(19) United States
(12) Patent Application Publication
(10) Pub. No.: US 2026/0156678 A1
(43) Pub. Date: Jun. 4, 2026

(54) METHOD, APPARATUS, AND SYSTEM FOR CROSS-LINK INTERFERENCE MEASUREMENT

(71) Applicant: Huawei Technologies Co., Ltd., Shenzhen (CN)

(72) Inventors: Abdelmalik Nasser Ali Aljalai, Kanata (CA); Amine Maaref, Ottawa (CA)

(21) Appl. No.: 19/429,407

(22) Filed: Dec. 22, 2025

Related U.S. Application Data
(63) Continuation of application No. PCT/CN2023/128260, filed on Oct. 31, 2023.
(60) Provisional application No. 63/510,013, filed on Jun. 23, 2023.

(51) Int. Cl. H04W 74/0816; H04B 17/309; H04L 5/00

(52) U.S. Cl. CPC H04W 74/0816; H04B 17/346; H04L 5/0051

(57) ABSTRACT

First resource elements (REs) are configured for determination of different components of interference that affects communications between a first user equipment (UE) and a first network device in a wireless communication system. The first REs include REs that correspond to a subset of REs in a set of second REs, and the set of second REs includes all REs at a time position in a time-frequency grid that are muted for communications by a second UE. The first REs further include an RE that corresponds to an RE at a time position in the time-frequency grid, different from the time position of the REs that are muted. The interference may include cross-link interference between links in the same wireless communication system, or links in different wireless communication systems such as a terrestrial network and a non-terrestrial network.

### CROSS-REFERENCE TO RELATED APPLICATIONS

The present application is a continuation of International Application No. PCT/CN2023/128260, filed on Oct. 31, 2023, which claims priority to U.S. Provisional Patent Application No. 63/510,013, filed on Jun. 23, 2023, applications of which are incorporated herein by reference in their entireties.

### TECHNICAL FIELD

The present application relates to communications, and in particular to measuring cross-link interference between communication links and facilitating coexistence of links of different or similar types.

### BACKGROUND

A communication system may comprise terrestrial communication system (also referred as terrestrial network, TN) and non-terrestrial communication system (also referred as non-terrestrial network, NTN). A terrestrial communication system may also be referred to as a land-based or ground-based communication system, although a terrestrial communication system can also, or instead, be implemented on or in water. However, it is difficult to implement terrestrial access-points/base-stations infrastructure in the areas like oceans, mountains, forests, or other remote areas. The non-terrestrial communication system may bridge the coverage gaps for underserved areas by extending the coverage of cellular networks (e.g., served by terrestrial nodes in the terrestrial communication system) through non-terrestrial nodes, may help ensure global seamless coverage and provide mobile broadband services to the unserved/underserved regions. The TN and NTN may co-exist.

In communications, one or more duplexing modes are used, e.g., TDD mode or FDD mode, i.e., a communication system may use the frequency bands in TDD mode and/or FDD mode, different communication system may use same duplexing mode or different duplexing mode. The TDD mode and FDD mode may co-exist.

TDD is the abbreviation of time division duplexing, FDD is the abbreviation of frequency division duplexing. In TDD mode, a communication system may use the frequency unpaired bands. In FDD mode, the communication system may use the frequency paired bands.

There is more than one operator that provides communication services in the same or adjacent area. E.g., multiple operators may co-exist.

The mentioned co-existed systems networks, duplexing modes, or operators may use the frequency band that are either separated, adjacent, partially overlapped, or fully overlapped (based on the deployment country). Using frequency bands that are adjacent, partially overlapped, or fully overlapped may result in severe interference that may arise upon cross-links coexistence, which causes a deployment limitation or triggers overlapped/adjacent channel performance's degradation in the coexisting systems.

It is generally desirable to provide coexistence interference measurement, to support, which may help in determining and mitigating effects of such interference and allow coexisted systems to work with high performance in a coexistence environment simultaneously.

### SUMMARY

In the disclosure of the present invention, a method, apparatus, and system for cross-link interference measurement is provided.

Some aspects of the present disclosure relate to a scheme (e.g., algorithm) for UEs that belong to a communications system, which operates in a coexisting communications systems environment, to measure the coexistence cross-link interference.

Coexistence generally refers to the case where two systems using different air interface or radio access technologies such as LTE, NR, WiFi, etc. use adjacent or partially/fully overlapping spectrum. However, it can also be extended as is the case of this invention to the coexistence between two radio links of the same radio access network wherein the link may refer to the communications link between a transmitter and receiver pair which may comprise the beam pair link (transmitter and receiver beam pair) used to establish and maintain the communication between the transmitter and receiver nodes. Even when the coexistence is between two links of a single system or radio access technology, the links may differ in the nature of the transmitter and receiver nodes. For example, the transmitter node may be a TN node in one link and a NTN node in the other link and vice versa. The links may also be different in terms of the Tx/Rx beam pairs they comprise. The beam pair links may also be of the similar nature e.g., two TN links or two NTN links.

According to an aspect of the present disclosure, a method involves receiving, by a first user equipment (UE), a configuration of a plurality of first resource elements (REs); and using the first REs, by the first UE according to the configuration, for determination of different components of interference. The interference affects communications between the first UE and the first network device. In one possible implementation, the first UE receives the configuration from a first network device in a first wireless communication system.

An apparatus according to an embodiment includes a receiver for receiving, from a first network device in a first wireless communication system in one possible implementation, a configuration of a plurality of first REs; and a controller, coupled to the receiver, to control the apparatus for using the first REs according to the configuration, for determination of different components of interference. The interference affects communications between the first UE and the first network device.

In such a method and apparatus, and others herein, the first REs include REs that correspond to a subset of REs in a set of second REs, the set of second REs includes all REs at a time position in a time-frequency grid that are muted for communications by a second UE, and the first REs further include an RE that corresponds to an RE at a time position in the time-frequency grid different from the time position of the REs that are muted.

A method according to another embodiment involves transmitting, to a first UE from a first network device in a first wireless communication system in one possible implementation, a configuration of a plurality of first REs; and using the first REs, by the first network device according to the configuration, for determination of different components of interference. The interference affects communications between the first UE and the first network device.

A related apparatus for a first network device includes a transmitter for transmitting, to a first UE in a first wireless communication system in one possible implementation, a configuration of a plurality of first REs; and a controller, coupled to the transmitter, to control the apparatus for using the first REs according to the configuration, for determination of different components of interference. The interference affects communications between the first UE and the first network device.

In these embodiments, and others herein, the first REs include REs that correspond to a subset of REs in a set of second REs, the set of second REs includes all REs at a time position in a time-frequency grid that are muted for communications by a second UE, and the first REs further include an RE that corresponds to an RE at a time position in the time-frequency grid different from the time position of the REs that are muted.

Yet another method embodiment involves coordinating, with a first network device in a first wireless communication system by a second network device, a set of second REs corresponding to a plurality of first REs for determination of different components of interference that affects communications between a first UE and the first network device; and transmitting, to a second UE from the second network device, a configuration to mute REs for communications between the second network device and the second UE.

A related apparatus for a second network device includes a controller for coordinating, with a first network device in a first wireless communication system, a set of second REs corresponding to a plurality of first REs for determination of different components of interference that affects communications between a first UE and the first network device; and a transmitter, coupled to the controller, for transmitting, to a second UE, a configuration to mute REs for communications between the second network device and the second UE.

For example, the first network device and the second network device coordinate with each other on selection of a set of REs.

In these and other embodiments herein, the set of second REs includes all REs at a time position in a time-frequency grid that are to be muted for communications between the second network device and a second UE, the configuration is to mute the REs at that time position, a subset of the REs at the time position correspond to a subset of the first REs, and the set of second REs further includes an RE, at a time position in the time-frequency grid different from the time position of the REs that are muted, corresponding to another RE of the plurality of first REs.

A method according to a still further embodiment involves receiving, by a second UE from a second network device, a configuration of a set of second REs corresponding to a plurality of first REs for determination of different components of interference that affects communications between a first UE and a first network device in a first wireless communication system; and using the set of second REs, by the second UE according to the configuration, for the determination of the different components of interference.

A related apparatus for a second UE includes a receiver for receiving, from a second network device, a configuration of a set of second resource elements (REs) corresponding to a plurality of first REs for determination of different components of interference that affects communications between a first UE and a first network device in a first wireless communication system; and a controller, coupled to the receiver, to control the apparatus for using the set of second REs according to the configuration, for the determination of the different components of interference.

In these and other embodiments herein, the set of second REs includes all REs at a time position in a time-frequency grid that are to be muted for communications between the second network device and the second UE, a subset of the REs at the time position correspond to a subset of the first REs, and the set of second REs further includes an RE, at a time position in the time-frequency grid different from the time position of the REs that are muted, corresponding to another RE of the plurality of first REs,

In other apparatus embodiments, an apparatus may include a processor configured to cause the apparatus to perform any of the methods as disclosed herein.

An apparatus may include a processor coupled with a non-transitory computer readable storage medium that stores programming for execution by the processor, to perform any method disclosed herein.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

A system is also disclosed, and may include a first network device for transmitting a configuration of first REs for determination of different components of interference that affects communications between the first UE and the first network device, and for using the first REs according to the configuration; and a first UE for receiving, from the first network device, the configuration of the first REs, and for using the first REs according to the configuration. The first REs include REs that correspond to a subset of REs in a set of second REs, the set of second REs includes all REs at a time position in a time-frequency grid that are muted for communications by a second UE, and the first REs further include an RE that corresponds to an RE at a time position in the time-frequency grid different from the time position of the REs that are muted.

In some aspects of the present disclosure, there is provided an apparatus/chipset system comprising means to implement the method implemented by a UE of the present disclosure. The apparatus/chipset system may be the UE (i.e., terminal device) or a module/component in the UE.

In some aspects of the present disclosure, there is provided an apparatus/chipset system comprising means to implement the method implemented by the network device of the present disclosure. The apparatus/chipset system may be the network device or a module/component in the network device.

In some aspects of the present disclosure, there is provided a system comprising at least one of an apparatus in the UE of the present disclosure, and an apparatus in the network device of the present disclosure.

In some aspects of the present disclosure, there is provided an apparatus/chipset system comprising at least one processor executing instructions stored in a computer-readable medium to implement the method implemented by the UE of the present disclosure.

In some aspects of the present disclosure, there is provided an apparatus/chipset system comprising at least one processor executing instructions stored in a computer-readable medium to implement the method implemented by the network device of the present disclosure.

In some aspects of the present disclosure, there is provided a computer program comprising instructions. The instructions, when executed by a processor, may cause the processor to implement the method of the present disclosure.

In some aspects of the present disclosure, there is provided a non-transitory computer-readable medium storing instructions, the instructions, when executed by a processor, may cause the processor to implement the method of the present disclosure.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example system architecture for multiple coexisting TN cells with multiple NTN beams.

FIG. 6 illustrates slot formats of both a victim system and an aggressor system, and steps illustrating where UEs may do measurements to calculate cross-link coexistence interference according to an embodiment.

FIG. 6A illustrates an example of cross-link interference measurements and management, in uplink with a single connectivity mode and existence of a single aggressor.

FIG. 7 illustrates an example of cross-link interference measurements and management, in uplink and existence of a single aggressor using a dual connectivity mode with the aggressor.

FIG. 8 illustrates another example of cross-link interference measurements and management, in downlink with a single connectivity mode and existence of a single aggressor.

FIG. 9 illustrates yet another example of cross-link interference measurements and management, in downlink and existence of a single aggressor using a dual connectivity mode with the aggressor.

FIG. 10A is a flow diagram illustrating an example method implemented at a victim UE in an embodiment.

FIG. 10B is a flow diagram illustrating an example method implemented at a victim network device in an embodiment.

FIG. 10C is a flow diagram illustrating an example method implemented at an aggressor network device in an embodiment.

FIG. 10D is a flow diagram illustrating an example method implemented at an aggressor UE in an embodiment.

FIG. 11 is a block diagram illustrating an apparatus according to an embodiment.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Some aspects of the present disclosure related to a method that the UEs can provide a feedback to the channel estimation algorithms to improve the channel estimation accuracy and or MCS adaptation in both UL and DL. UEs provide an active updated accurate interference measurement of the two types of coexistence interference measurements, which can work jointly with channel estimation algorithms to improve the channel estimation accuracy. This enables UEs to maintain a good quality of communication channel equalization. This may also enable UEs to maintain a high QoS.

Reference is made above to UEs providing a feedback to channel estimation algorithms. It should be noted that this is one example of how UEs may provide feedback for channel estimation. Reference is also made to two types of coexistence interference measurements, and these may be two types of coexistence cross-links interference measurements.

MCS refers to modulation coding scheme. UL refers to uplink. DL refers to downlink.

Some aspects of the present disclosure related to a method to use reference signals (CSI-RS) and some distributed special REs (empty REs, NZP CSI-RS RES, and CSI-IM REs) to do the cross-link coexistence interference measurements at the victim UEs in DL. In some implementations, sounding reference signals (SRS) and empty REs may be used to facilitate cross-link coexistence interference measurement at network(s) side node(s) for victim UEs in UL. Please note that the CSI-RS is an example of reference signals, reference signals may comprise other signals different from CSI-RS. Similarly, empty REs, NZP CSI-RS REs and CSI-IM REs are examples of special resource elements, and the special resource elements may comprise other REs.

In this disclosure, CSI-RS is an abbreviation of channel state information-reference signal, RE is an abbreviation of resource element, NZP CSI-RS is an abbreviation of non-zero power-CSI-RS, CSI-IM is an abbreviation of CSI-interference measurement.

Resources are referred to herein primarily as resource elements. In some embodiments, multiple REs are empty, muted, or blanked, and may be referred to as REs, symbols (such as an entire muted or blanked symbol at a time position at which all REs are muted or blanked), resource blocks (RBs), symbol-RBs, and so on.

Some aspects of the present disclosure relate to a method that the UEs can identify the presence of the cross-link coexistence interference. Some implementations may enable UEs to detect the coexistence interference that may arise from multiple operators, via muted/blanked time-frequency resources for each operator.

This enables the UE to identify the presence of coexisted operator(s) and which aggressor coexisted operator induces a higher cross-link interference impact.

Some aspects of the present disclosure relate to a method that the UEs can identify the source and the types of the cross-link coexistence interference e.g., inband coexistence interference or adjacent coexistence interference. The UEs can measure the two types of the interference described herein and provide an active updated level of the cross-link coexistence interference.

For example, as the allocation of BWP at the aggressor system can be changed dynamically, there might be a chance that coexistence cross-link interference changes over time. As measurements are performed periodically for each slot, an adaptive level of cross-link interference can be detected in an active mode or manner, and measurement reports or determined interference levels related to cross-link interference can be updated periodically or based on one or more triggering events that trigger report updates.

Some aspects of the present disclosure relate to a method that UE reports (i.e., via an UCI in the PUCCH) to the gNBs, an active updated level of both adjacent and in-band co-channel coexistence interference in DL. In this disclosure, UCI is an abbreviation of uplink control information, and PUCCH is an abbreviation of physical uplink control channel.

The present disclosure provides a general tool that equips UEs in a wireless communication system with the capability to detect and measure the existence of the cross-link coexistence interference (i.e., existence of other system(s) that might use partially/fully overlapped or adjacent frequency band(s) with the frequency band of the system under consideration). It equips the UEs with the capability to identify the source and type of cross-link coexistence interference, measure this interference, and do a reporting to the serving/non-serving gNBs. The reported measurements in the present disclosure facilitate the integration of different coexisting systems (e.g., NTN and TN) and can help different operators to coordinate their sites (gNBs) deployments to minimize the cross-link coexistence interference between different operators. In this disclosure, other system(s) may be used by the same or different operator(s).

The method provided in the present disclosure enables active interference measurement at a lower cost (only requires several REs in the BWP of both aggressor/s system/s and victim system to be muted or allocated for CSI-IM, ZP or NZP CSI-RS, or SRS, or muted REs or symbols). BWP is an abbreviation of bandwidth part.

The method provided in the present disclosure provides an economically efficient method that will enable interference avoidance/mitigation schemes to be implemented. Such interference avoidance/mitigation schemes improve UE experience while preserving the high spectral efficiency.

In some aspects of the present disclosure, a method is provided to estimate an active updated level of the two types of coexistence interference, namely in-band co-channel and out-of-band adjacent coexistence interference. This can be used to implement an easy equalization/interference mitigation algorithm through signal processing to overcome the coexistence interference. Optionally and furthermore, it can be used to implement an efficient spectral efficiency by facilitating in-band frequency coexistence management that minimized the in-band coexistence frequency through adopting a dynamic combined spatial/beam and frequency hopping in the in-band co-channel coexistence. Optionally and furthermore, it can be used to implement an efficient spectral efficiency by facilitating in-band frequency coexistence management that reduces the in-band coexistence frequency through adopting a dynamic combined spatial/beam and frequency hopping in the in-band co-channel coexistence.

The method provided in the present disclosure can extract the effective ACLR of each aggressor at the UE/gNB victim receiver. It may convert the fixed ACS into adaptive virtual ACS that can be tuned to accommodate various ranges of SNR (which can help avoid hardware redesigns). The network may employ dynamic frequency spacing based on the active coexistence interference conditions or do a pre-compensation to apply the interference management. The network may be in particular a network device therein such as a gNB.

ACLR is an abbreviation of adjacent channel leakage ratio, ACS is an abbreviation of adjacent channel selectivity, and SNR is an abbreviation of signal-to-noise ratio.

The method provided in the present disclosure can be implemented in various coexistence scenarios (different SCS, different BWP, and different MCS, different connectivity, etc. that work synchronously/asynchronously). It can also be generalized into several types of coexistence topologies. It can apply to future 3GPP standards, which serve the market of wireless telecommunications to address various types of coexistence/upgrading/backward compatibility and 6G to facilitate the integration and deployment of NTN and TN. Implementations can also or instead apply to future standards or specifications such as Institute of Electrical and Electronics Engineers (IEEE) WiFi standards. SCS is an abbreviation of subcarrier spacing, 3GPP is an abbreviation of 3rd generation partnership project, 6G is an abbreviation of 6th generation.

The method provided in the present disclosure is easy to implement and has a low computational complexity. Therefore, it is suitable to be implemented at network nodes that have limited power capability such as satellites or UEs, which have limited battery life.

Reference may be made, above and/or elsewhere herein, to particular examples (such as “the method”) that have or provide certain features. It should be appreciated that these are examples only, and such features need not necessarily be provided in all examples or embodiments, or may be provided in other examples or embodiments.

The following description are some detailed examples for present disclosure.

The terrestrial communication system may be a wireless communications using 5G technology and/or later generation wireless technology (e.g., 6G or later). In some examples, the terrestrial communication system may also accommodate some legacy wireless technology (e.g., 3G, 4G or 5G wireless technology). The non-terrestrial communication system may be a communications using the satellite constellations like Geo-Stationary Orbit (GEO) satellites which utilize broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional.

3G refers to 3rd generation, 4G refers to 4th generation, and 5G refers to 5th generation. Legacy wireless technology may also include 2nd generation (2G). A non-terrestrial communication system may also or instead use Middle earth orbit (MEO) satellites, and MEO satellites may be horizontal and two-dimensional.

In this disclosure, horizontal means that satellites are placed or located on the same orbit and at the same altitude, and two dimensional means that satellites are placed or located on the same altitude but different orbits. Three dimensional (3D), as referenced below, in this context means that satellites are placed on different orbits and different altitudes.

In some examples, UAVs, HAPs and VLEOs can be coupled to integrate satellite communications to cellular networks emerging 3D vertical networks comprise many moving (other than geostationary satellites) and high altitude access points such as UAVs, HAPs and VLEOs.

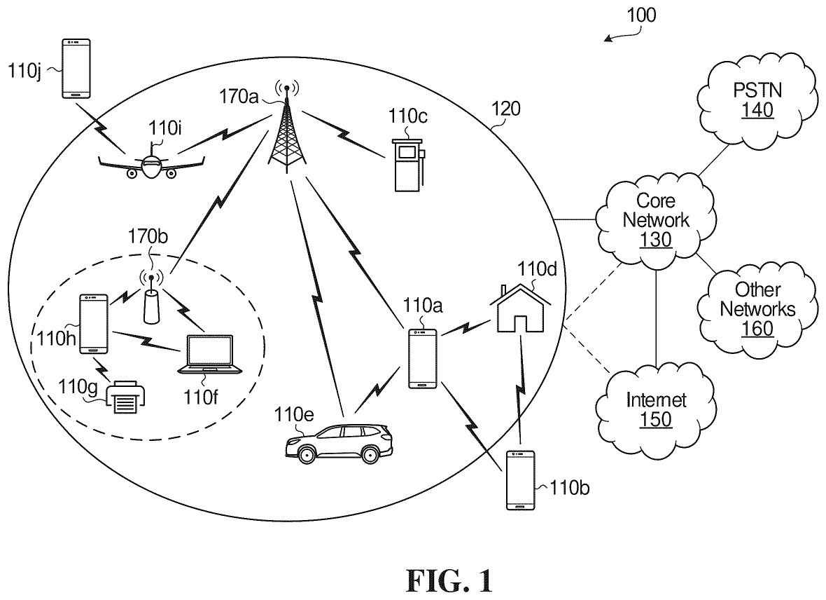

The present disclosure uses the interaction and processing procedures among at least one UE (i.e., the sensing device which is also called sensing node, which is marked as ED in FIG. 1) and at least one BS (i.e., the network device) in a wireless communication system as an illustrative example. The exchanged information and protocol flows can also be used between other network nodes described below, for example, between ED 110 and TRP 170, between ED 110 and core network, between ED 110 and ED 110, between TRP 170 and TRP 170. The UE in the procedure described in the present disclosure may be replaced with other node served by a BS. These nodes can be stand-alone nodes dedicated to just sensing operations or other nodes (for example TRP 170, ED 110, or core network node shown below).

ED refers to electric device. BS refers to base station. TRP refers to transmit and receive point.

Referring to FIG. 1, as an illustrative example without limitation, a simplified schematic illustration of a communication system is provided. The communication system 100 (which may be the wireless system in FIG. 1) comprises a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

In the present disclosure, the uplink messages/data transmitted between the BS (e.g., the network node 170) and the sensing device (e.g., ED 110) could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the BS and the ED 110 could be carried in higher layer signaling, such as RRC signaling, or MAC layer signaling. Or, they could be carried in physical layer signaling, e.g., DCI. Or they could be carried in the combination of the higher layer signaling and the physical signaling. It could be noted that the message in the present disclosure could be replaced with information, which may be carried in one single message, or be carried in more than one separate message.

MAC refers to medium access control. UCI refers to uplink control information. DCI refers to downlink control information.

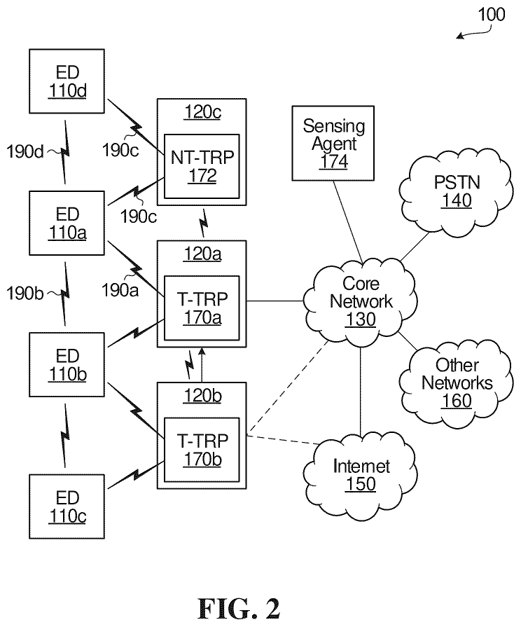

FIG. 2 illustrates an example communication system 100. In general, the communication system 100 enables multiple wireless or wired elements to communicate data and other content. The purpose of the communication system 100 may be to provide content, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers to support such.

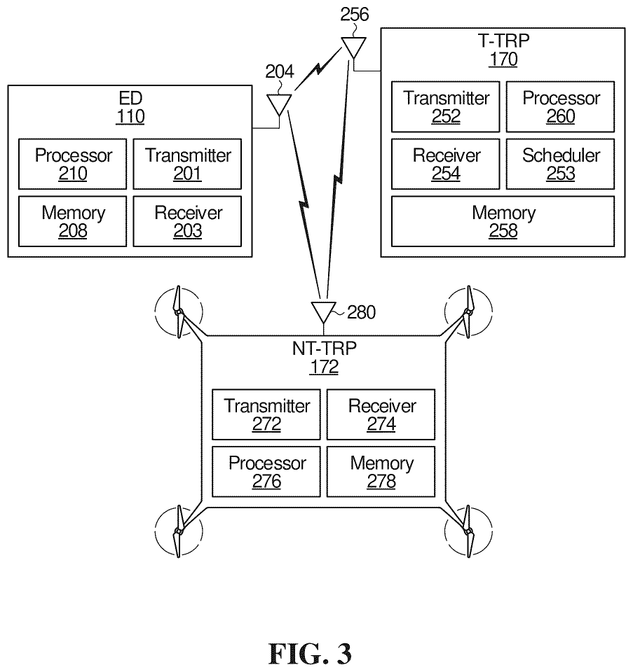

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the forgoing devices, among other possibilities. Future generation EDs 110 may be referred to using other terms. Each base station 170a and 170b is a T-TRP and will hereafter be referred to as T-TRP 170. Also shown in FIG. 3, an NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may alternatively be panels. The transmitter 201 and the receiver 203 may be integrated, e.g., as a transceiver. The transceiver is configured to modulate data or other content for transmission by at least one antenna 204 or network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data. For other nodes/entities in this disclosure, similar rule applies.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

The scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same or different one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGAI a GPU, a CPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGAI a GPU, a CPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

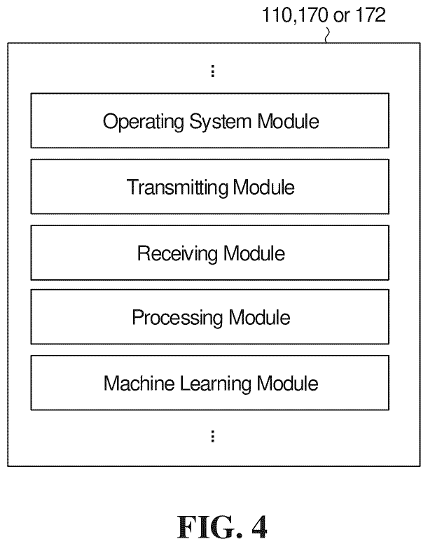

One or more steps of the embodiment methods provided herein may be performed by corresponding units or modules, according to FIG. 4. FIG. 4 illustrates units or modules in a device, such as in the ED 110, in the T-TRP 170, in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGAI a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

When the NT-TRP 172 is an apparatus (e.g., communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

Additional details regarding the EDs 110, the T-TRP 170 and the NT-TRP 172 are known to those of skill in the art. As such, these details are omitted here.

Please note that the different embodiments in the present disclosure may be implemented separately or combined. Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occur on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common (or group) control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The above mentioned configuration parameters may be signaled via, but not limited to, radio resource control (RRC) layer signaling, media access control (MAC) layer signaling, physical layer signaling (e.g., downlink control information) or any combination.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency of the carrier, the lowest frequency of the carrier, the highest frequency of the carrier or a reference point that is outside the carrier and an offset. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers. In some examples, a bandwidth part comprises a subset of contiguous common resource blocks for a given numerology on a given carrier.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

The abbreviation mmW refers to millimeter wave.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

The present disclosure encompasses the following features, for which additional or alternative definitions may also be provided herein:
6th Generation radio access refers to the next generation air interface of cellular standards which may comprise both Terrestrial Networks and Non-Terrestrial Networks.

Coexistence refers to a scenario in which wireless communications networks are deployed in adjacent or overlapped frequency bands/channels in overlapped coverage areas. Coexistence may also refer to a scenario in which wireless communications links are deployed in adjacent or overlapped frequency bands/channels in overlapped coverage areas.

User Equipment refers to any device in a wireless communications network which can connect to TN and/or NTN.

BS (e.g., eNB/gNB) refers to access nodes in 4G, 5G or 6G networks which provide connectivity between the UE and the core network. Access nodes such as base station nodes are responsible for allocating/configuring resources and transmission/reception in a set of cells. Other network examples include 2G and 3G.

Cell is a Radio network object that can be uniquely identified by a UE from a (cell) identification that is broadcasted over a geographical area from TRPs or access nodes associated with the cell. A Cell can be either FDD or TDD mode. A cell may also refer to the carrier frequencies within the DL/UL carrier bandwidth resources of a single standalone carrier or a component carrier in a carrier aggregation mode.

Frequency Range 1: covers frequency bands up to 7 GHz.

Frequency Range 2: covers frequency bands above 7 GHz.

Adjacent Channel Leakage Ratio refers to the ratio of the filtered mean power centered on the assigned channel frequency to the filtered mean power centered on the adjacent channel frequency.

Adjacent Channel Interference Ratio refers to the ratio of the total power transmitted from an aggressor transmitter to the total interference power affecting a victim receiver, resulting from both transmitter and receiver imperfections.

Adjacent Channel Selectivity refers to a measure of the receiver ability to receive a wanted signal at its assigned channel frequency in the presence of an adjacent channel signal with a specified center frequency offset of the interfering signal to the band edge of a victim system. It is the required minimum attenuation that should be applied by the receiver selectivity filter on the interfering signal to be able to detect the wanted signal at the required signal to noise ratio.

Operating band/carrier refers to the frequency band/carrier in which the aggressor or victim operates (paired or unpaired spectrum, in TDD or FDD mode).

Uplink Control Information may refer to control information that schedules PUSCH uplink transmissions via REs in the PUCCH carrying control signals from UE-to-gNB in the uplink direction.

Downlink Control Information may refer to control information that is used to schedule PDSCH downlink transmissions via REs in the PDCCH that are dedicated to carry control signals from gNB-to-UE in the downlink direction.

Control resource set (CORESET) is a set of time-frequency resources in the resource grid used to carry PDCCH.

Resource Element (RE) is the element in the resource grid for a specific antenna port p that is associated with a subcarrier spacing configuration, which can be uniquely identified by its frequency domain index and its OFDM time domain symbol position index.

Resource Element Group (REG) is a group of 12 consecutive REs in the resource grid that have the same OFDM time domain symbol position index.

Control Channel Element (CCE) is a group of 6 adjacent REGs in the resource, which are used by the PDCCH.

Demodulation Reference Signal (DMRS) is a demodulation reference signal used by the receiver to produce the channel estimates for the demodulation of the associated physical channel.

Phase Tracking Reference Signal (PTRS) is a reference signal used for the tracking of the phase of the local oscillator at the receiver and transmitter to enable the suppression of phase noise and common phase error which may result in time and frequency synchronization between the transmitter and the receiver in the downlink.

Sounding Reference Signal (SRS) is a reference signal that is transmitted by the UE in the UL to the base station to sound the UL channel.

Gold Sequence is a special class of pseudo noise sequences that is generated from xoring two m-sequences. In a possible implementation, xoring is the operation of combining by Exclusive OR (XOR). Gold sequences generated from xoring may be used in DMRS.

Zadoff-Chu Sequence is a special type of sequences having a unity magnitude of their entries, zero cross-correlation with their cyclic shifted versions, and constant cross-correlation with other Zadoff-Chu sequences that are generated using different roots. In a possible implementation, ZC sequences may be used in SRS.

Physical Uplink Control Channel is the physical channel that carries the uplink control information.

Physical Downlink Control Channel is the physical channel that carries the downlink control information.

Carrier may refer to the RF carrier/cell or the modulated waveform conveying radio access physical channels.

Carrier frequency may refer to the center frequency of a cell and carrier frequencies may refer to the frequencies within the channel bandwidth which comprises the RF bandwidth supporting a single RF carrier with the transmission bandwidth configured for UL or DL of a given cell or component carrier in a carrier aggregation mode.

RF refers to radio frequency.

Bandwidth Part comprises a subset of contiguous common resource blocks for a given numerology on a given carrier.

Transmission bandwidth may refer to the bandwidth of an instantaneous transmission of a UE or base station, usually measured in units of resources blocks (RBs).

Orthogonal Frequency Division Multiplexing is a method of data transmission where a single information bit stream is split among several parallel bit streams over closely spaced orthogonal narrowband subcarrier frequencies instead of a single wideband channel frequency.

Sub-Carrier Spacing is the separation in frequency between the consecutive subcarriers of the OFDM waveform.

Channel State Information-Reference Signal (CSI-RS) is a downlink reference signal used for DL channel sounding, i.e., used by the UE to estimate the state of the channel in the downlink direction. It may be configured on a per-device basis over so-called CSI-RS resources (e.g., a set of contiguous or non-contiguous REs in one RB in the frequency domain and one slot in the time domain) and may correspond to a number of antenna ports e.g., 32 antenna ports at the transmitter. A multi-port CSI-RS may correspond to a set of orthogonal per antenna port CSI-RSs sharing the same set of configured resources for the multi-port CSI-RS. The sharing can be a time-domain sharing (TDM), frequency-domain sharing (FDM), code-domain sharing (CDM) or a combination thereof. For example, the time-domain sharing may use time-domain multiplexing (TDM), the frequency-domain sharing may use frequency-domain multiplexing (FDM), and the code-domain sharing may use code-domain multiplexing (CDM).

CSI-RS can be of two types, non-zero power (NZP-CSI-RS) or zero-power ZP-CSI-RS. The UE may assume that PDSCH is not mapped to the resource elements associated with ZP-CSI-RS. ZP-CSI-RS may have a different function in contrast to CSI-IM. A UE cannot make any assumption of the content of these REs.

SSB may refer to SS/Physical broadcast channel (PBCH) block or SS block set.

Channel state information-interference measurement (CSI-IM) refers to resources configured for interference measurement by the UE. CSI-IM resources may contain zero power REs. Similar to CSI-RS, the location of CSI-IM resources is flexible within the slot/RB and is part of the CSI-IM configuration. Typically, UE assumes that nothing is transmitted on the CSI-IM resources, or in other words that no physical signals or channels are mapped to the CSI-IM resources from its serving cell or beam and UE would therefore be able to measure interference from other neighboring cells or beams on the CSI-IM resources. CSI-IM resources may contain zero power REs. Thus, a UE may assume that nothing is transmitted on the CSI-IM resources, or in other words the UE may assume that no physical channels or signals are mapped to the CSI-IM resources from its serving cell or beam and UE would therefore be able to measure interference from other neighboring cells or beams on the CSI-IM resources.

Received Signal Strength Indicator (RSSI) comprises the linear average of the total received power (in Watt) observed in OFDM symbols of measurement time resource(s), in the measurement bandwidth, over N number of resource blocks from all sources, including co-channel serving and non-serving cells, adjacent channel interference, thermal noise etc.

Reference signal received power (RSRP) is a power measurement of the received RS power over the time-frequency resources configured for the corresponding RS e.g., SS block or NZP-CSI-RS.

Reference signal received quality (RSRQ) is a signal-to-noise-and-interference measurement also measured over the time-frequency resources configured for the corresponding RS e.g., SS block or NZP-CSI-RS.

RSSI, RSRP and RSRQ can correspond to one-shot measurements e.g., Li measurements or may be filtered over a time period e.g., 100 ms, for a more stable measurement results. Such filtered measurements may be referred to as L3 measurements.

Coexisting communication systems in TDD or FDD mode, can operate on frequency bands that are either separated, adjacent, partially overlapped, or fully overlapped (based on the deployment country). Using frequency bands that are adjacent, partially overlapped, or fully overlapped may result in severe interference that may arise upon cross-links coexistence, which causes a deployment limitation or triggers overlapped/adjacent channel performance's degradation in the coexisting systems (e.g., the coexistence between NTN and TN). Each system in the coexisting environment will be seen either as the victim/aggressor(s) of/on the another/others. Besides, usage of different MCSs in coexisting wireless communications networks may lead to more coexistence degradation performance. In addition to this, multiple operators' coexistence may complicate the severity of such type of interference.

TDD mode and FDD mode are referenced above. Coexisting communication systems may operate in hybrid TDD-FDD mode, on frequency bands that are either separated, adjacent, partially overlapped, or fully overlapped (based on the deployment country).

We distinguish between two types of the coexistence cross-link interference:
The in-band co-channel interference is the interference caused by the aggressor/s on the victim receiver due to mixing the inseparable victim desired signal with the aggressor interfering signal, which may be caused by sharing the same operating spectrum either fully or partially.
The adjacent channel interference (ACI) is the total interference from adjacent channels and is mainly related to the amount of signal leakage from a transmitter, the amount of signal loss between two transceivers, and the ability of a receiver to suppress out of band interference, caused by using non-overlapping adjacent operating spectrum.

The presence of the two types of coexistence interference depends on whether the coexisting systems operate on fully/partially/non overlapping frequency bands. The coexistence cross-link interference can happen either in UL, DL, or in both UL and DL, depending on the deployment configurations and frequency band allocations.

Managing the coexistence cross-link interference may help improve spectral efficiency and optimize performance of coexisting systems or radio links. There is a trade-off between acceptable coexisting systems performance and spectrum efficiency. The aim is to take advantage of coexistence constructively and ensure high QoS at each coexisting link while at the same time enhancing spectral efficiency.

QoS refers to quality of service.

Coexistence cross-link adjacent channel interference is measured via ACIR, which depends on the two quantities: ACS and ACLR. ACIR may be limited by the smallest value of ACS or ACLR. Unwanted emissions mitigation may be especially important in cross-link coexistence applications.

Unwanted emissions comprise out of band emissions and spurious emissions. Out of band emissions, which are the main source of ACI, are unwanted emissions immediately outside of the channel bandwidth of the aggressor. Such ACI may result from the modulation process and non-linearity in the aggressor's transmitters(s) but excluding the spurious emissions. Spurious emissions, which is a secondary source of in-band coexistence cross-link interference in addition to the primary interference caused by the frequency bands overlapping, are caused by the other unwanted transmitter's effects such as harmonics emissions, parasitic emissions, intermodulation products and frequency conversion products, but exclude the out of band emission. Therefore, depending on the scenario of the coexistence, either unwanted out of band emission, or unwanted spurious emissions, or both can be considered and mitigated.

In an operating frequency band, the unwanted out of band emissions are limited to 10 MHz above and 10 MHz below the operating band. However, the effective interference band depends on the bandwidth of the aggressor, which can be considered up to the three times of the aggressor's bandwidth (i.e., ACLR₁, ACLR₂, and ACLR₃). The in-band coexistence cross-link emission is defined as the average unwanted emission across the PRB subcarriers and as a function of the PRB offset edge from the allocated transmission bandwidth. It is measured as the ratio of transmission node power in a non-overlapped PRB to the transmission node output power in an overlapped PRB. The measurement interval is done over one time slot and conventionally averaged over 10 subframes.

The ACIR=Transmit power of an aggressor-interference power at the victim receiver. ACIR can be improved by improving the frequency spacing between the coexisting systems (which is an efficient economically and may face practical limitation and standardization) or by improving filters and detection at the transmitter and receiver of coexisting links. The required attenuation that should be applied by ACS at the victim receiver can be found by applying equation (1):

$$ACS = Power of interferer ( s ) ( aggressor ( s ) ) - Power of wanted signal + Signal to Noise Ratio \qquad ( 1 )$$

As mentioned above, the TN and NTN may co-exist, TDD mode or FDD mode may co-exist, and multiple operators may co-exist. The mentioned co-existed networks, duplexing modes, or operators may use the frequency band that are either separated, adjacent, partially overlapped, or fully overlapped (based on the deployment country). Using frequency bands that are adjacent, partially overlapped, or fully overlapped may result in severe interference that may arise upon cross-links coexistence, which causes a deployment limitation or triggers overlapped/adjacent channel performance's degradation in the coexisting systems. Hybrid TDD-FDD systems may co-exist.

One example, Out-of-band/in-band co-channel coexistence interference between different links of the same or different type e.g., TN and/or NTN have not been considered in the literature in the scope of coexisting systems. Only co-channel interference mitigation techniques across links of the same type e.g., TN or NTN or TN cells/beams were considered e.g., as part of inter-cell interference coordination in LTE.

Another example of cross-link or system interference management is aligning the frames of the two coexisting systems along with a proposed uplink scheduling algorithm that utilizes a leakage pattern of ACI to make the coexistence feasible and ensure that the UL transmission is robust against the adjacent channel interference. However, feasibility of coexistence requires some special cell-site engineering techniques to reduce ACI and make coexistence work.

In some implementations, only adjacent channel coexistence interference between two systems have been explored, however, such solutions were case by case oriented, where a solution has been designed to fit with specific coexisting systems, which can not be generalized to accommodate other coexistence communications environments.

However, the in-band co-channel coexistence interference were not considered in the scope of coexisting systems. The co-channel interference was studied in certain literature only in the scope of intra-system interference while doing the frequency planning for groups of cells that belong to the same network.

Specific cases of wireless communications systems have been considered upon upgrading or changing technology only, and were temporary and addressed coexistence feasibility. In this regard, for instance, a proposal was restructuring the frame in the two coexisting systems along with a proposed uplink scheduling algorithm that utilizes a leakage pattern of ACI to make the coexistence feasible and ensure that the UL transmission is robust against the adjacent channel interference. However, feasibility of coexistence requires some special cell-site engineering techniques to reduce ACI and make coexistence work.

Another implementation to improve ACLR is reducing intermodulation products within the carrier band and adjacent frequencies for power amplifiers via introduced predistortion. There is another implementation of a 5-GHz power amplifier using high temperature superconducting reaction-type transmitting filters to improve ACLR. Frequency range specific solution that cannot accommodate various scenarios. Especially, as frequency of operation increases, the difficulty of electronic IC designs increases, which make it difficult for 6G.

It is also possible to improve ACLR by reducing intermodulation products within the carrier band and adjacent frequencies for power amplifiers via introduced predistortion. Yet another possibility is an improvement method of a 5-GHz power amplifier using high temperature superconducting reaction-type transmitting filters to mitigate ACLR. Such method is frequency range specific and cannot accommodate various scenarios. Especially, as frequency of operation increases, the difficulty of electronic IC designs increases, which make solutions relying on power amplifier improvements less effective.

IC refers to integrated circuit.

The present disclosure considers a group of two wireless communications systems (or more) that are working in the same geographical area and using partial/fully overlapped or adjacent frequency bands. One example of such a communication system comprises an integrated TN/NTN network deployment with both TN links and NTN links and wherein UEs can communicate (that is, transmit physical control and data channels and signals) with either TN and/or NTN nodes through the corresponding links.

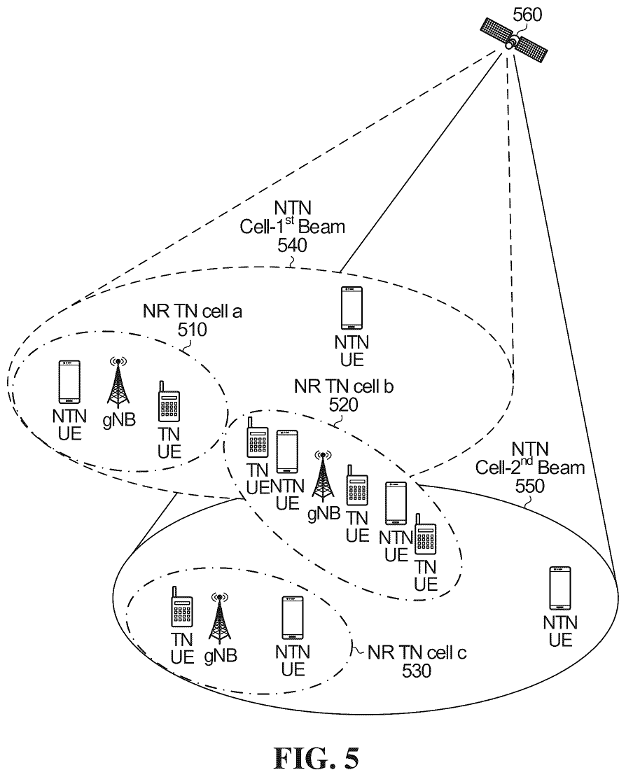

FIG. 5 is a block diagram illustrating an example system architecture for multiple coexisting TN cells 510, 520, 530 with multiple NTN beams 540, 550 associated with an NTN BS 560, shown by way of example as a satellite. In order to avoid congestion in the drawing, only NTN beams, and specifically NTN transmit beams, are shown in FIG. 5. However, it should be noted that both transmit beams and receive beams can be used in a coexistence scenario, both at UEs and at network device nodes (TN or NTN).

Each wireless communications system may consist of cells, and each cell is equipped with a gNB at the center of the cell that serves a group of users inside the cell. The nature of a gNB in each system can be a micro bases station, macro base station, unmanned aerial vehicle, or a satellite. Any wireless communication system in this scenario can be either TN or NTN. Considering the hybrid scenario where TN coexists with NTN, FIG. 5 shows the types of possible coexistence interference that occur in UL and DL. Table 1 describes the possible scenarios, which depend on the duplexing scheme, whether it is TDD or FDD. Note that the disclosure of the present disclosure is not limited only to TN and NTN coexistence only, it is broader and can be generalized to address any network architecture.

Each wireless communications system may comprise cells and each cell is equipped with one or more BSs or TRPs that serve a group of users inside the cell. The nature of a gNB in each system can be a micro bases station, macro base station, unmanned aerial vehicle, or a satellite. Any wireless communication system in this scenario can be either TN or NTN. Considering the hybrid scenario where TN coexists with NTN, FIG. 5 shows the types of possible coexistence interference that occur in UL and DL. Table 1 describes the possible scenarios, which depend on the duplexing scheme, whether it is TDD or FDD. Note that the disclosure of present disclosure is not limited only to TN and NTN coexistence only, it is broader and can be generalized to address other network architectures.

TABLE 1
Examples of Possible Coexistence Scenarios

| Scenario | Co-existence | Aggressor | Victim |
|---|---|---|---|
| 1 | TN with NTN | TN DL | NTN DL |
| 2 | TN with NTN | TN UL | NTN UL |
| 3 | TN with NTN | NTN DL | TN DL |
| 4 | TN with NTN | NTN UL | TN UL |
| 5 | TN with NTN | NTN UL | TN DL |
| 6 | TN with NTN | TN DL | NTN UL |

Cells of a wireless communications system are shown at 510, 520, 530 in FIG. 5, BSs or TRPs are shown as gNBs in FIG. 5, and users are shown as UEs in FIG. 5. The possible scenarios in Table 1 are illustrative and non-limiting examples. The present disclosure can be generalized not only to address other network architectures, but also to other cross-links scenarios.

Reference is now made to the scenarios in Table 1.

In scenario 1, the DL TN interferes with the DL of NTN while in scenario 2 the UL of TN interferes with the UL of NTN. In scenario 3, the DL of NTN interferes with the DL of TN while in scenario 4 the UL of NTN interferes with the UL of TN. In scenario 5, the UL NTN interferes with the DL of TN while in scenario 6 the DL of TN interferes with the UL of NTN.

The present disclosure provides a method for measuring the coexistence cross-link interference at the victim UE for any system that operates in a coexisting communications systems environment. It introduces an algorithm for measuring the coexistence cross-link interference for any system that operates in a coexisting communications systems environment in DL. reference signals and some distributed special REs (empty REs, NZP CSI-RS REs, and CSI-IM REs) are used to do the interference measurements. Number of CSI-IM and NZP CSI-RS REs depends on the SCS, the size of the allocated BWP, the aggressor/s BW/s, and the coexistence scenario. The UEs receive the reference signals and do the measurements. Victim UEs in DL carry out the measurements and report them back to the serving/non-serving gNBs of the victim/aggressor(s) systems.

The number of REs, which may be or include any of empty REs, CSI-IM REs, and/or NZP CSI-RS REs, may depend on any of various factors or parameters, such as any one or more of the examples provided above (SCS, the size of the allocated BWP, the aggressor/s BW/s, the coexistence scenario), and/or others.

In some implementations, UEs do measurements on the empty/CSI-IM/NZP CSI-RS REs that are aligned with OFDM symbol(s), which is corresponding to a muted OFDM symbol(s) along the whole system bandwidth of the aggressor/s; this step is nulling the coexistence interference emitted from aggressor(s) during the measurements. In the existence of multiple aggressors, more than one OFDM symbol is muted, one per existed aggressor system, and the UEs do measurements in a similar manner accordingly. The UEs do measurements on the empty/CSI-IM/NZP CSI-RS REs that are aligned with specific REs of aggressor(s), which are corresponding to empty REs or muted subcarrier(s) of the aggressor(s). In the existence of multiple aggressors more than one subcarrier is muted, one per existed aggressor system. This step is nulling the in-band co-channel coexistence interference emitted from aggressor(s) during the measurements. The UEs do interference measurements at any other REs. Thus, the UEs measure cross-link coexistence interference at 1) the absence of the total cross-link coexistence interference to measure the level of other background sources of interference, 2) the presence of the adjacent channel coexistence interference emitted from aggressor(s) and the absence of the in-band co-channel coexistence interference, and 3) the absence of the adjacent channel coexistence interference and the presence of the in-band co-channel coexistence interference emitted from aggressor(s).

Then, the UE can calculate the average coexistence interference measurements amongst all PRBs in the allocated BWP and extracts the combined effective ACLR of the aggressor(s) systems(s). Consequently, the UE checks whether the combined ACLR of the aggressor/s meets the requirement of its ACS or not. Therefore, the method enables UEs to do an active measurement and tracking of the cross-link coexistence interference and consequently report active interference measurement to the serving/non-serving gNBs at a lower cost (only requires several REs in the BWP to be allocated for CSI-IM, NZP CSI-RS, and empty REs). Besides, the UEs can provide a feedback to the channel estimation algorithms to improve the channel estimation accuracy.

If the serving gNB finds that the victim UE, based on its provided reports, suffers from ACS that does not meet the requirements, then serving gNB applies an interference mitigation scheme: change PRBs (redefining BWP boundaries), change/switch to a different BWP, change the RSRP signal strength (Power control to accommodate current ACS).

An interference management and mitigation approach is also referred to herein as interference mitigation or an interference mitigation scheme, and can include, for example, any one or more of the following: changing scheduled or configured resources such as PRBs including redefining the boundaries of the BWP, applying a frequency offset, changing/switching the BWP because each UE can have up to 4 preconfigured BWPs in some deployments, avoiding scheduling in the impacted resources, changing the RSRP signal strength (to accommodate current ACS), changing the allocated power level (power control), switching a serving transmit beam, a receive beam or a beam pair link, hybrid beamforming, adaptive frequency hopping, and/or focused beamforming. Power control may involve updating/sending a transmit power control command to the victim UE. Hybrid or focused beamforming may involve reshaping the transmit beam it uses to communicate with the UE (for example, to use a more focused spot beam instead of a wider beam to increase the SINR of the victim UE). The serving gNB in the victim system can use the interference measurements to improve the channel estimation of the desired signal.

Interference mitigation may include the optional step of sending a request from the victim UE to the serving network device in the victim network to perform a certain kind of cross-link interference mitigation. The request may include the type of interference mitigation. Interference mitigation may also or instead include an indication or configuration step from the serving network device to the victim UE indicating the type of cross-link interference mitigation scheme to be applied, as well as one or more parameters to be applied such as any one or more of the following: BWP configuration, BWP switch indication, beam switch indication such as quasi-colocation (QCL) indication or transmission configuration indication (TCI) switch, and so on. Configuration signaling may be conveyed to the victim UE from the serving network device through downlink control information (DCI) in a physical downlink control channel (PDCCH), or through medium access control-control element (MAC-CE) or higher-layer signaling in a physical downlink shared channel (PDSCH), for example.

If coexistence interference cannot be mitigated by the victim system, then the victim system and aggressor(s) system(s) coordinate to do the interference management because it will be beneficial for all systems.

The present disclosure provides an algorithm for UEs that belong to any communications system, which operates in a coexisting communications systems environment, to measure the coexistence cross-link interference.

The present disclosure uses reference signals (CSI-RS) and some distributed special REs (empty REs, NZP CSI-RS REs, and CSI-IM REs) to do the cross-link coexistence interference measurements at the victim UEs in DL.

The present disclosure provides a method that the UEs using can provide a feedback to the channel estimation algorithms to improve the channel estimation accuracy in both UL and DL. UEs provide an active updated accurate interference measurement of the two types of coexistence interference measurements, which can work jointly with channel estimation algorithms to improve the channel estimation accuracy. This enables UEs to maintain a good quality of communication channel equalization.

The present disclosure provides a method that the UEs can identify the presence of the cross-link coexistence interference. This may enable UEs to detect the coexistence interference that may arise from multiple operators, via muted subcarrier for each operator. UEs can identify which operator that emits a higher interference among other coexisted operators.

The present disclosure may provide a method that the UEs can identify the source and the types of the cross-link coexistence interference. The UEs can measure the two types of the active updated level of the cross-link coexistence interference.

The present disclosure provides a method that UE reports (i.e., via a UCI in the PUCCH) to the gNBs, an active updated level of both adjacent and in-band co-channel coexistence interference in DL.

The present disclosure identifies the presence of cross-link coexistence interference. Some embodiments may enable a victim node to calculate the cross-link interference while the other aggressor(s) link(s) is/are configured to be blanked or muted at selected resources or resource elements including the victim system itself.

Some embodiments may identify the source and two types of the cross-link coexistence interference, namely in-band co-channel cross-link coexistence interference and out-of-band adjacent coexistence interference.

Some embodiments may expand the capability of victim nodes to do cross-link coexistence interference measurements in DL and reporting those measurements in UL to its serving or non-serving node. In the disclosure of the present invention, the two types of the cross-link coexistence interference are measured at the nodes of victim system. Each node measures an active updated level of the coexistence interference at the victim UEs/BSs of the victim system. Then the node of victim system (e.g., UE) reports an active updated level of both adjacent and in-band co-channel coexistence interference in DL to the serving and or non-serving cell via uplink message, e.g., an UCI in the PUCCH, or messages in the PUSCH).

Embodiments may help to improve channel estimation by providing an active updated accurate interference measurement. For example, embodiments can work jointly with channel estimation algorithms to improve the channel estimation accuracy and the combined effective ACLR of the aggressor(s) system(s) can then be extracted at the victim node (such as a UE) within the victim system.

The present disclosure encompasses embodiments that can work in various scenarios of coexisting systems with different connectivity modes (i.e., single and dual.), MCS, SCS, networks topology/architecture, and synchronous/asynchronous coexisting systems.

The present disclosure further includes embodiments that model a received signal (in UL or DL) at the node (such as a UE in DL) of the victim system or link by an equation (equation 2 below, for example) that contains three types of interference to classify and split the two types of the cross-link coexistence interference.

$$y = Hx + {A}_{I} + {C}_{I} + {R}_{I} + n \qquad ( 2 )$$

where H is the channel between victim node and its serving node in the victim system, x is the desired signal (can be NZP CSI-RS, or SRS in the case of uplink interference measurements), A_{I} is the adjacent channel coexistence interference, C_{I} is the in-band co-channel coexistence interference, R_{I} is the residual interference, and n is the noise. T_{I}=A_{I}+C_{I} is the total coexistence interference. There may be two possible scenarios:
1) Both A_{I} and C_{I} can exist when the operating bands of TN and NTN are either partially or fully overlapped. The operating bands are operating bands of coexisted systems/links (such as TN and NTN as an example).
2) Only A_{I} exists when the operating bands of TN and NTN are only adjacent but not overlapped. The operating bands are operating bands of coexisted systems/links (such as TN and NTN as an example).

Some embodiments may provide several alternative options in UL/DL to measure and extract the types of coexistence interference in the cross-link interference, which can be exploited in various ways.

The present disclosure may also provide several alternative options in DL to measure and extract the types of coexistence interference in the cross-link interference, which can be exploited in various ways. The several alternative options could be implemented separately, or combinations of at least two of the several alternative options could be implemented.

The method provided in the present disclosure may be easy to implement, and can be added via software and algorithms.

The method provided in the present disclosure may allow UEs to provide inputs that enable efficient interference mitigation algorithms either initiated by the UE or by gNB based on the reporting measurements.

The method provided in the present disclosure may give the UEs the flexibility to employ the measurements algorithm in various network configurations that accommodate various wireless communications scenarios and different networks architectures.

The method provided in the present disclosure may have a low computational complexity and be suitable for UEs (which have a limited power capability due to limited storage batteries).

By using the method provided in the present disclosure, UEs can work in both types of connectivity scenarios: single and dual, with ability to do dual reporting.

Measuring and reporting to the serving/non-serving gNBs can facilitate the coordination between multiple operators that are covering the same geographical region to address the cross-link coexistence interference and enhance the coexistence constructively.

UEs can extract and report the combined effective ACLR of the aggressor(s) system(s).

The present disclosure includes embodiments that can accommodate various wireless communications scenarios and different network architectures. It may be easy to implement and have a low computational complexity. It may build the foundation to enable several efficient interference mitigation algorithms and facilitate the integration of coexisting systems or links (e.g., NTN and TN links).

Some embodiments can be used as a technique to coordinate the coexistence of multiple operators that are covering the same geographical region, to address the cross-link coexistence interference that may arise from multiple operators.

The combined effective ACLR may depend on the carrier frequencies employed by the victim and the aggressor and can be estimated as:

$${ACLR}_{effective} = {ACLR}_{aggressor} - 10 * {log}_{10} ( {BW}_{victim} / {BW}_{aggresor} ) in dB \qquad ( 3 )$$

$${RE}_{Measured Interference} = {ACIR}_{weighted effective} = \frac{{ACLR}_{effective} * {ACS}_{victim}}{{ACLR}_{effective} + {ACS}_{victim}} \qquad ( 4 )$$

$${ACLR}_{effective} = \frac{{ACIR}_{effective} * {ACS}_{victim}}{{ACS}_{victim} - {ACIR}_{effective}} in linear scale \qquad ( 5 )$$

In some implementations of the present disclosure, UE Cross-link Coexistence Interference Measurement Algorithm is considered.

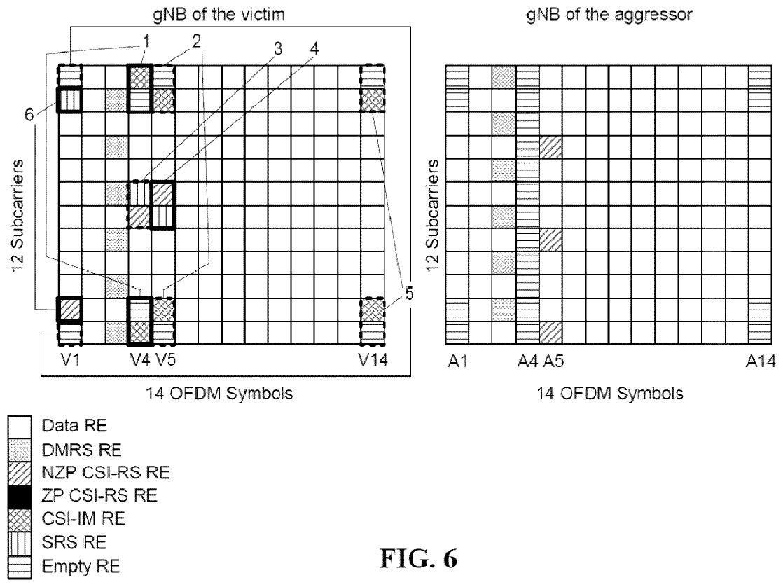

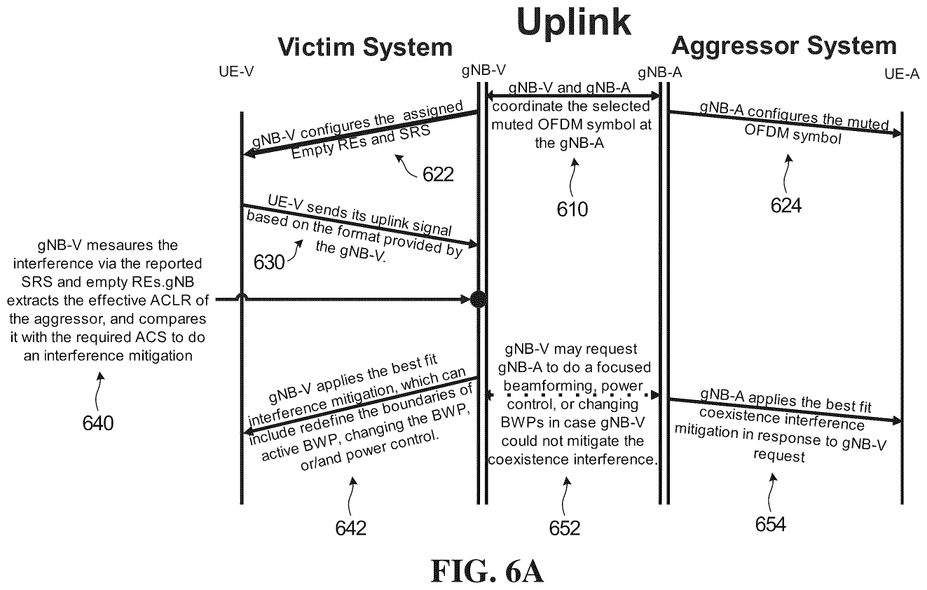

FIG. 6 illustrates slot formats of both a victim and an aggressor with steps illustrating where a UE may do measurements to calculate the cross-link coexistence interference.

The example in FIG. 6 will be useful in further understanding how different types of REs are associated with each other and may be used in interference measurement and management.

Interference measurement and management as disclosed herein are based in part on correspondence, which may also or instead be referred to as an association, between REs. In the example shown in FIG. 6, the slot format at the left relates to a victim system (NTN by way of example, and a network device slot format is shown), and the slot format at the right relates to an aggressor system (TN by way of example, and again a network device slot format is shown). A victim UE would use a counterpart of the victim gNB slot format, and similarly UE an aggressor UE would use a counterpart of the aggressor gNB slot format. In general, there is a correspondence or association of certain blanked or muted resources (which may be or include a single RE, a set of REs, or a whole OFDM symbol) in one link, or for communications over one link, and a subset of resources in another link. Such correspondence enables interference measurements to be taken. The subset of resources may be or include, for example, REs to carry certain types of signals (reference signals for example), or REs in which no communications or signals for an intended receiver are to be carried. RE configurations may be determined and configured by a network device, or multiple network devices in the case of different victim and aggressor network devices. Although victim and aggressor UEs receive RE configurations for the corresponding or associated resources, a UE itself need not necessarily be aware of the correspondence or association between those REs. UEs and network devices use the corresponding REs according to the configurations, but UEs can properly use the REs according to received configurations without having more information about RE correspondence.

As an example, consider a victim UE that is affected by interference from communications by an aggressor UE with an aggressor network device, consistent with the example shown in FIG. 6. All of the REs in the entire fourth time position A4 are empty in FIG. 6, and for simplicity in the example in FIG. 6 it is presumed that those REs correspond to the REs in the fourth time position V4 in the time-frequency grid at the victim gNB. Some of the REs in the time position V4 (in particular the REs other than the data REs) are configured to enable measurement of interference. All REs at the time position A4 are empty, and this may be an entire OFDM symbol for example. Blanking or muting all of the REs at A4 across the entire operating bandwidth is advantageous, to avoid adjacent channel interference during interference measurements at the victim system. There are also other corresponding or associated REs in the example shown in FIG. 6, which can be useful in interference measurement.

FIG. 6 shows in detail the steps of an algorithm that a UE may follow in a DL scenario, to measure the cross-link coexistence interference. In this algorithm the UE calculates each quantity of the interference type in equation (2).

Herein, determining interference may involve, for example, measuring interference or a component of interference, or calculating interference from multiple measurements.
1. By keeping x=0, A_{I}=0, and C_{I}=0 in equation (1) [symbol] yᵣ₁=R_{I}+n. This happens when a measurement is taken at an empty RE or a CSI-IM RE at the corresponding to a muted OFDM symbol(s) of the aggressor(s) as shown in FIG. 6.

Thus, 1 in FIG. 6 illustrates keeping x=0, A_{I}=0, and C_{I}=0 in equation (1), so that yᵣ₁=R_{I}+n, for a measurement taken at an empty RE or a CSI-IM RE corresponding to a muted OFDM symbol(s) of the aggressor(s).
2. By keeping x=o [symbol] yᵣ₂=A_{I}+C_{I}+R_{I}+n. This happens when a measurement is taken at any empty RE or a CSI-IM RE that does not belong to the corresponding muted OFDM symbol(s). Here, T_{I}=A_{I}+C_{I}=yᵣ₂−(R_{I}+n), where (R_{I}+n) can be found from step 1 in FIG. 6 (i.e., yᵣ₁). This is a direct measurement of the total coexistence interference T_{I}.

Thus, 2 in FIG. 6 illustrates keeping x=o, so that yᵣ₂=A_{I}+C_{I}+R_{I}+n, for a measurement taken at any empty RE or a CSI-IM RE that does not belong to the corresponding muted OFDM symbol(s). With T_{I}=A_{I}+C_{I}=yᵣ₂−(R_{I}+n), (R_{I}+n) can be found from a measurement consistent with step 1 (yᵣ₁ above), this direct measurement of interference which can be used (with another direct measurement, yᵣ₁ above) to determine the total coexistence interference T_{I}.
3. By keeping T_{I}=A_{I}+C_{I}=0 [symbol] yᵣ₃=Hx+R_{I}+n. This happens when a measurement of CSI-RS or SRS is taken at the corresponding muted OFDM symbol(s). Here we find Ĥ, therefore T_{I}=yᵣ₂-(yᵣ₃−Ĥx). This is an indirect measurement of the total coexistence interference T_{I}.

Thus, 3 in FIG. 6 illustrates keeping T_{I}=A_{I}+C_{I}=0, so that yᵣ₃=Hx+R_{I}+n, for a measurement of CSI-RS (or SRS for UL) taken at the corresponding muted OFDM symbol(s). Ĥ can be found based on yᵣ₃−yᵣ₁, and therefore T_{I}=yᵣ₂-(yᵣ₃-Ĥx). This is an indirect measurement or determination (by calculation based on multiple measurements) of the total coexistence interference T_{I}.
4. When A_{I}≠0 and C_{I≠}0 [symbol] y=Hx+T_{I}+R_{I}+n. This happens when a measurement of CSI-RS or SRS is taken at any RE that does not belong to the corresponding muted OFDM symbol(s). Here we find Ĥ, therefore T_{I}=y-Ĥx−(R_{I}+n), where (R_{I}+n) can be found from step 1 (i.e., yᵣ₁). When C_{I}=0 [symbol] A_{I}=y-Ĥx−(R_{I}+n).

Thus, 4 in FIG. 6 illustrates A_{I}≠0 and C_{I}≠0, so that y=Hx+T_{I}+R_{I}+n, for a measurement of CSI-RS (or SRS for UL) is taken at any RE that does not belong to the corresponding muted OFDM symbol(s). Here Ĥ can be found based on y-yᵣ₂, and therefore T_{I}=y−Ĥx−(R_{I}+n), where (R_{I}+n) can be found from a measurement consistent with step 1 (yᵣ₁ above). When C_{I}=0, (that is, a measurement is taken at an RE that is corresponding to an empty RE at the aggressor as at 6 for example, described below) then A_{I}=y-Ĥx−(R_{I}+n).
5. By keeping x=0 and C_{I}=0 [symbol] yᵣ₅=A_{I}+R_{I}+n. This happens when a measurement is taken at any empty RE or CSI-IM RE that is corresponding to an empty RE at the aggressor. A_{I}=yᵣ₅-(R_{I}+n), where (R_{I}+n) can be found from step 1 (i.e., yᵣ₁). This is a direct measurement of the adjacent coexistence interference A1. Both victim and aggressor gNBs can agree also on a muted subcarrier for nulling the in-band coexistence interference at the corresponding victim subcarrier.

Thus, 5 in FIG. 6 illustrates keeping x=0 and C_{I}=0, so that yᵣ₅=A_{I}+R_{I}+n, for a measurement taken at any empty RE or CSI-IM RE that is corresponding to an empty RE at the aggressor. A_{I}=yᵣ₅−(R_{I}+n), where (R_{I}+n) can be found from a measurement consistent with step 1 (yᵣ₁ above). This direct measurement of interference can be used (with another direct measurement, yᵣ₁ above) to determine the adjacent coexistence interference A1.
6. By keeping C_{I}=0 [symbol] yᵣ₆=Hx+A_{I}+R_{I}+n. This happens when a measurement of CSI-RS or SRS is taken at the corresponding aggressor's empty RE/muted subcarrier. Here we find Ĥ, therefore A_{I}=yᵣ₆-yᵣ₃.

Thus, 6 in FIG. 6 illustrates keeping C_{I}=0, so that yᵣ₆=Hx+A_{I}+R_{I}+n, for a measurement of CSI-RS (or SRS for UL) taken at an RE corresponding to an aggressor's empty RE/muted subcarrier.
7 (not shown in FIG. 6). The coexistence in-band interference can be found by C_{I}=T_{I}-A_{I}, with T_{I} from step 2 or 3 and A_{I} from step 5 or 6.

The steps demonstrate the low computational complexity, the multiple options to compute the quantity by different approaches, and how it is connected to the channel estimation.

In some implementations of the present disclosure, the method includes identifying the presence of other coexisting wireless communications systems.

A UE can do measurements at self-system muted subcarrier and self-system muted OFDM symbol to detect the presence of other coexisting wireless communication system. A serving gNB allocates one muted subcarrier and one muted OFDM symbol.

A UE may declare another/other system(s) coexistence if the corresponding measured interference in these REs is greater than the total sum of the background noise and UE's receiver noise figure.

A UE may declare a stand-alone system if the corresponding measured interference is less than or equal to the total sum of the background noise and the UE's receiver noise figure, then the system is free from any coexistence interference.

In some implementations of the present disclosure, a coexistence scenario of multiple aggressors is considered. The method provided in the present disclosure may have the scalability to enlarge into multiple dimensions. Therefore, a UE may address this case but equation (2) becomes a matrix. Consequently, the algorithm steps can run in parallel to calculate each type of interference that is emitted by each aggressor. With multiple aggressors, the gNB in the victim system that serves the victim node (or if the gNB itself is the victim node) may coordinate with the aggressor gNB in each aggressor system. Accordingly, one muted OFDM symbol along the whole system bandwidth and one muted subcarrier for each aggressor may be used while a UE does the measurements. The muted symbol/subcarrier for each aggressor should be different and not overlapped among aggressors if it is important to identify the source of interference. On the other hand, if it is only important to find the combined cross-link coexistence interference effect on the victim UE, then muted OFDM symbols and muted subcarriers in all aggressors can have the same indices.

In some implementations of the present disclosure, the method facilitates the integration of NTN and TN. For example, a UE may maintain a dual connectivity with both NTN and TN while both are coexisting. This may be especially useful where an NTN satellite frequency band is adjacent, partially overlapped, or fully overlapped (based on the deployment country) to NR TN bands that work either in TDD or FDD modes. Coexisting communication systems may operate in hybrid TDD-FDD mode.

A UE using features disclosed herein may provide both NTN and TN with real time cross-link coexistence interference measurement, which can reduce the deployment limitations of the NTN satellite band that may arise due to the severe interference upon the coexistence of NTN and TN.

In the downlink scenario, where an NTN UE is the victim, the victim system is the NTN, the aggressor system is the TN, and the aggressor nodes are the TN gNBs. Assuming the victim system adopts a dual connectivity mode, the cross-link interference measurements under these assumptions, the NTN DL (victim)/TN DL (aggressor) coexistence scenario will be done in order:
The TN gNB and NTN gNB coordinate the configuration of slot format. This may include a configuration for the TN and a configuration for the NTN, with corresponding REs as discussed herein.
The aggressor TN gNB configures: 1) a muted OFDM symbol over the whole system BW and 2) either a muted subcarrier or selected empty REs.
The serving NTN gNB at the victim system, which serves the victim UEs, configures CSI REs, in the allocated bandwidth of the victim UEs, corresponding to the muted OFDM symbol, which include: 1) a number of CSI-IM REs and 2) a number of NZP CSI-RS REs. Empty REs may be used in addition to or alternatively to CSI-IM RES (here and/or in the next step).
The serving NTN gNB at the victim system, which serves the victim UEs, configures CSI REs at any OFDM symbol, which include: 1) a number of CSI-IM RES and/or 2) a number of NZP CSI-RS REs to measure the total coexistence cross-link interference.
The serving NTN gNB at the victim system, which serves the victim UEs, configures empty REs/CSI-IM REs at the corresponding muted subcarrier or empty REs, which can be used to measure the adjacent coexistence cross-link interference.
Victim UE does a direct interference measurement on these REs. Besides, alternatively, victim UE can do an indirect interference measurement that will be estimated based on NZP CSI-RS.
Victim UE does a direct measurement of the signal strength of the received reference signals from the serving NTN gNB and reports it to TN gNB.
Victim UE extracts the combined effective ACLR of the coexisting aggressor system (i.e., TN).
Victim UE reports all of the interference measurements, types, and the extracted ACLR to the serving NTN gNB to check whether the equivalent ACS meets the requirement or not, if not it checks the alternatives to do the interference mitigation including a coordination with the aggressor system.

Please note that in the present disclosure, the number of the steps is just used to distinguish the steps, but does not limit the order of the steps, any order which could implement the method is reasonable. Please also note that some steps may be optional in some implementations. And some steps may be combined into one step in some implementations.

Other variations are also possible.

For example, embodiments for a single connectivity mode and embodiments for a dual connectivity mode are contemplated. Embodiments also are not in any way limited to UE measurements, and may also or instead provide or support measurements by a network device such as a gNB.

Such embodiments, for single or dual connectivity, and for UE or network device interference measurements, are considered in further detail below.

In some implementations of the present disclosure, uplink using a single connectivity mode is considered. It works in the presence of one aggressor or multiple aggressors. FIG. 6A shows the steps of operations in the UL scenario in a single connectivity mode, i.e., when UE can communicate with one serving gNB or maintain a single link to its serving gNB at a time.

FIG. 6A shows the steps of operations for cross-link coexistence interference management in the UL scenario in a single connectivity mode in the presence of a single aggressor link or beam pair link.

In FIG. 6A, a UE and a gNB in a victim system are shown as UE-V and gNB-V, and a UE and a gNB in an aggressor system are shown as UE-A and gNB-A.

Step 1: The gNB in the victim system coordinates with gNB of the aggressor system and agrees on a selected muted OFDM symbol that the aggressor system will configure along its whole carrier bandwidth and also a muted subcarrier or other selected muted REs, i.e., blanked or muted resource set, in the slots dedicated or scheduled for UL transmission.

This is shown by way of example at 610 in FIG. 6A. Although reference is made herein to a blanked or muted OFDM symbol to blank or mute all REs across the entire operating bandwidth at a particular time, it should be appreciated that more than one symbol may be blanked or muted. Reference is also made to the slots dedicated or scheduled for UL transmission, which are slots that are dedicated or scheduled for UL transmission in the victim system in this UL example.

Step 2: Both the gNB of the victim system and the gNB in the aggressor system configure and update their UL slot formats accordingly, where gNB of the aggressor configures the muted OFDM symbol and muted subcarrier or other selected distributed empty REs while in association or coordination with these configurations the gNB of the victim system configures the interference measurements REs (both empty REs and SRS REs) accordingly on the same time frequency locations in the OFDM resource grid. This is shown by way of example in FIG. 6A at 622 in the victim system and 624 in the aggressor system.

Step 3: UE which has the ability to establish connection only to its serving gNB at the victim system sends its uplink signals according to the provided slot formats, including not transmitting any signals or channels on the preassigned REs for interference measurements and transmitting reference signals on the resources configured for SRS transmission (SRS REs). The serving gNB at the victim system will carry out measurements on the muted REs in addition to detecting and receiving the SRS transmitted by the UE.

This is shown by way of example at 630 in FIG. 6A. The UE-V sends (and the gNB-V receives) uplink signals according to the provided slot formats. The preassigned REs for interference measurements may be referred to as empty REs.

Step 4: The serving gNB at the victim system receives the signals transmitted by the UE and carries out measurements on the received reference signals (SRS REs) and muted REs for interference measurements. The serving gNB in the victim system will calculate each type of the cross-link coexistence interference (in-band and adjacent channel interference), extract the combined effective ACLR and compare it with its receiver's ACS. Based on the measurement results, the serving gNB may carry out an interference management and mitigation approach that can include: Redefining the boundaries of the BWP, changing the BWP because each UE can have up to 4 preconfigured BWPs, update/send the transmit power control command to the UE, and/or reshape the transmit beam it uses to communicate with the UE, e.g., use a more focused spot beam instead of a wider beam to increase the SINR of the UE. The serving gNB can use the interference measurements to improve the channel estimation of the desired signal.

FIG. 6A illustrates, at 640, the serving gNB-V at the victim system receiving the signals transmitted by the UE at 630 and carrying out measurements. At 642, FIG. 6A illustrates the serving gNB-V carrying out an interference management and mitigation approach based on the measurement results.

An interference management and mitigation approach is also referred to herein as interference mitigation or an interference mitigation scheme, and can include, for example, any one or more of the following: changing scheduled or configured resources such as PRBs including redefining the boundaries of the BWP, changing/switching the BWP because each UE can have up to 4 preconfigured BWPs in some deployments, avoiding scheduling in the impacted resources, changing the RSRP signal strength (to accommodate current ACS), changing the allocated power level (power control), switching a serving transmit beam, a receive beam or a beam pair link, hybrid beamforming, adaptive frequency hopping, and/or focused beamforming. Power control may involve updating/sending a transmit power control command to the UE-V. Hybrid or focused beamforming may involve reshaping the transmit beam it uses to communicate with the UE (for example, to use a more focused spot beam instead of a wider beam to increase the SINR of the UE-V). The serving gNB-V can use the interference measurements to improve the channel estimation of the desired signal.

Step 5: The serving gNB may also coordinate with the aggressor gNB to reduce the emitted cross-link interference, which degrades the performance of the victim system. The gNB in the aggressor system may carry out an interference management and mitigation on its own system to reduce the interference caused by its system on the victim system. Accordingly, the gNB in the aggressor system finds its best fit interference mitigation approach and applies it on itself and its serving nodes, which can include: redefine the boundaries of the BWP configured to the UEs it is serving, changing the BWP because each UE can have up to 4 preconfigured BWPs, updating the power control commands for some UEs it is serving, and/or changing the shape of the beams it is using to communicate with the UE it is serving.

At 652, FIG. 6A illustrates the serving gNB-V coordinating with the aggressor gNB-A to reduce the emitted cross-link interference. FIG. 6A also illustrates, at 654, the gNB-A carrying out an interference management and mitigation on its own system. A best fit interference mitigation approach may include any one or more of the examples provided above, and may also include adaptive frequency hopping, for example. The reference to 4 preconfigured BWPs is also an example that may apply in some deployments.

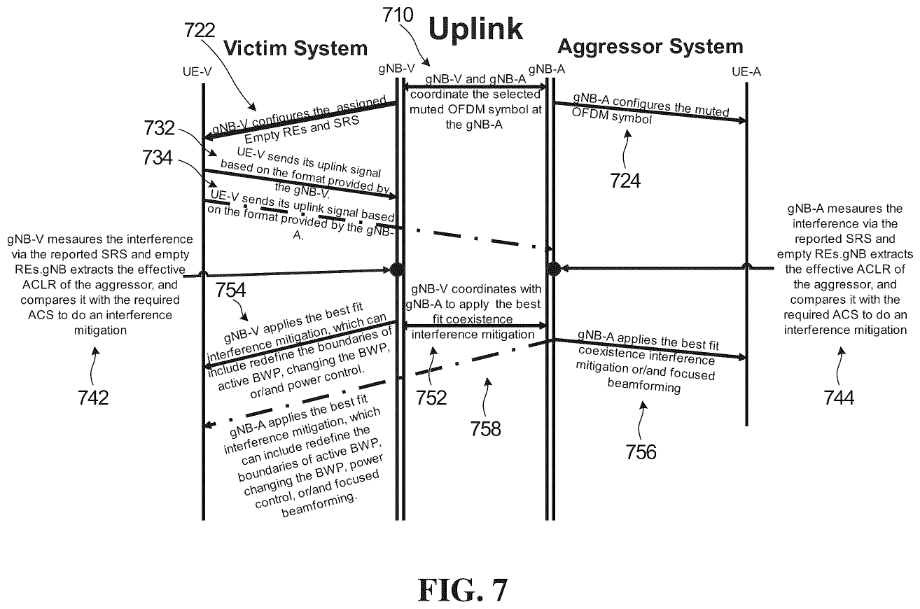

In some implementations, uplink using a dual connectivity mode is considered. It works in the presence of one aggressor or multiple aggressors. FIG. 7 shows the steps of operations in the UL scenario in a dual connectivity mode respectively. It works in the presence of one aggressor or multiple aggressors. FIG. 7 shows the steps of operations for cross-link coexistence interference management of the invention in the UL scenario in a dual connectivity mode, i.e., UE can communicate or establish a connection with both the victim and aggressor gNBs, in the presence of one aggressor's system/link. The example shown in FIG. 7 relates to cross-link interference measurements and management in a UL scenario with existence of a single aggressor using a dual connectivity mode with the aggressor.

Step 1: The gNB in the victim system coordinates with gNB of the aggressor system and agrees on a selected muted OFDM symbol that the aggressor system will configure along the whole carrier bandwidth of the aggressor link/system and also on a set of muted subcarriers or other selected muted distributed REs in the UL slots.

This is shown by way of example at 710 in FIG. 7.

Step 2: Both the gNB of the victim system and the gNB of the aggressor system configure and update their UL slot formats accordingly, where gNB of the aggressor configures the muted OFDM symbol and muted subcarrier or other selected distributed empty REs. At the same time, the gNB of the victim system configures the interference measurements REs (both empty REs and SRS REs) accordingly, i.e., on the corresponding same time frequency locations in the OFDM resource grid.

This is shown in FIG. 7 at 722 in the victim system and 724 in the aggressor system, with both the gNB-V of the victim system and the gNB-A of the aggressor system configuring and updating their UL slot formats. The gNB-A of the aggressor configures the muted OFDM symbol and muted subcarrier or other selected distributed empty REs at 724, and, at the same time in some embodiments, the gNB-V of the victim system configures the interference measurement at 722.

Step 3: UE which has the ability to establish a dual connectivity with both gNBs sends its uplink signals according to the indicated/configured slot formats, i.e., UE may not transmit any signal or channel on the muted REs for interference measurements and may send the SRS on the REs configured for SRS transmission.

This is shown in FIG. 7 as the UE-V sending uplink signals at 732, 734.

Step 4: Both gNBs receive the signals transmitted by the UE and carry out measurements on the received reference signals (SRS REs) and indicated REs for interference measurements. Each gNB may calculate each type of the cross-link coexistence interference (in-band and adjacent channel interference) and extracts the combined effective ACLR and compare it with its receiver's ACS. The gNB of the aggressor system now will be aware of the interference caused by its system on the victim system. Accordingly, both gNBs (in the victim system and the aggressor system) coordinates based on this information to carry out an interference management and mitigation approach. Both gNBs may carry out similar or different interference mitigation approaches that can include: Redefining the boundaries of the BWP, changing the BWP because each UE can have up to 4 preconfigured BWPs, power control, and/or focused beamforming. Both the two gNBs can use the interference measurements to improve the channel estimation.

FIG. 7 illustrates the gNBs receiving the signals transmitted by the UE at 732, 734 and carrying out measurements, and also illustrates the gNBs coordinating with each other at 752 to carry out an interference management and mitigation approach. The interference mitigation approaches may include one or more of the following: changing scheduled or configured resources such as PRBs including redefining the boundaries of the BWP, changing/switching the BWP because each UE can have up to 4 preconfigured BWPs in some deployments, avoiding scheduling in the impacted resources, changing the RSRP signal strength (to accommodate current ACS), changing the allocated power level (power control), switching a serving transmit beam, a receive beam or a beam pair link, hybrid beamforming, adaptive frequency hopping, and/or focused beamforming.

Interference mitigation signaling is shown by way of example at 754 between the gNB-V and the UE-V, at 756 between the gNB-A and the UE-AI and at 758 between the gNB-A and the UE-V.

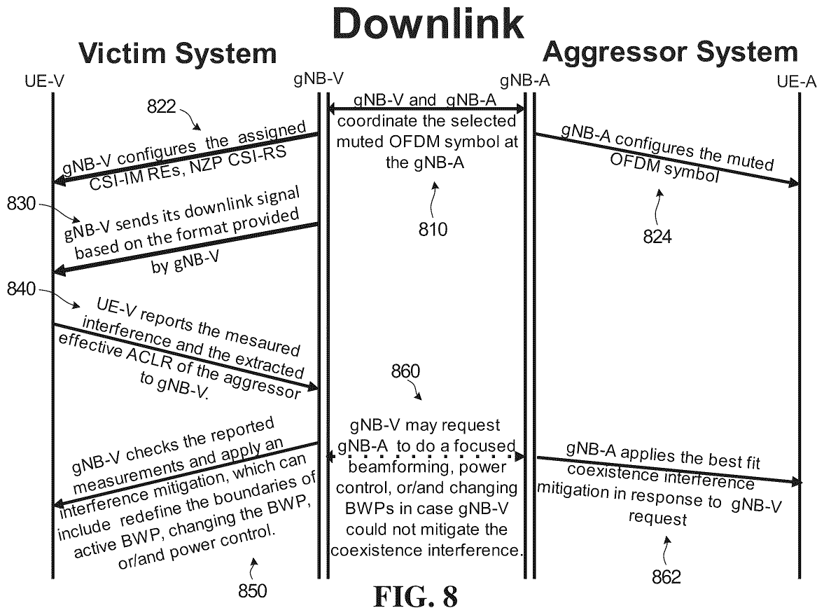

In some implementations, downlink using a single connectivity mode is considered. It works in the presence of one aggressor or multiple aggressors. FIG. 8 shows the steps of operations of an embodiment in the DL scenario in a single connectivity mode respectively, i.e., victim UE can connect to victim gNB but not aggressor gNB.

It works in the presence of one aggressor or multiple aggressors. FIG. 8 shows the steps of operations for cross-link coexistence interference management of the invention in the DL scenario in a single connectivity mode, in the presence of one aggressor's system. Step 1: The gNB in the victim system coordinates with gNB of the aggressor system and agrees on a selected muted OFDM symbol that the aggressor system will configure along its whole system and/or carrier bandwidth and also a muted subcarrier or other selected muted distributed REs in the slots configured or allocated for DL transmission.

This is shown by way of example at 810 in FIG. 8, in which the slots configured or allocated for DL transmission are in the victim system in this DL example.

Step 2: Both the gNB of the victim system and the gNB in the aggressor system configure and update their DL slot formats accordingly, where gNB of the aggressor configures the muted OFDM symbol and muted subcarrier or other selected distributed empty REs while in same resources in the OFDM time-frequency grid the, gNB of the victim system configures the interference measurements REs (empty REs, NZP CSI-RS REs and CSI-IM REs). Although empty REs are not explicitly shown at 822, in downlink empty REs and CSI-IM REs, only CSI-IM REs, or only empty REs may be used.

This step is illustrated in FIG. 8 at 822 in the victim system and 824 in the aggressor system, where the gNB-A of the aggressor configures the muted OFDM symbol and muted subcarrier or other selected distributed empty REs at 824 while in same corresponding resources in the OFDM time-frequency grid the gNB-V of the victim system configures the interference measurements REs (empty REs, NZP CSI-RS REs and CSI-IM REs) at 822. Although empty REs are not explicitly shown at 822, in downlink empty REs and CSI-IM RES, only CSI-IM REs, or only empty REs may be used.

Step 3: UE which has the capability to establish a connection to its serving gNB at the victim system receives the downlink transmitted signals according to the configured/indicated slot formats, which carried the pre-assigned REs for interference measurements and reference signals (NZP CSI-RE, CSI-IM REs), which all of these received REs and reference signals need to be measured at receiver of UE at the victim system. The UE carries on measurements on the received reference signals (NZP CSI-RE, CSI-IM REs) and preassigned REs for interference measurements. The UE in the victim system will calculate each type of the cross-link coexistence interference (in-band and adjacent channel interference) and extracts the combined effective ACLR and compare it with its receiver's ACS. The UE can use these measurements to improve the channel estimation.

This step is illustrated in FIG. 8 at 830, in which the UE-V receives downlink transmitted signals that are carried in pre-assigned REs. REs in which signals are carried may include REs for reference signals (NZP CSI-REs, for example). REs may also include REs for interference measurements (empty REs and/or CSI-IM REs, for example). These received reference signals are measured at the receiver, which is UE-V at the victim system in the example shown. The UE-V carries out measurements on the received reference signals and in the preassigned REs for interference measurements (empty REs, CSI-IM REs, for example). The UE-V calculates each type of the cross-link coexistence interference (in-band and adjacent channel interference), extracts the combined effective ACLR, and compares it with its receiver's ACS in some embodiments, and can use the measurements to improve channel estimation.

Step 4: The UE through UCI reports the measurements to the serving gNB.

This is shown by way of example at 840 in FIG. 8. The UE-V may report the measurements to the serving gNB-V through UCI for example.

Step 5: Accordingly, the serving gNB does an interference management and mitigation approach that can include: redefine the boundaries of the BWP, changing the BWP because each UE can have up to 4 preconfigured BWPs, power control, and/or focused beamforming. The serving gNB can use the reported information to improve the channel estimation.

At 850, FIG. 8 illustrates the serving gNB-V performing an interference management and mitigation approach. The interference management and mitigation approach, may be also referred to herein as interference mitigation or an interference mitigation scheme, and it can include, for example, any one or more of the following: changing scheduled or configured resources such as PRBs including redefining the boundaries of the BWP, changing/switching the BWP because each UE can have up to 4 preconfigured BWPs in some deployments, avoiding scheduling in the impacted resources, changing the RSRP signal strength (to accommodate current ACS), changing the allocated power level (power control), switching a serving transmit beam, a receive beam or a beam pair link, hybrid beamforming, adaptive frequency hopping, and/or focused beamforming. The serving gNB-V can use the reported information received at 840 to improve the channel estimation.

Step 6: In case the serving gNB fails to do the best fit interference management and mitigation on its own, the serving gNB coordinates with the gNB at the aggressor system to reduce emitted cross-link interference, which degrades the performance of the victim system. The gNB in the aggressor system does an interference management and mitigation on its own system to reduce the interference caused by its system on the victim system. Accordingly, the gNB in the aggressor system finds its best fit interference mitigation approach and apply it on itself and its serving nodes, which can include: redefine the boundaries of the BWP, changing the BWP because each UE can have up to 4 preconfigured BWPs, power control, and/or focused beamforming.

At 860, FIG. 8 illustrates the serving gNB-V coordinating with the gNB-A to reduce emitted cross-link interference. At 862, FIG. 8 illustrates the gNB-A performing an interference management and mitigation on its own, to reduce the interference caused by its system on the victim system. The best fit interference mitigation approach found by the gNB-A may include, for example, any one or more of the following: changing scheduled or configured resources such as PRBs including redefining the boundaries of the BWP, changing/switching the BWP because each UE can have up to 4 preconfigured BWPs in some deployments, avoiding scheduling in the impacted resources, changing the allocated power level (power control), switching a serving transmit beam, a receive beam or a beam pair link, hybrid beamforming, adaptive frequency hopping, and/or focused beamforming.

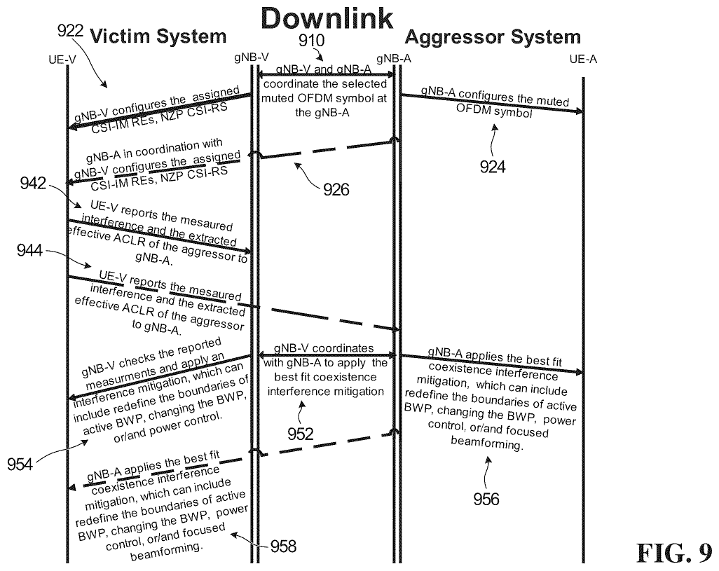

In some implementations, downlink using a dual connectivity mode is considered. It work in the presence of one aggressor or multiple aggressors. FIG. 9 shows the steps of operations of the invention in the DL scenario in a dual connectivity mode respectively, i.e., victim UE can connect to both victim gNB and aggressor gNB.

It works in the presence of one aggressor or multiple aggressors. FIG. 9 shows the sequence of operations for cross-link coexistence interference management of the invention in the DL scenario in a dual connectivity mode at the presence of one aggressor's system. Step 1: The gNB in the victim system coordinates with gNB of the aggressor system and agrees on a selected muted OFDM symbol that the aggressor system will configure along its whole system bandwidth and also a muted subcarrier or other selected muted distributed REs in the DL allocated slots.

This is shown by way of example at 910 in FIG. 9.

Step 2: Both the gNB of the victim system and the gNB in the aggressor system configure and update their DL slot formats accordingly, where gNB of the aggressor configures the muted OFDM symbol and muted subcarrier or other selected distributed empty REs while in corresponding to these configurations the gNB of the victim system configures the interference measurements REs (empty REs, NZP CSI-RS REs and CSI-IM REs) accordingly. Although empty REs are not explicitly shown at 922 or 926, empty REs may be used.

In FIG. 9, the gNB-A of the aggressor configures the muted OFDM symbol and muted subcarrier or other selected distributed empty REs at 924, and corresponding to these configurations the gNB-V of the victim system (at 922) and the gNB-A in coordination with the gNB-V (at 926) configure the interference measurements REs. Although empty REs are not explicitly shown at 922 or 926, empty REs may be used.

Step 3: UE which has the ability to establish a dual connection with both two gNBs (with the gNB at the victim system and with gNB at the aggressor system) receives the downlink transmitted signals from the two gNBs, which followed the provided slot formats and carried the pre-assigned REs for interference measurements and reference signals (NZP CSI-RE, CSI-IM REs). All of these received REs and reference signals need to be measured at receiver of UE at the victim system. The UE carries on measurements on the received reference signals (NZP CSI-RE, CSI-IM REs) and preassigned REs for interference measurements. The UE in the victim system will calculate each type of the cross-link coexistence interference (in-band and adjacent channel interference) and extracts the combined effective ACLR and compare it with its receiver's ACS. The UE can use these measurements to improve the channel estimation.

In FIG. 9, UE-V has the ability to establish a dual connection with both of the gNBs (gNB-V and gNB-A), and receives downlink transmitted signals from the two gNBs. The signals follow the provided slot formats and are carried in pre-assigned REs. REs in which signals are carried may include REs for reference signals (NZP CSI-REs, for example). REs may also include REs for interference measurements (empty REs and/or CSI-IM REs, for example). The downlink transmitted signals are not shown in FIG. 9 in order to avoid further congestion in the drawing.

Step 4: The UE through UCI reports the measurements to the both two gNBs.

At 942, 944 FIG. 9 illustrates the UE-V reporting the measurements to both of the gNBs, through UCI for example.

Step 5: The gNB of the aggressor system now will have a knowledge about the interference caused by its system on the victim system. Accordingly, both two gNB (in the victim system and the aggressor system) coordinate based on the findings to do an interference management and mitigation approach, where each gNB does similar or different interference mitigation that can include: redefine the boundaries of the BWP, changing the BWP because each UE can have up to 4 preconfigured BWPs, power control, and/or focused beamforming. Both the two gNBs can use the interference measurements to improve the channel estimation.

With reference again to FIG. 9, as a result of the reporting at 944, the gNB-A of the aggressor system will have knowledge about the interference caused by its system on the victim system. The gNBs (gNB-V and gNB-A) may coordinate at 952 to do an interference management and mitigation approach. The interference mitigation can include any one or more of the following, for example: changing scheduled or configured resources such as PRBs including redefining the boundaries of the BWP, changing/switching the BWP because each UE can have multiple (up to 4 for example) preconfigured BWPs in some deployments, avoiding scheduling in the impacted resources, changing the allocated power level (power control), switching a serving transmit beam, a receive beam or a beam pair link, hybrid beamforming, adaptive frequency hopping, and/or focused beamforming. Signaling related to interference mitigation is shown at 954 between the gNB-V and the UE-V, at 956 between the gNB-A and the UE-AI and at 958 between the gNB-A and the UE-V.

In some implementations, a method to identify the presence of other coexisted wireless communications systems is provided.

Embodiments can be used within a wireless communication system itself to detect the presence of other coexisted wireless communication system within its coverage area.

The system (e.g., the network device) may allocate one muted subcarrier and one muted OFDM symbol and do an interference measurement in both UL and DL.

If the corresponding measured interference is equal or less than a threshold, e.g., the total sum of the background noise and the receiver noise figure, then the system is free from any coexistence interference.

If the corresponding measured interference is greater than the threshold, e.g., the total sum of the background noise and the receiver noise figure, then there is coexisted system(s) in place.

In some implementations, a coexistence scenario of multiple aggressors is addressed by allocating one muted OFDM symbol along the whole system bandwidth and one muted subcarrier for each aggressor. However, the muted symbol/subcarrier for each aggressor should be different and not overlapped among aggressors to ensure orthogonality. In this scenario (e.g., FIG. 6A to FIG. 9) multiple aggressor can be existed, where the BS in the victim system that serves the victim node (or if the BS itself is the victim node) coordinates with the aggressor BS in each aggressor system.

The disclosure may facilitate the integration of NTN and TN because NTN satellite frequency band is adjacent, partially overlapped, or fully overlapped (based on the deployment country) to NR TN bands that work either in TDD or FDD modes. Implementations in the present disclosure may help reduce the deployment limitation of the NTN satellite band that may arise due to the severe interference upon the coexistence of NTN and TN, which triggers overlapped/adjacent channel performance's degradation.

In some implementations, steps to measure the cross-link coexistence interference in the uplink scenario are provided, here, the following example assumptions are used: the victim system is the NTN system, the aggressor system is the TN, the victim node is the (gNB-V, which is here the gNB-NTN), the aggressor nodes are the gNBs-TN and the UEs-TN, and the victim system adopts a single connectivity mode. Accordingly, under these assumptions, the steps for NTN UL (victim)/TN (aggressor) coexistence scenario includes one or more of the following steps:
1. Aggressor TN gNB configures: 1) a muted OFDM symbol over the whole system BW and 2) either a muted subcarrier or selected empty REs.
2. Victim NTN gNB configures the REs in the allocated bandwidth, corresponding to the muted OFDM symbol to include: 1) a number of SRS REs and 2) a number of empty REs.
3. Victim NTN gNB configures empty REs at any OFDM symbol, which can be used to measure the total coexistence interference.
4. Victim NTN gNB configures empty REs/CSI-IM REs at the corresponding muted subcarrier or empty REs, which can be used to measure the adjacent coexistence interference.
5. Victim NTN gNB does a direct/indirect interference measurement on these REs.
6. Victim NTN gNB extracts the combined effective ACLR of the coexisted aggressor system (i.e., TN).
7. Victim NTN gNB checks whether the equivalent ACS meets the requirement or not, if not it checks the available options to do the interference mitigation including a coordination with the aggressor system if needed.

Please note that in the example above, the number of the steps is just used to distinguish the steps, but does not limit the order of the steps, any order which could implement the method is reasonable. Please also note that some steps may be optional in some implementations. And some steps may be combined into one step in some implementations.

### OVERVIEW

Various aspects of the present disclosure are described herein and shown in the drawings by way of example. Embodiments are also considered more generally below.

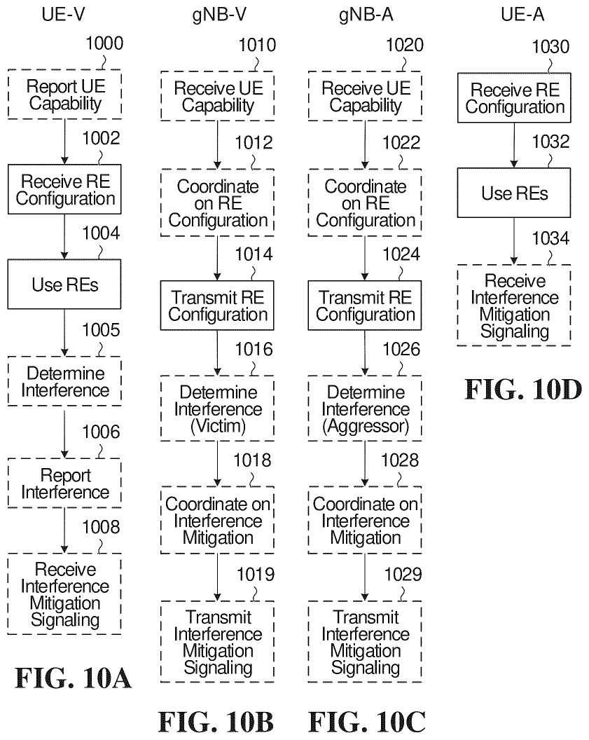

FIGS. 10A to 10D are flow diagrams illustrating more general example methods according to embodiments. FIG. 10A is a flow diagram illustrating an example method implemented at a victim UE in an embodiment, FIG. 10B is a flow diagram illustrating an example method implemented at a victim network device in an embodiment, FIG. 10C is a flow diagram illustrating an example method implemented at an aggressor network device in an embodiment, and FIG. 10D is a flow diagram illustrating an example method implemented at an aggressor UE in an embodiment. Victim and aggressor are convenient labels that are used herein for ease of reference, but these terms may or may not be used elsewhere. In the following discussion of FIGS. 10A to 10D, a first UE is affected by interference (and may also be referenced as a victim UE), the first UE communicates with a first network device in a first wireless system (a serving gNB in a victim system, also referred to herein as a victim gNB or a victim network device, is an example), and communications by a second UE, with the same network device or a different network device, are causing or contributing to the interference. A second UE is also referred to herein as an aggressor UE.

Co-existence scenarios, in which different communication systems co-exist, represent one possible application of aspects of the present disclosure. However, in the general context of communications between a first UE and a first network device being affected by interference due to communications by a second UE, there is not necessarily always a second wireless communication system in which the second UE is communicating with a different (second) network device. Embodiments disclosed herein encompass cross-link interference measurement and management, and links could be from the same or different wireless systems. Regarding links from the same wireless system, such links could be links from the same cell, corresponding to different beams of the same cell for example, or links from different cells of the same wireless system.

With reference first to FIG. 10A, a method implemented at a victim UE may involve receiving, at 1002, by a first UE from a first network device in a first wireless communication system, a configuration of a plurality of first REs. As described in further detail herein, the first REs are for determination of different components of interference. For example, measurements of components of interference may be taken, and used in determining overall interference such as interference that affects communications between the first UE and the first network device. In this sense, REs may be considered as being for measurement(s) of interference or components thereof to be taken, and/or for determination of interference or components thereof. REs may also be described as enabling (or to enable) measurement(s) of interference or components thereof to be taken, and/or enabling (or to enable) determination of interference or components thereof.

The first REs include REs (at time position V4 in FIG. 6, for example) that correspond to a subset of REs in a set of second REs that includes all REs at a time position (A4 in FIG. 6, for example) in a time-frequency grid that are muted for communications by a second UE. Examples of a first UE receiving such a configuration from a first network device are shown at 622 in FIG. 6A, 722 in FIG. 7, 822 in FIGS. 8, and 922 in FIG. 9, and are described above with reference to a UE and gNB in a victim system.

The first REs also include an RE that corresponds to an RE at a different time position in the time-frequency grid. The different time position is different from the time position (A4 in FIG. 6, for example) at which all REs are muted for communications by the second UE. Examples of first REs at different time positions include NZP CSI-RS REs, CSI-IM REs, SRS REs, and empty REs at positions other than V4 at the left in FIG. 6, and these correspond to REs in the second set of REs at time positions other than A4 at the right in FIG. 6.

A configuration of first REs may be periodic, semi-persistent, or triggered by an event. For a periodic configuration, the first REs may be configured such that they recur periodically or the configuration may be transmitted to and received by the first UE periodically. For triggered (or in other words aperiodic) configuration, whether an RE is used for (or to enable) interference measurement or for some other purpose may be dependent upon occurrence of a triggering event, or the configuration may be transmitted to and received by the first UE responsive to occurrence of a triggering event. Any of various types of triggering events may trigger such an RE configuration, and a triggering event could be just based on a network decision for example.

The UE may receive the configuration periodically, or the first REs in the configuration may be periodic. For example, measurement resources such as REs, RSs, and so on, can be periodic with periodicity that can be expressed in units of time (absolute) or in terms of frames, symbols, slots, and so on.

There can be three types of the RS transmission (CSI-IM can be called RS even through it is just a resource) in the time domain:
periodic (no dynamic triggering/activation), wherein measurement feedback may also be periodically reported, in PUCCH for example;
aperiodic: or event triggered, usually measurement and/or reporting is triggered by MAC CE or DCI and reporting is carried out via physical uplink shared channel (PUSCH); semi-persistent (mix of periodic and non-periodic) with reporting on PUCCH or PUSCH-semi-persistent could be interpreted as periodic in between receiving and the activation and deactivation triggers (MAC-CE and/or DCI for example) by the UE.

The first REs may include any of various types of REs, such as an RE in which there is to be no communication between the first UE and the first network device. Such an RE may also or instead be described as an RE in which the first UE may assume that there no communication between the first UE and the first network device. Examples of this type of RE include empty REs and CSI-IM REs. Both of these types of REs are shown in FIG. 6, and the empty REs and CSI-IM REs at time position V4 in FIG. 6 correspond to the blanked or muted REs at time position A4. As shown in FIG. 6, such REs may also be configured elsewhere in a time-frequency grid (at a different time position as referenced herein), and are not restricted only to correspondence with blanked or muted resources at time positions at which all resources are blanked or muted. Empty REs and CSI-IM REs are also configured at time positions V5 and V14, for example, which correspond to non-empty REs at time position A5 or empty REs at time position A14 where not all REs are blanked or muted.

The first REs may also or instead include a reference signal RE, in which a reference signal is to be communicated between the first UE and the first network device. Examples of this type of RE include NZP CSI-RS REs (for DL interference measurement) and SRS REs (for UL interference measurement). Both of these types of REs are shown in FIG. 6, and those at time position V4 in FIG. 6 correspond to the blanked or muted REs at time position A4. As shown in FIG. 6, such REs may also be configured elsewhere in a time-frequency grid (at a different time position as referenced herein), and are not restricted only to correspondence with blanked or muted resources at time positions at which all resources are blanked or muted. NZP CSI-RS RES and SRS are also configured at time positions V1 and V5 in the example shown in FIG. 6. These REs at time position V1 correspond to empty REs at time position A1 where not all REs are blanked or muted, and these REs at time position V5 correspond to non-empty REs at time position A5.

A method may also involve using the first REs by the first UE according to the configuration, for determination of different components of interference that affects communications between the first UE and the first network device. This is illustrated in FIG. 10A at 1004. Using the first REs may include, for example, transmitting UL signals to the first network device as shown by way of example at 630 in FIGS. 6A and 732 in FIG. 7. UL signals may be or include SRS and/or other signals. Using the first REs may also or instead include receiving DL signals from the first network device as described by way of example herein, including at least above with reference to FIGS. 8 and 9. In some embodiments, using the first REs may involve measuring the interference, which may be referred to as performing or taking an interference measurement, using a first RE. The first UE may perform a measurement based on a reference signal received in a reference signal RE, or perform a measurement during an empty RE or a CSI-IM RE for example. Regarding empty REs or CSI-IM REs, using such REs by the first UE may involve the UE not communicating with (that is, not transmitting any signals to or receiving any signals from) the first network device so that the network device can perform a measurement. Therefore, it should be appreciated that using the first REs need not necessarily involve the first UE communicating with the first network device.

Some embodiments involve the first UE performing one or more measurements, and possibly reporting interference or measurements to the first network device. In such embodiments, a method may involve transmitting, by the first UE to the first network device, an indication of a capability of the first UE to measure, and possibly report, the interference to the first network device. Transmitting an indication of one or more capabilities is shown by way of example as “Report UE Capability” at 1000 in FIG. 10A as an optional feature. The configuration may then be received by the first UE at 1002 responsive to transmitting the indication of the capability at 1000.

A method implemented at a UE may involve determining and reporting interference, and these are also shown as optional features at 1005, 1006 in FIG. 10A.

Regarding interference determination, determining interference may involve, for example, measuring interference or a component of interference, and/or calculating interference from multiple measurements.

In some embodiments, the first REs include an RE, in which there is to be no communication between the first UE and the first network device, that corresponds to an RE at the time position at which all REs are muted. Such an RE in which there is to be no communication between the first UE and the first network device is not used for communication between the first UE and the first network device, but is used for a measurement to be taken of a component of the interference that includes residual interference and noise.

For example, according to equation 2 above y=Hx+A_{I}+C_{I}+R_{I}+n. As also described at least above, 1 in FIG. 6 illustrates keeping x=0, A_{I}=0, and C_{I}=0 in equation (1), so that yᵣ₁=R_{I}+n. This happens when a measurement is taken at an empty RE or a CSI-IM RE corresponding to a muted OFDM symbol(s) of the aggressor(s) as shown in FIG. 6. An empty RE or a CSI-IM RE at time position V4 in FIG. 6 is an example of an RE in which there is to be no communication between the first UE and the first network device, and that corresponds to an RE at the time position at which all REs are muted (at time position A4 in FIG. 6), and yᵣ₁=R/+n is an example of a component of the interference that includes residual interference and noise. In this example, this component of the interference can be measured directly, and therefore using the first REs or determining interference or a component thereof may involve measuring, or taking or performing a measurement, of a component of the interference (such as yᵣ₁=R/+n) that includes residual interference and noise.

The first REs may also or instead include an RE, in which again there is to be no communication between the first UE and the first network device, but that corresponds to an RE at a different time position in the time-frequency grid that is different from the time position at which all REs are muted for communications by the second UE. The RE in which there is to be no communication between the first UE and the first network device in this example is not used for communication between the first UE and the first network device, but is used for a measurement to be taken of interference that includes a component of the interference caused by communications by the second UE, and a component of the interference that includes residual interference and noise.

At 2, FIG. 6 illustrates keeping x=o in equation 2, so that a measurement under this condition yᵣ₂=A_{I}+C_{I}+R_{I}+n. This happens when a measurement is taken at any empty RE or a CSI-IM RE that does not belong to the corresponding muted OFDM symbol(s). These REs, at time positions other than V4 in FIG. 6, are examples of an RE in which there is to be no communication between the first UE and the first network device but that corresponds to an RE at a different time position in the time-frequency grid that is different from the time position (A4 in FIG. 6, for example) at which all REs are muted for communications by the second UE. yᵣ₂ is an example of interference that includes a component of the interference caused by communications by the second UE (T)=A_{I}+C_{I}), and a component of the interference that includes residual interference and noise (R_{I}+n). In this example, using the first REs or determining interference or a component thereof may involve measuring, or taking or performing a measurement (of yᵣ₂ for example) that includes a component of the interference caused by communications by the second UE, and a component of the interference that includes residual interference and noise.

Determining interference may involve calculating interference or components thereof based on multiple measurements. For example, total interference T_{I}=A_{I}+C_{I} can be expressed as T_{I}=A_{I}+C_{I}=yᵣ₂−(R_{I}+n). The component of the interference that includes residual interference and noise in the yᵣ₂ example above is (R_{I}+n), which can also be found from a measurement consistent with the yᵣ₁ example above). yᵣ₂ is a direct measurement of interference, which can be used with another direct measurement yᵣ₁, to determine total interference T_{I}, which may be coexistence interference if the first and second UEs communicate with different network devices in different communication systems.

This example of using yᵣ₂ and yᵣ₁ illustrates that, in some embodiments, the first REs may include the same types of REs, at different time positions, for measurements of interference or components thereof to be taken or performed, and also to be used in determining (by calculating) interference based on the measurements. This is an example in which the measurement of the component of the interference that includes residual interference and noise (yᵣ₁ for example) and the measurement of the interference that includes the component of the interference caused by communications by the second UE and the component of the interference including the residual interference and noise (yᵣ₂ for example) enable determination of the component of the interference caused by communications by the second UE (T_{I} for example). In other words, the component of the interference caused by communications by the second UE is determinable from the measurement of the component of the interference that includes residual interference and noise and the measurement of the interference including the component of the interference caused by communications by the second UE and the component of the interference that includes the residual interference and noise.

The first REs may also or instead include a reference signal RE, in which a reference signal is to be communicated between the first UE and the first network device, that corresponds to an RE at the time position at which all REs are muted. Using the REs at 1004 may then involve communicating, by the first UE with the first network device, the reference signal to enable a measurement to be taken based on the reference signal. This measurement based on the reference signal also includes a component of the interference including residual interference and noise. Expressed another way, the reference signal RE may be used to communicate a reference signal between the first UE and the first network device for a measurement to be taken of interference that includes a component of the interference caused by communications by the second UE and a component of the interference including residual interference and noise.

Examples of such a reference signal RE that corresponds to an RE at the time positions at which all REs are muted include CSI-RS REs (for DL measurements by the first UE) and SRS REs (for UL measurements by the first network device), shown by way of example at time position V4 in FIG. 6. Communicating a reference signal by the first UE in such an RE may involve receiving the reference signal by the first UE from the first network device (in the case of a CSI-RS in a CSI-RS RE for example) or transmitting the reference signal by the first UE to the first network device (in the case of an SRS in an SRS RE for example).
3 in FIG. 6 illustrates an example in which T_{I}=A_{I}+C_{I}=0, so that a measurement can be taken or performed for yᵣ₃=Hx+R_{I}+n. T_{I}=A_{I}+C_{I}=0 when a measurement of CSI-RS (or SRS for UL) is taken at first reference signal REs that correspond to muted second REs. A measurement of yᵣ₃=Hx+R_{I}+n in this example illustrates how communicating a reference signal in a reference signal RE that corresponds to an RE at the time position at which all REs are muted may enable or provide for a measurement to be taken or performed based on the reference signal, and how such a measurement may include a component of residual interference and noise (R_{I}+n).

Ĥ (an estimate of H) can be determined by calculation, based on yᵣ₃-yᵣ₁, and therefore T_{I}=yᵣ₂-(yᵣ₃-Ĥx). This is an indirect measurement or determination (by calculation based on multiple measurements) of the total interference T_{I}, which may be coexistence interference in some embodiments. In this example, yᵣ₁, yᵣ₂, and yᵣ₃ are used in calculations, and this further illustrates that in some embodiments the first REs include multiple REs, including some of the same type (in the yᵣ₁ and yᵣ₂ examples) and a different type (in the yᵣ₃ example), at the same time position (in the yᵣ₁ and yᵣ₃ examples) and a different time position (in the yᵣ₂ example), for measurements of interference or components thereof or measurements based on a reference signal to be taken or performed, and also to be used in determining (by calculating) interference based on the measurements.

This example illustrates how the measurement based on the reference signal (yᵣ₃ for example), the measurement of the component of the interference comprising residual interference and noise (yᵣ₁ for example), and the measurement of the interference that includes the component of the interference caused by communications by the second UE and the component of the interference that includes residual interference and noise (yᵣ₂ for example) further enable determination of the component of the interference caused by communications by the second UE (T_{I} for example). In other words, the component of the interference caused by communications by the second UE is determinable from the measurement based on the reference signal (yᵣ₃ for example), the measurement of the component of the interference that includes residual interference and noise (yᵣ₁ for example), and the measurement of the interference that includes the component of the interference caused by communications by the second UE and the component of the interference that includes residual interference and noise (yᵣ₂ for example).

As also described at least above, 4 in FIG. 6 illustrates A_{I}≠0 and C_{I}≠0, so that y=Hx+T_{I}+R_{I}+n, which is referred to below as yᵣ₄ (=y) for ease of reference. A_{I}≠0 and C_{I}≠0 when a measurement of CSI-RS (or SRS for UL) is taken at any RE that does not belong to corresponding muted REs. Victim system REs at which such measurements can be taken include a reference signal RE (in the first REs referenced herein), in which a reference signal is to be communicated between the first UE and the first network device, and that corresponds to an RE at a different time position in the time-frequency grid (at a time position other than V4 in FIG. 6 for example) different from the time position at which all REs are muted for communications by the second UE (at the time position A4 in FIG. 6 for example). Thus, a reference signal RE that corresponds to an RE at a time position different from the time position of the REs that are muted may be used to communicate a reference signal between the first UE and the first network device for a measurement to be taken based on the reference signal.

Using REs by the first UE in this context may involve communicating a reference signal by the first UE in such an RE, by receiving the reference signal by the first UE from the first network device (in the case of a CSI-RS in a CSI-RS RE for example) or transmitting the reference signal by the first UE to the first network device (in the case of an SRS in an SRS RE for example). The reference signal is communicated for a measurement to be taken based on the reference signal. The measurement based on such a reference signal that is communicated using this type of reference signal RE includes a component of the interference caused by communications by the second UE (T_{I} in yᵣ₄ for example) and a component of the interference comprising residual interference and noise ((R_{I}+n) in yᵣ₄ for example).

Ĥ can be found based on yᵣ₄-yᵣ₂, and therefore T_{I}=yᵣ₄-Ĥx−(R_{I}+n), where (R_{I}+n) can be found from a measurement consistent with step 1 in FIG. 6 (yᵣ₁ above). This is another example of an indirect measurement or determination (by calculation based on multiple measurements) of the total interference T_{I}, which may be coexistence interference in some embodiments. In this example, yᵣ₁, yᵣ₂, and yᵣ₄ are used in calculations, and this further illustrates that in some embodiments the first REs include multiple REs, including some of the same type (in the yᵣ₁ and yᵣ₂ examples) and a different type (in the yᵣ₄ example), at the same time position (in the yᵣ₂ and yᵣ₄ examples) and a different time position (in the yᵣ₁ example), for measurements of interference or components thereof or measurements based on a reference signal to be taken or performed, and also to be used in determining (by calculating) interference based on the measurements.

This calculation example illustrates how the measurement based on the reference signal (yᵣ₄ for example), the measurement of the component of the interference that includes residual interference and noise (yᵣ₁ for example), and the measurement of the interference that includes the component of the interference caused by communications by the second UE and the component of the interference including residual interference and noise (yᵣ₂ for example) may enable determination of the component of the interference caused by communications by the second UE (T_{I} for example). In other words, the component of the interference caused by communications by the second UE (T_{I} for example) may be determinable from the measurement based on the reference signal (yᵣ₄ for example), the measurement of the component of the interference that includes residual interference and noise (yᵣ₁ for example), and the measurement of the interference that includes the component of the interference caused by communications by the second UE and the component of the interference including residual interference and noise (yᵣ₂ for example).

At 5, FIG. 6 illustrates an example in which x=0 and C_{I}=0, and therefore yᵣ₅=A_{I}+R_{I}+n. A measurement of yᵣ₅ is taken at any empty RE or CSI-IM RE corresponding to an empty RE at the aggressor, at a time position other than the time position at which all REs are muted (A4 in FIG. 6 for example). Such REs are examples of an RE (included in the first REs), in which there is to be no communication between the first UE and the first network device, that corresponds to an RE in which there is to be no communication by the second UE and that is at a different time position (V1 or V14 in FIG. 6 for example) in the time-frequency grid different from the time position (A1 or A14 in FIG. 6 for example) at which all REs are muted for communications by the second UE. This type of RE at such a time position enables measurement of interference that an adjacent channel component of the interference caused by communications by the second UE (A_{I} in yᵣ₅ for example), and a component of the interference comprising residual interference and noise ((R_{I}+n) in yᵣ₅ for example). Such an RE is not used for communication between the first UE and the first network device, bit is used for a measurement to be taken of interference that includes an adjacent channel component of the interference caused by communications by the second UE and a component of the interference including residual interference and noise.

A_{I}=yᵣ₅−(R_{I}+n), where (R_{I}+n) can be found from a measurement consistent with step 1 in FIG. 6 (yᵣ₁ above). A direct measurement of interference can be made for yrs, and can be used (with another direct measurement, yᵣ₁ above) to determine the adjacent interference A1. This example illustrates how the measurement of the component of the interference including residual interference and noise (yᵣ₁ for example) and the measurement of interference comprising the adjacent channel component and the component of the interference comprising residual interference and noise (yrs for example) enable determination of the adjacent channel component of the interference (A_{I} for example), or in other words how the adjacent channel component of the interference (A_{I} for example) is determinable from the measurement of the component of the interference including residual interference and noise (yᵣ₁ for example) and the measurement of interference that includes the adjacent channel component and the component of the interference including residual interference and noise (yᵣ₅ for example).

With continued reference to FIG. 6, item 6 illustrates REs for measurements with C_{I}=0, so that yᵣ₆=Hx+A_{I}+R_{I}+n. Such a measurement may be a measurement of CSI-RS (or SRS for UL) taken at an RE corresponding to an aggressor's empty RE/muted RE, but at a different time position than the time position at which all REs are muted.

The REs indicated by 6 in FIG. 6 are examples of an RE (included in the first REs), in which a reference signal is to be communicated between the first UE and the first network device, that corresponds to an RE (at time position A1 in FIG. 6 for example) in which there is to be no communication by the second UE and at a different time position in the time-frequency grid different from the time position (A4 in FIG. 6 for example) at which all REs are muted for communications by the second UE. Using the first REs by the first UE may involve communicating the reference signal by the first UE with the first network device, by transmitting the reference signal (SRS for example) to the first network device or receiving the reference signal (CSI-RS for example) from the first network device in the reference signal RE, to enable a measurement to be taken. Put another way, such a reference signal RE is used to communicate the reference signal for a measurement to be taken. The measurement (of yᵣ₆ for example) is to be taken based on the reference signal and includes an adjacent channel component of the interference caused by communications by the second UE (A_{I} in yᵣ₆ for example) and a component of the interference that includes residual interference and noise ((R_{I}+n_{I}) in yᵣ₆ for example).

A_{I} can be determined based on calculation, as A_{I}=yᵣ₆-yᵣ₃. This illustrates that the measurement (of yᵣ₃ for example) based on a reference signal and including the component of the interference comprising residual interference and noise, and the measurement (of yᵣ₆ for example) based on a further reference signal, enable determination of the adjacent channel component of the interference (A_{I} for example). In other words, the adjacent channel component of the interference (A_{I} for example) is determinable from the measurement (of yᵣ₃ for example) based on the reference signal and including the component of the interference that includes residual interference and noise, and the measurement (of yᵣ₆ for example) based on a further reference signal.

These examples related to yᵣ₁ to yᵣ₆ may be implemented or supported individually or in any of various combinations. Some combinations are described at least above, and others may also or instead be implemented or supported. For example, in-band interference (which may be coexistence interference in some embodiments) may be determined by calculation, based on C_{I}=T_{I}−A_{I}, and a combination of T_{I} (determined in a manner consistent with the yᵣ₂ example or the yᵣ₃ example as described above), and A_{I} (determined in a manner consistent with the yᵣ₅ example or the yᵣ₆ example as described above).

More generally, interference determination may involve taking or performing measurements of different components of interference (which may be referred to as target components for respective measurements), or measurements that include such components, under different measurement conditions (using one or more REs with correspondence to REs of an aggressor), while other components of the interference are known (equal to zero for example). This allows a series of measurements to be taken or performed so that interferences or components thereof can be determined (by direct measurement and/or calculation).

Therefore, some embodiments may involve determining, by the first UE, the different components of the interference, at 1005. Various examples of such determining are provided at least above, and may be applied not only to interference (or interference component) determination by the first UE, but also or instead to interference (or interference component) determination by the first UE.

Interference (or interference components) as measured or otherwise determined by the first UE may be reported to the first network device. A method may therefore include reporting, by the first UE, to the first network device based on the determined different components of the interference. Such reporting “based on” the determined different components of the interference may involve reporting measurements, calculation results, or both, and is shown in FIG. 10A at 1006. The reporting at 1006 may include reporting, by the first UE based on the determined components of the interference, to either or both of the first network device or the second network device.

Interference determination is not limited only to the specific measurement and calculation examples described above. In some embodiments, a method involves determining an effective adjacent channel leakage ratio (ACLR) based on the determined different components of the interference. This is also referred to herein as extracting the effective ACLR.

Another optional feature is shown at 1008 in FIG. 10A. Some embodiments may involve receiving, by the first UE from the first network device, signaling related to interference mitigation that is based on the measurement of interference. Interference may be measured or otherwise determined by the first UE or the first network device, and the first network device may then determine interference mitigation that is to be applied.

Interference mitigation may include any one or more of the following: changing scheduled or configured resources; redefining boundaries of a bandwidth part; changing or switching a bandwidth part; avoiding scheduling in impacted resources; changing RSRP signal strength; changing allocated power level; power control; switching a serving transmit beam; switching a receive beam; switching a beam pair link; hybrid beamforming; adaptive frequency hopping; focused beamforming. These examples are also discussed elsewhere herein.

The first UE and the second UE may be communicating with the same network device but suffering from cross-link interference. In this scenario, communications by the second UE that are causing interference for the first UE are communications between the second UE and the first network device. In co-existence embodiments, the communications by the second UE are communications between the second UE and a second network device in a second wireless communication system. The set of second REs may then be based on coordination between the first network device and the second network device in such embodiments. Such coordination is shown by way of example at 610, 710, 810, 910 in FIGS. 6A-9, respectively.

Coordination between the first network device and the second network device may involve an exchange of direct signaling, such as direct messages, between the first network device and the second network device. This signaling is related to one or more parameters of the configuration of the first REs, to enable the first network device and the second network device to agree on the configuration parameter(s). Examples of configuration parameters are shown at 610, 710, 810, 910 in FIGS. 6A-9, and more generally may include the resources to be blanked or muted, periodicity, and/or others. Coordination could be between a satellite or otherwise non-terrestrial TRP and a terrestrial TRP, for example.

In embodiments that involve communications between the second UE and a second network device, a method may involve receiving, by the first UE from the second network device, a further configuration of further REs for communications between the first UE and the second network device. This is described by way of example for dual connection scenarios at least with reference to FIGS. 7 and 9, and is also shown by way of example at 926 in FIG. 9.

UE capability reporting is referenced above in the context of reporting by the first UE to the first network device. In a dual connection embodiment, a method may involve transmitting, by the first UE to the second network device, an indication of a capability of the first UE to measure the interference and/or report the interference to the second network device. The further configuration may then be received by the first UE responsive to transmitting the indication of the capability of the first UE to measure and/or report the interference to the second network device.

A method may also involve receiving, by the first UE from the second network device, signaling related to interference mitigation that is based on interference measurement associated with the further REs and is to be applied to subsequent communications between the first UE and the second network device. This is shown by way of example at 758 and 958 in FIGS. 7 and 9, respectively.

The interference mitigation to be applied to subsequent communications between the first UE and the second network device may include any one or more of the following, which are also discussed elsewhere herein: changing scheduled or configured resources for the subsequent communications between the first UE and the second network device; redefining boundaries of a bandwidth part for the subsequent communications between the first UE and the second network device; changing or switching a bandwidth part for the subsequent communications between the first UE and the second network device; avoiding scheduling in impacted resources for the subsequent communications between the first UE and the second network device; changing reference signal received power (RSRP) signal strength for the subsequent communications between the first UE and the second network device; changing allocated power level for the subsequent communications between the first UE and the second network device; power control for the subsequent communications between the first UE and the second network device; switching a serving transmit beam for the subsequent communications between the first UE and the second network device; switching a receive beam for the subsequent communications between the first UE and the second network device; switching a beam pair link for the subsequent communications between the first UE and the second network device; hybrid beamforming for the subsequent communications between the first UE and the second network device; adaptive frequency hopping for the subsequent communications between the first UE and the second network device; focused beamforming for the subsequent communications between the first UE and the second network device.

Embodiments disclosed herein may be applied to or implemented in any of various cross-link scenarios. For example, in a co-existence scenario with the first network device in a first wireless communication system and a second network device in a second wireless communication system, one of the first wireless communication system and the second wireless communication system may be or include a terrestrial network, and the other of the first wireless communication system and the second wireless communication system may be or include a non-terrestrial network.

Referring now to FIG. 10B, a method implemented at a network device in a victim system, also referred to herein as a first network device, may involve transmitting, at 1014, to a first UE from the first network device in a first wireless communication system, a configuration of a plurality of first REs. The first REs are for determination of different components of interference. The interference affects communications between the first UE and the first network device. As described elsewhere herein and at least with reference to FIG. 6, the first REs include REs (at time position V4 in FIG. 6, for example) that correspond to a subset of REs in a set of second REs that includes all REs at a time position (A4 in FIG. 6, for example) in a time-frequency grid that are muted for communications by a second UE. The first REs further include an RE that corresponds to an RE at a different time position in the time-frequency grid different from the time position of the REs that are muted. Examples of a first network device transmitting such a configuration to a first UE are shown at 622 in FIG. 6A, 722 in FIG. 7, 822 in FIGS. 8, and 922 in FIG. 9, and are described above with reference to a UE and gNB in a victim system.

As also described at least above, such a configuration of first REs may be periodic, semi-persistent, or triggered by an event. Examples of the first REs are provided at least above as well. The first REs may include, for example, an RE in which there is to be no communication between the first UE and the first network device, and may also or instead include a reference signal RE in which a reference signal is to be communicated between the first UE and the first network device. Examples of both of these types of REs are also discussed at least above.

A method may also involve using the first REs by the first network device according to the configuration, for determination of different components of interference. This is not shown separately in FIG. 10B to avoid congestion in the drawing, but may be involved in determining interference at 1016. Using the first REs may include, for example, receiving UL signals by the first network device from the first UE as shown by way of example at 630 in FIGS. 6A and 732 in FIG. 7. UL signals may be or include SRS and/or other signals. Using the first REs may also or instead include transmitting DL signals from the first network device to the first UE as described by way of example herein, including at least above with reference to FIGS. 8 and 9. In some embodiments, using the first REs may involve measuring the interference as shown by way of example at 640 in FIG. 6A and at 740 in FIG. 7. Measuring interference may be referred to as performing or taking an interference measurement, using a first RE. The first network device may perform or take a measurement based on a reference signal received in a reference signal RE, or perform a measurement during an empty RE for example. Regarding empty REs or CSI-IM REs, using such REs by the first network device may involve the network device not communicating with (that is, not transmitting any signals to or receiving any signals from) the first UE so that the network device or the first UE can perform a measurement. Therefore, it should be appreciated that using the first REs need not necessarily involve the first network device communicating with the first UE.

Some embodiments involve the first UE performing one or more measurements and/or otherwise determining interference or components thereof, and possibly reporting interference and/or measurements to the first network device. In such embodiments, a method may involve receiving, from the first UE by the first network device, an indication of a capability of the first UE to measure interference and/or report the interference to the first network device. This is shown by way of example at 1010 in FIG. 10B as an optional feature. The configuration may then be transmitted to the first UE at 1014 responsive to receiving the indication of the capability at 1010. For example, upon receiving a report of this UE capability at 1010, the network device may configure the UE accordingly by transmitting the RE configuration at 1014.

Receiving reported interference is not separately shown in FIG. 10B in order to avoid further congestion in the drawing. However, determining interference at the victim system is shown at 1016, and this may involve receiving, from the first UE by the first network device, an interference report or more generally a report based on different components of the interference determined by the first UE, or an indication of interference, a measurement of the interference, or one or more components of interference, as determined by the first UE.

Various RE, measurement, and determination examples are described in detail herein, including at least above with reference to FIG. 10A. These examples may also or instead apply to embodiments related to a first network device.

The first REs may include an RE, in which there is to be no communication between the first UE and the first network device, that corresponds to one of the REs that are muted, for example. Such an RE enables a measurement to be taken of a component of the interference comprising residual interference and noise. In other words, the first REs may include an RE that corresponds to one of the REs that are muted. This RE (of the first REs) is not used for communication between the first UE and the first network device, but is used for a measurement to be taken of a component of the interference comprising residual interference and noise. See, for example, the detailed description related to the yᵣ₁ example above.

As another example, the first REs may include an RE, in which there is to be no communication between the first UE and the first network device, that corresponds to an RE at a different time position in the time-frequency grid different from the time position at which all REs are muted for communications by the second UE. Such an RE enables a measurement to be taken of interference comprising a component of the interference caused by communications by the second UE, and a component of the interference comprising residual interference and noise. This may also be described as the first REs including an RE that corresponds to an RE at a time position in the time-frequency grid different from the time position of the REs that are muted. The RE (in the first REs) is not used for communication between the first UE and the first network device, and is used for the measurement to be taken. See, for example, the detailed description related to the yᵣ₂ example above.

The first REs may include both of these REs. The measurement of the component of the interference that includes residual interference and noise, and the measurement of the interference including the component of the interference caused by communications by the second UE and the component of the interference including the residual interference and noise, enable determination of the component of the interference caused by communications by the second UE. With both of these REs used in this way, the component of the interference caused by communications by the second UE is determinable from the measurement of the component of the interference including residual interference and noise and the measurement of the interference including the component of the interference caused by communications by the second UE and the component of the interference that includes the residual interference and noise. See, for example, the detailed description related to the combined yᵣ₁ and yᵣ₂ example above.

The first REs may also or instead include a reference signal RE, in which a reference signal is to be communicated between the first UE and the first network device, that corresponds to an RE in the set of second REs. Using the first REs may then involve communicating the reference signal, with the first UE by the first network device, to enable a measurement to be taken based on the reference signal and including a component of the interference that includes residual interference and noise. The communicating may involve transmitting the reference signal by the first network device to the first UE or receiving the reference signal by the first network device from the first UE. Thus, the first REs may include a reference signal RE that corresponds to one of the REs that are muted, and that reference signal RE may be used to communicate a reference signal between the first UE and the first network device for the measurement to be taken based on the reference signal. See, for example, the detailed description related to the yᵣ₃ example above.

Such an RE and related features may be implemented in combination with one or more other REs and related features. In an embodiment, the measurement based on the reference signal, the measurement of the component of the interference that includes residual interference and noise, and the measurement of the interference that includes the component of the interference caused by communications by the second UE and the component of the interference including residual interference and noise, further enable determination of the component of the interference caused by communications by the second UE. An equivalent description is that the component of the interference caused by communications by the second UE is determinable from the measurement based on the reference signal, the measurement of the component of the interference including residual interference and noise, and the measurement of the interference including the component of the interference caused by communications by the second UE and the component of the interference that includes residual interference and noise. See, for example, the detailed description related to the combined yᵣ₁, yᵣ₂, and yᵣ₃ example above.

In further embodiments, the first REs may also or instead include a reference signal RE, in which a reference signal is to be communicated between the first UE and the first network device, that corresponds to an RE at a different time position in the time-frequency grid different from the time position at which all REs are muted for communications by the second UE. Using the first REs may then involve communicating the reference signal in such an RE, with the first UE by the first network device, to enable a measurement to be taken based on the reference signal and including a component of the interference caused by communications by the second UE and a component of the interference that includes residual interference and noise. Thus, the first REs may include a reference signal RE that corresponds to an RE at a time position different from the time position of the REs that are muted, and the reference signal RE may be used to communicate a reference signal between the first UE and the first network device for such a measurement to be taken. See, for example, the detailed description related to the yᵣ₄ example above. The communicating may involve transmitting the reference signal by the first network device to the first RE or receiving the reference signal by the first network device from the first RE.

In an embodiment that involves such an RE and other REs disclosed herein, the measurement based on the reference signal, the measurement of the component of the interference that includes residual interference and noise, and the measurement of the interference including the component of the interference caused by communications by the second UE and the component of the interference that includes residual interference and noise, enable determination of the component of the interference caused by communications by the second UE. This may also be described as follows: the component of the interference caused by communications by the second UE is determinable from the measurement based on the reference signal, the measurement of the component of the interference including residual interference and noise, and the measurement of the interference including the component of the interference caused by communications by the second UE and the component of the interference that includes residual interference and noise. See, for example, the detailed description related to the combined yᵣ₁, yᵣ₂, and yᵣ₄ example above.

The first REs may also or instead include an RE, in which there is to be no communication between the first UE and the first network device, that corresponds to an RE in which there is to be no communication by the second UE and at a different time position in the time-frequency grid different from the time position at which all REs are muted for communications by the second UE. Such an RE enables a measurement to be taken of interference that includes an adjacent channel component of the interference caused by communications by the second UE, and a component of the interference including residual interference and noise. Thus, the first REs may include an RE that corresponds to an RE in which there is to be no communication by the second UE and at a time position different from the time position of the REs that are muted. That that RE (which is one of the first REs) is not used for communication between the first UE and the first network device, but is used for the measurement to be taken. See, for example, the detailed description related to the yᵣ₅ example above.

In an embodiment that involves such an RE and another RE as disclosed herein, the measurement of the component of the interference that includes residual interference and noise, and the measurement of interference including the adjacent channel component and the component of the interference that includes residual interference and noise, enable determination of the adjacent channel component of the interference. See, for example, the detailed description related to the combined yᵣ₁ and yᵣ₅ example above. This is also an example of how the adjacent channel component of the interference is determinable from the measurement of the component of the interference including residual interference and noise and the measurement of interference including the adjacent channel component and the component of the interference that includes residual interference and noise.

The first REs may also or instead include a reference signal RE, in which a reference signal is to be communicated between the first UE and the first network device, that corresponds to an RE in which there is to be no communication by the second UE and at a different time position in the time-frequency grid different from the time position at which all REs are muted for communications by the second UE. Using the first REs by the first network device may then involve communicating the reference signal in such an RE, with the first UE by the first network device, to enable a measurement to be taken based on the reference signal and including an adjacent channel component of the interference caused by communications by the second UE and a component of the interference that includes residual interference and noise. See, for example, the detailed description related to the yᵣ₆ example above. The communicating, as in other embodiments, may involve transmitting the reference signal by the first network device to the first RE or receiving the reference signal by the first network device from the first RE. In other words, the first REs may include a reference signal RE that corresponds to an RE in which there is to be no communication by the second UE and is at a time position different from the time position of the REs that are muted. The reference signal RE may be used to communicate a reference signal between the first UE and the first network device for such a measurement to be taken.

Such an RE may be used with one or more other REs. For example, the measurement based on a reference signal in a previous example and including the component of the interference that includes residual interference and noise, and the measurement based on the reference signal in the present example, may enable determination of the adjacent channel component of the interference. This may also be described as the adjacent channel component of the interference being determinable from the measurement based on the reference signal and including the component of the interference that includes residual interference and noise and the measurement based on a further reference signal (and including an adjacent channel component of the interference caused by communications by the second UE and a component of the interference that includes residual interference and noise). See, for example, the detailed description related to the combined yᵣ₆ and yᵣ₃ example above.

Another optional feature is shown at 1019 in FIG. 10B. Some embodiments may involve transmitting, to the first UE from the first network device, signaling related to interference mitigation that is based on a measurement of interference, or the different components of such interference. Interference may be measured or otherwise determined by the first UE or the first network device, and the first network device may then determine interference mitigation that is to be applied.

Examples of interference mitigation are provided elsewhere herein, including in the description related to FIG. 10A. Interference mitigation may include any one or more of the above examples.

The first UE and the second UE may be communicating with the same network device but suffering from cross-link interference. In this scenario, communications by the second UE that are causing interference for the first UE are communications between the second UE and the first network device. In co-existence embodiments, the communications by the second UE are communications between the second UE and a second network device in a second wireless communication system.

A method may involve coordinating, by the first network device with the second network device, on the interference mitigation. This is shown at 1018 in FIG. 10, and also by way of example at 752 in FIGS. 7 and 952 in FIG. 9. The interference mitigation may include interference mitigation to be applied to any one or more of the following: subsequent communications between the first UE and the first network device (in which the first UE may be referred to as an intended UE for such communications); subsequent communications between the first UE and the second network device (in which the first UE may again be referred to as an intended UE for such communications); subsequent communications between the second UE and the second network device. Signaling related to these types of interference mitigation is shown by way of example in FIGS. 6A-9 at 642, 754, 850, 954 (for first UE/first network device communications), at 758, 958 (for first UE/second network device communications), and at 654, 756, 862, 956 (for second UE/second network device communications).

The set of second REs may also or instead be based on coordination between the first network device and the second network device in some embodiments, and a method may include coordinating, by the first network device with the second network device, on selection of the REs in the second set of REs. Such coordination is illustrated at 1012 in FIG. 10B, and is also shown by way of example at 610, 710, 810, 910 in FIGS. 6A-9, respectively.

Coordination between the first network device and the second network device, on interference mitigation and/or RE selection, may involve an exchange of direct signaling, such as direct messages, between the first network device and the second network device. Separate signaling may be used for coordination on interference mitigation and coordination on RE selection, and may include or indicate one or more parameters of interference mitigation or REs, to enable the first network device and the second network device to agree on such parameter(s). Examples of configuration parameters are shown at 610, 710, 810, 910 in FIGS. 6A-9, and parameters for interference mitigation may be related to any of the examples of interference mitigation disclosed herein.

An example of a method implemented at a network device in an aggressor system, also referred to herein as a second network device, is shown in FIG. 10C. Many of the features in FIG. 10C are shown in the same way as in FIG. 10B, but are related to a second network device in FIG. 10C instead of a first network device in FIG. 10B.

A method implemented at a second network device may involve coordinating at 1022, with a first network device in a first wireless communication system by a second network device, a set of second REs that are to be muted for communications with the second network device. This may involve coordinated selection of REs, and therefore may be referred to as coordinating on selection of the set of REs. In the case of such coordinating, there are two network devices, but these may be in the same or different wireless communication systems. Coordination between network elements on selection of such REs is shown by way of example in FIGS. 6A-9, at 610, 710, 810, 910.

This set of second REs includes a subset of REs (some of the REs at time position A4 in FIG. 6, for example) corresponding to first REs (at time position V4 in FIG. 6, for example) that enable measurement or determination of interference or components thereof. REs may also be described as being for measurement or determination of interference or components thereof. The interference affects communications between a first UE and the first network device. The set of second REs includes not only the corresponding REs, but all REs at a time position (the time position A4 in FIG. 6 for example) in a time-frequency grid. Thus, the set of second REs that are for interference determination or measurement may include REs that do (and do not) correspond to first REs, and may include REs other than muted REs at a particular time position such as A4 in FIG. 6.

In embodiments that relate to different components of interference, the set of second REs may be described as corresponding to a plurality of first REs that enable (or first REs that are for) determination of different components of interference. The set of second REs includes all REs at a time position in a time-frequency grid that are to be muted for communications between the second network device and a second UE as noted above, and a subset of the REs at the time position correspond to a subset of the first REs (or in other words the set of second REs may include other REs in addition to those that correspond to the first REs, as shown by way of example in FIG. 6). The set of second REs also include an RE, at a different time position in the time-frequency grid different from the time position at which all REs are muted, corresponding to another RE of the plurality of first REs.

The method in FIG. 10C also involves transmitting (at 1024), to a second UE from the second network device, a configuration to mute the REs at the time position, for communications between the second UE and the second network device. This is shown by way of example at 624, 724, 824, 924 in FIGS. 6A-9, respectively.

As described at least above for a configuration of first REs, a configuration of second REs for communications with a second network device may be periodic, semi-persistent, or triggered by an event. The REs for communications with the second network device may include, for example, not only all REs at a particular time position such as A4 in FIG. 10, but one or more other types of REs as well, such as empty REs with other correspondence as shown in FIG. 10 and/or reference signal REs. Please note that the periodic here means the first UE may use the first REs periodically, e.g., measuring the first REs according to the configuration. Similarly, triggered by an event here means the first UE may use the first REs based on a trigger, for example, a DCI which indicate the UE to use the first REs, or when some other criteria e.g., the interference in some band exceed a threshold.

A method may also involve using the set of REs (second REs) by the second network device according to the configuration. This is not shown separately in FIG. 10C to avoid congestion in the drawing, but may be involved in determining interference at 1026. Using the second REs may include, for example, receiving UL signals by the second network device from the first UE as shown by way of example at 734 in FIG. 7. UL signals may be or include SRS and/or other signals. Using the second REs may also or instead include transmitting DL signals from the second network device to the first UE as described by way of example herein, including at least above with reference to FIG. 9. In some embodiments, using the second REs may involve measuring the interference as shown by way of example at 744 in FIG. 7. Measuring interference may be referred to as performing an interference measurement, using a second RE. The second network device may perform a measurement based on a reference signal received in a reference signal RE, or perform a measurement during an empty RE for example. Regarding empty REs, using such REs by the second network device may involve the network device not communicating with (that is, not transmitting any signals to or receiving any signals from) the first UE or the second UE so that the network device or the first UE can perform a measurement. Therefore, it should be appreciated that using REs need not necessarily involve the second network device communicating with the first UE or the second RE.

Some embodiments involve the first UE performing one or more measurements, and possibly reporting interference or measurements to the second network device. In such embodiments, a method may involve receiving, from the first UE by the second network device, an indication of a capability of the first UE to measure interference and/or report the interference to the second network device. This is shown by way of example at 1020 in FIG. 10C as an optional feature. The configuration may then be transmitted to the first UE at 1024 responsive to receiving the indication of the capability at 1020. For example, upon receiving a report of this UE capability at 1020, the second network device may configure the first UE (and the second) accordingly by transmitting the RE configuration at 1024.

Receiving reported interference is not separately shown in FIG. 10C in order to avoid further congestion in the drawing. However, determining interference at the aggressor system is shown at 1026, and this may involve receiving, from the first UE by the second network device, an interference report or more generally a report based on different components of the interference determined by the first UE, or an indication of interference, a measurement of the interference, or one or more components of the interference as determined by the first UE.

Various RE, measurement, and determination examples are described in detail herein, including at least above with reference to FIGS. 10A and 10B. These examples may also or instead apply to embodiments related to a first network device.

The first REs may include an RE, in which there is to be no communication between the first UE and the first network device, that corresponds to an RE in the set of second REs, for example. Such an RE enables a measurement to be taken of a component of the interference comprising residual interference and noise. Thus the first REs may include an RE that corresponds to one of the muted REs, and that RE (one of the first REs) is not used for communication between the first UE and the first network device but is used for a measurement to be taken of a component of the interference that includes residual interference and noise. See, for example, the detailed description related to the yᵣ₁ example above.

As another example, the first REs may include an RE, in which there is to be no communication between the first UE and the first network device, that corresponds to an RE at a different time position in the time-frequency grid different from the time position at which all REs are muted for communications between the second UE and the second network device. Such an RE enables a measurement to be taken of interference comprising a component of the interference caused by communications between the second UE and the second network device, and a component of the interference comprising residual interference and noise. See, for example, the detailed description related to the yᵣ₂ example above. This is also an example of the first REs including an RE that corresponds to an RE at a time position different from the time position of the REs that are muted, wherein the RE (in the first REs) is not used for communication between the first UE and the first network device but is used for a measurement to be taken of interference including a component of the interference caused by communications between the second UE and the second network device, and a component of the interference including residual interference and noise.

The first REs may include both of these REs. The measurement of the component of the interference that includes residual interference and noise, and the measurement of the interference including the component of the interference caused by communications between the second UE and the second network device and the component of the interference including the residual interference and noise, then enable determination of the component of the interference caused by communications between the second UE and the second network device. In an example with both of these REs, the component of the interference caused by communications between the second UE and the second network device is determinable from the measurement of the component of the interference that includes residual interference and noise and the measurement of the interference that includes the component of the interference caused by communications between the second UE and the second network device and the component of the interference including the residual interference and noise. See, for example, the detailed description related to the combined yᵣ₁ and yᵣ₂ example above.

The first REs may also or instead include a reference signal RE, in which a reference signal is to be communicated between the first UE and the first network device, that corresponds to an RE in the set of second REs. The reference signal enables a measurement to be taken based on the reference signal and including a component of the interference that includes residual interference and noise. See, for example, the detailed description related to the yᵣ₃ example above. This is also an example of the first REs including a reference signal RE that corresponds to one of the REs that are muted, with the reference signal RE being used to communicate a reference signal between the first UE and the first network device for a measurement to be taken based on the reference signal and including a component of the interference comprising residual interference and noise.

Such an RE and related features may be implemented in combination with one or more other REs and related features. In an embodiment, the measurement based on the reference signal, the measurement of the component of the interference that includes residual interference and noise, and the measurement of the interference that includes the component of the interference caused by communications between the second UE and the second network device and the component of the interference including residual interference and noise, further enable determination of the component of the interference caused by communications between the second UE and the second network device. See, for example, the detailed description related to the combined yᵣ₁, yᵣ₂, and yᵣ₃ example above. This example also illustrates how the component of the interference caused by communications between the second UE and the second network device is determinable from the measurement based on the reference signal, the measurement of the component of the interference including residual interference and noise, and the measurement of the interference including the component of the interference caused by communications between the second UE and the second network device and the component of the interference that includes residual interference and noise.

In further embodiments, the first REs may also or instead include a reference signal RE, in which a reference signal is to be communicated between the first UE and the first network device, that corresponds to an RE at a different time position in the time-frequency grid different from the time position at which all REs are muted for communications by the second UE. The reference signal enables a measurement to be taken based on the reference signal and including a component of the interference caused by communications between the second UE and the second network device and a component of the interference that includes residual interference and noise. See, for example, the detailed description related to the yᵣ₄ example above. This is also an example of the first REs including a reference signal RE that corresponds to an RE at a time position different from the time position of the REs that are muted, wherein the reference signal RE is used to communicate a reference signal between the first UE and the first network device for a measurement to be taken based on the reference signal and including a component of the interference caused by communications between the second UE and the second network device and a component of the interference including residual interference and noise.

In an embodiment that involves such an RE and other REs disclosed herein, the measurement based on the reference signal, the measurement of the component of the interference that includes residual interference and noise, and the measurement of the interference including the component of the interference caused by communications between the second UE and the second network device and the component of the interference that includes residual interference and noise, enable determination of the component of the interference caused by communications between the second UE and the second network device. See, for example, the detailed description related to the combined yᵣ₁, yᵣ₂, and yᵣ₄ example above. In other words, the component of the interference caused by communications between the second UE and the second network device is determinable from the measurement based on the reference signal, the measurement of the component of the interference including residual interference and noise, and the measurement of the interference including the component of the interference caused by communications between the second UE and the second network device and the component of the interference that includes residual interference and noise.

The first REs may also or instead include an RE, in which there is to be no communication between the first UE and the first network device, that corresponds to an RE in which there is to be no communication by the second UE and at a different time position in the time-frequency grid different from the time position at which all REs are muted for communications by the second UE. Such an RE enables measurement of interference that includes an adjacent channel component of the interference caused by communications between the second UE and the second network device, and a component of the interference including residual interference and noise. Put another way, the first REs may include an RE that corresponds to an RE in which there is to be no communication between the second UE and the second network device and at a time position different from the time position of the REs that are muted, and that RE is not used for communication between the first UE and the first network device but is used for a measurement to be taken of interference including an adjacent channel component of the interference caused by communications between the second UE and the second network device, and a component of the interference including residual interference and noise. See, for example, the detailed description related to the yᵣ₅ example above.

In an embodiment that involves such an RE and another RE as disclosed herein, the measurement of the component of the interference that includes residual interference and noise, and the measurement of interference including the adjacent channel component and the component of the interference that includes residual interference and noise, enable determination of the adjacent channel component of the interference. Thus, the adjacent channel component of the interference is determinable from the measurement of the component of the interference including residual interference and noise and the measurement of interference including the adjacent channel component and the component of the interference that includes residual interference and noise. See, for example, the detailed description related to the combined yᵣ₁ and yᵣ₅ example above.

The first REs may also or instead include a reference signal RE, in which a reference signal is to be communicated between the first UE and the first network device, that corresponds to an RE in which there is to be no communication by the second UE and at a different time position in the time-frequency grid different from the time position at which all REs are muted for communications by the second UE. The reference signal enables a measurement to be taken based on the reference signal and including an adjacent channel component of the interference caused by communications between the second UE and the second network device and a component of the interference that includes residual interference and noise. In such an embodiment, the first REs include a reference signal RE that corresponds to an RE in which there is to be no communication between the second UE and the second network device and at a time position different from the time position of the REs that are muted. The reference signal RE is used to communicate a reference signal between the first UE and the first network device for such a measurement to be taken based on the reference signal. See, for example, the detailed description related to the yᵣ₆ example above.

Such an RE may be used with one or more other REs. For example, the measurement based on the reference signal and including the component of the interference that includes residual interference and noise, and the measurement based on the reference signal, may enable determination of the adjacent channel component of the interference.

In such a combined embodiment, the first REs include a reference signal RE and a further reference signal RE. The reference signal RE corresponds to one of the REs that are muted, and is used to communicate a reference signal between the first UE and the first network device for a measurement to be taken based on the reference signal and including a component of the interference comprising residual interference and noise. The further reference signal RE corresponds to an RE in which there is to be no communication between the second UE and the second network device and at a time position different from the time position of the REs that are muted, and is used to communicate a further reference signal between the first UE and the first network device for a measurement to be taken based on the further reference signal and including an adjacent channel component of the interference caused by communications between the second UE and the second network device and the component of the interference that includes residual interference and noise. The adjacent channel component of the interference is determinable from the measurement based on the reference signal and the measurement based on the further reference signal.

See, for example, the detailed description related to the combined yᵣ₆ and yᵣ₃ example above.

Another optional feature is shown at 1029 in FIG. 10C. Some embodiments may involve transmitting, to the first UE and/or to the second UE from the second network device, signaling related to interference mitigation that is based on a measurement of interference, or more generally based on different components of interference. Interference may be measured or otherwise determined by the first UE or the second network device, and may also or instead be determined by the first network device and/or the second UE, and the second network device may then determine interference mitigation that is to be applied.

Examples of interference mitigation are provided elsewhere herein, including in the description related to FIG. 10A and/or FIG. 10B. Interference mitigation may include any one or more of the above examples.

The first UE and the second UE may be communicating with the same network device but suffering from cross-link interference. In this scenario, communications by the second UE that are causing interference for the first UE are communications between the second UE and the first network device. In co-existence embodiments, the communications by the second UE are communications between the second UE and a second network device in a second wireless communication system.

A method may involve coordinating, with the first network device by the second network device, on the interference mitigation. This is shown at 1028 in FIG. 10C, and is also shown by way of example at 752 in FIGS. 7 and 952 in FIG. 9. The interference mitigation may include interference mitigation to be applied to any one or more of the following, as also described at least above: subsequent communications between the first UE and the first network device (in which the first UE may be referred to as an intended UE for such communications); subsequent communications between the first UE and the second network device (in which the first UE may again be referred to as an intended UE for such communications); subsequent communications between the second UE and the second network device. From the perspective of the second network device, transmitted interference mitigation signaling would be related to first UE/second network device communications as shown by way of example at 758 and 958 in FIGS. 7 and 9, and/or related to second UE/second network device communications as shown by way of example at 654, 756, 862, 956 in FIGS. 6A-9.

As described at least above in the description of FIG. 10B, coordination between the first network device and the second network device, on interference mitigation and/or RE selection, may involve an exchange of direct signaling, such as direct messages, between the first network device and the second network device. Signaling features described in this context may also or instead be provided or supported in aggressor (second) network device embodiments.

In some embodiments, a method may also involve transmitting, to the first UE from the second network device, a further configuration of further REs for communications between the first UE and the second network device. This is described by way of example for dual connection scenarios at least with reference to FIGS. 7 and 9, and is also shown by way of example at 926 in FIG. 9. Selection of these further REs may involve coordinating, by the second network device with the first network device at 1022, for example, on selecting the further REs.

Configuration of the further REs may be dependent upon UE capability, and some embodiments, may involve receiving at 1020, from the first UE by the second network device, an indication of a capability of the first UE to measure interference and/or report the interference to the second network device. Transmitting the further configuration may then involve transmitting the further configuration to the first UE responsive to receiving the indication of the capability from the first UE. Thus, the second network device may configure the further REs accordingly, after receiving an indication or report of UE capability from the first UE.

Interference mitigation may, in some embodiments, be based on interference measurement associated with the further REs. In such embodiments, a method may involve transmitting, to the first UE from the second network device, signaling related to such interference mitigation, to be applied to subsequent communications between the first UE and the second network device.

The first and second network devices may be in the same system, such as the above-referenced first wireless communication system, or in different systems, with the first network device being in the first wireless communication system and the second network device being in a second wireless communication system.

FIG. 10D illustrates a method at a second (aggressor) UE. As shown, the method may involve receiving at 1030, by a second UE from a second network device, a configuration of REs that are to be muted for communications with the second network device, and using the REs at 1032 according to the configuration, for the determination of the different components of interference. This is shown by way of example at 624, 724, 824, 924 in FIGS. 6A-9, respectively. As in other embodiments, the REs include a subset of REs (some of the REs at time position A4 in FIG. 6, for example) corresponding to first REs that are for measurement of interference. The interference affects communications between a first UE and a first network device in a first wireless communication system. The REs include not only these corresponding REs, but all REs at a time position (shown by way of example at A4 in FIG. 6) in a time-frequency grid that are to be muted for communications between the second UE and the second network device.

The set of second REs may be described as corresponding to a plurality of first REs for determination of different components of interference that affects communications between the first UE and the first network device. The set of second REs includes all REs at a time position in a time-frequency grid that are to be muted for communications between the second network device and the second UE, and a subset of the REs at the time position correspond to a subset of the first REs. The set of second REs further includes an RE, at a different time position in the time-frequency grid different from the time position at which all REs are muted, corresponding to another RE of the plurality of first REs.

An optional feature of receiving, by the second UE from the second network device, signaling related to interference mitigation that is based on the measurement of interference, is shown at 1034. Examples of interference mitigation and related features are provided elsewhere herein, and such features may also or instead be implemented in aggressor UE embodiments.

FIGS. 10A-D and the foregoing descriptions thereof are illustrative of features that may be provided in various embodiments. Features disclosed in the context of one embodiment may also or instead be provided or supported in other embodiments. Other features may also or instead be provided or supported.

For example, reference is made primarily to one victim being impacted by cross-link interference from one other link. It should be appreciated that features herein may be applied to scenarios in which a victim is subjected to or affected by interference from multiple cross-links, between multiple UEs and a second network device or multiple other network devices. Features that are disclosed herein with reference to a second (aggressor) network device or a second (aggressor) UE may be applied to each of multiple aggressor network device(s) or UE(s) associated with multiple interfering links. Thus, for example, a second network device or UE may be one of multiple second network devices or UEs, and features herein may apply to each of those second network devices or UEs.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to, or a processor, device, or other component may otherwise be configured to, receive by a first UE from a first network device in a first wireless communication system, a configuration of first REs, and to use the first REs by the first UE according to the configuration for determination of different components of interference. The interference affects communications between the first UE and the first network device.

In another embodiment, programming stored in or on a non-transitory computer readable storage medium may include instructions to or to cause a processor to, or a processor, device, or other component may otherwise be configured to, transmit to a first UE from a first network device in a first wireless communication system, a configuration of first REs, and to use the first REs by the first network device according to the configuration for determination of different components of interference.

Another embodiment may involve programming stored in or on a non-transitory computer readable storage medium may include instructions to or to cause a processor to, or a processor, device, or other component may otherwise be configured to, coordinate with a first network device in a first wireless communication system by a second network device, a set of second REs (including REs that are to be muted for communications with the second network device), and to transmit, to a second UE from the second network device, a configuration to mute the REs for communications between the second UE and the second network device.

Programming stored in or on a non-transitory computer readable storage medium may include instructions to or to cause a processor to, or a processor, device, or other component may otherwise be configured to, receive, by a second UE from a second network device, a configuration of second REs (including REs that are to be muted for communications with the second network device), and to use the REs by the second UE according to the configuration for the determination of the different components of interference.

Apparatus embodiments are not limited to the foregoing examples, or to processor-based or programming-based embodiments.

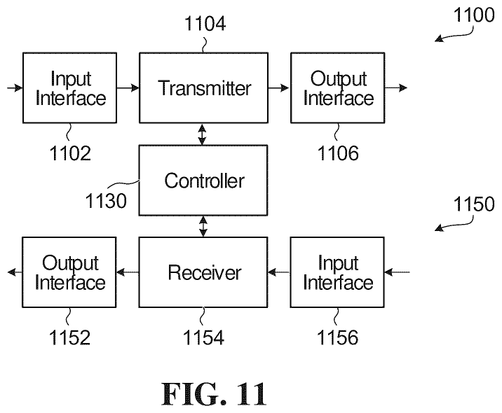

FIG. 11 is a block diagram illustrating an apparatus according to an embodiment. At 1100, FIG. 11 illustrates components of an example apparatus in which or in conjunction with which transmitting features may be implemented, and components of an example apparatus in which or in conjunction with which receiving features may be implemented is illustrated at 1150. A controller 1130 may be provided in either of these types of apparatus. In some embodiments, an apparatus may include both transmitting and receiving features. In the example shown in FIG. 11, an apparatus with all of the illustrated components supports both transmitting features and receiving features.

For transmitting features, the example apparatus in FIG. 11 includes an input interface 1102, a transmitter 1104 coupled to the input interface, an output interface 1106 coupled to the transmitter, and the controller 1130 coupled to the transmitter. The input interface 1102 is illustrated to generally represent a connection to other apparatus components to obtain information that is to be transmitted. Although shown as a separate component in FIG. 11, the output interface 1106 through which transmissions are made by the transmitter 1104 may be provided by or incorporated into the transmitter. Similarly, although shown as a separate input interface 1102 in FIG. 11, an interface through which information for transmission is obtained by the transmitter 1104 may be provided by or incorporated into the transmitter.

For receiving features, the example apparatus in FIG. 11 includes an input interface 1156 for received signals, a receiver 1154 coupled to the input interface, an output interface 1152 coupled to the receiver, and the controller 1130 coupled to the receiver. The input interface 1156 is illustrated to generally represent a connection to other apparatus components to receive signals from one or more network devices. Although shown as a separate component in FIG. 11, the input interface 1156 through which signals are received by the receiver 1154 may be provided by or incorporated into the receiver. Similarly, although shown as a separate output interface 1152 in FIG. 11, an interface through which information from received signals is provided to other components by the receiver 1154 may be provided by or incorporated into the receiver.

Transmitting and receiving features or functions, and other features or functions herein, may be implemented in any of various ways, such as in hardware, firmware, or one or more components that execute software. The present disclosure is not limited to any specific type of implementation, and implementation details may vary between different devices.

Information for transmission may be obtained, signals may be transmitted, signals may be received, and information from received signals may be provided to other apparatus components, via any of various types of interface, including a communication interface in the case of signals transmitted by the transmitter 1104 and/or signals received by the receiver 1154. Embodiments are not in any way restricted to any particular type of interface, the implementation of which may be based at least in part on a type of device (UE or network device for example) in which an apparatus is to be implemented.

In an embodiment, an apparatus for a first UE as disclosed herein includes a receiver such as the receiver 1154 for receiving from a first network device in a first wireless communication system, a configuration of a plurality of first REs, and a controller such as the controller 1130, coupled to the receiver, to control the apparatus to use the first REs according to the configuration.

More generally, an apparatus for a first UE or a component thereof such as a receiver 1154 or a processor may be configured to receive (or for receiving) the configuration of first REs, or programming may include instructions to receive (or for receiving) the configuration of first REs or to cause a processor to receive the configuration of first REs from the first network device. An apparatus for a first UE or a component thereof such as a controller 1130, which may be coupled to the receiver 1154, may be configured to control (or for controlling), or programming may include instructions to control (or for controlling) the apparatus to use the first REs according to the configuration.

Embodiments related to such apparatus or non-transitory computer readable storage media may include any one or more of the following features, for example, which are also discussed elsewhere herein:
the first REs may include an RE, in which there is to be no communication between the first UE and the first network device, that corresponds to an RE in the set of second REs-such an RE enables a measurement to be taken of a component of the interference comprising residual interference and noise (see, for example, the detailed description related to the yᵣ₁ example above, which is also an example of the first REs including an RE that corresponds to one of the REs that are muted, wherein the RE (of the first REs) is not used for communication between the first UE and the first network device, and is used for a measurement to be taken of a component of the interference including residual interference and noise);
the first REs may include an RE, in which there is to be no communication between the first UE and the first network device, that corresponds to an RE at a different time position in the time-frequency grid different from the time position at which all REs are muted for communications by the second UE-such an RE enables a measurement to be taken of interference comprising a component of the interference caused by communications by the second UE, and a component of the interference comprising residual interference and noise (see, for example, the detailed description related to the yᵣ₂ example above, which is also an example of the first REs including an RE that corresponds to an RE at a time position different from the time position of the REs that are muted, wherein the RE (one of the first REs) is not used for communication between the first UE and the first network device, and is used for a measurement to be taken of interference including a component of the interference caused by communications by the second UE, and a component of the interference including residual interference and noise);
the first REs may include both of these REs, and the measurement of the component of the interference that includes residual interference and noise, and the measurement of the interference including the component of the interference caused by communications by the second UE and the component of the interference including the residual interference and noise, enable determination of the component of the interference caused by communications by the second UE (see, for example, the detailed description related to the combined yᵣ₁ and yᵣ₂ example above)—with both of these REs, the component of the interference caused by communications by the second UE is determinable from the measurement of the component of the interference that includes residual interference and noise and the measurement of the interference that includes the component of the interference caused by communications by the second UE and component of the interference including the residual interference and noise;
the first REs may also or instead include a reference signal RE, in which a reference signal is to be communicated between the first UE and the first network device, that corresponds to an RE in the set of second REs—the using may then involve communicating, by the first UE with the first network device, the reference signal to enable a measurement to be taken based on the reference signal and including a component of the interference that includes residual interference and noise (see, for example, the detailed description related to the yᵣ₃ example above)—these examples also illustrate that the first REs may include a reference signal RE that corresponds to an RE of the REs that are muted, wherein the reference signal RE is used to communicate a reference signal between the first UE and the first network device for such a measurement to be taken;
such communicating (and other communicating referenced below) may involve receiving or transmitting the reference signal;
to support such receiving, the apparatus or a component thereof such as a receiver 1154 or a processor may be configured to receive (or for receiving), or programming may include instructions to receive (or for receiving), the reference signal by the first UE from the first network device;
to support such transmitting, the apparatus or a component thereof such as a transmitter 1104 or a processor may be configured to transmit (or for transmitting), or programming may include instructions to transmit (or for transmitting), the reference signal by the first UE to the first network device;
such an RE and related features may be implemented in combination with one or more other REs and related features—for example, the measurement based on the reference signal, the measurement of the component of the interference that includes residual interference and noise, and the measurement of the interference that includes the component of the interference caused by communications by the second UE and the component of the interference including residual interference and noise, may further enable determination of the component of the interference caused by communications by the second UE (see, for example, the detailed description related to the combined yᵣ₁, yᵣ₂, and yᵣ₃ example above)—such a combined implementation may be described as the component of the interference caused by communications by the second UE being determinable from the measurement based on the reference signal, the measurement of the component of the interference including residual interference and noise, and the measurement of the interference including the component of the interference caused by communications by the second UE and the component of the interference that includes residual interference and noise;
the first REs may also or instead include a reference signal RE, in which a reference signal is to be communicated between the first UE and the first network device, that corresponds to an RE at a different time position in the time-frequency grid different from the time position at which all REs are muted for communications by the second UE—the using may then involve communicating, by the first UE with the first network device, the reference signal to enable a measurement to be taken based on the reference signal and including a component of the interference caused by communications by the second UE and a component of the interference that includes residual interference and noise (see, for example, the detailed description related to the yᵣ₄ example above, which is also illustrative of the first REs including a reference signal RE that corresponds to an RE at a time position different from the time position of the REs that are muted, wherein the reference signal RE is used to communicate a reference signal between the first UE and the first network device for such a measurement to be taken);
such an RE may be used with other REs disclosed herein—for example, the measurement based on the reference signal, the measurement of the component of the interference that includes residual interference and noise, and the measurement of the interference including the component of the interference caused by communications by the second UE and the component of the interference that includes residual interference and noise, enable determination of the component of the interference caused by communications by the second UE (see, for example, the detailed description related to the combined yᵣ₁, yᵣ₂, and yᵣ₄ example above)—these are also examples in which the component of the interference caused by communications by the second UE is determinable from the measurement based on the reference signal, the measurement of the component of the interference that includes residual interference and noise, and the measurement of the interference that includes the component of the interference caused by communications by the second UE and the component of the interference including residual interference and noise;
the first REs may also or instead include an RE, in which there is to be no communication between the first UE and the first network device, that corresponds to an RE in which there is to be no communication by the second UE and at a different time position in the time-frequency grid different from the time position at which all REs are muted for communications by the second UE-such an RE enables measurement of interference that includes an adjacent channel component of the interference caused by communications by the second UE, and a component of the interference including residual interference and noise-another description is that the first REs may include an RE that corresponds to an RE in which there is to be no communication by the second UE and at a time position different from the time position of the REs that are muted, and that RE (one of the first REs) is not used for communication between the first UE and the first network device, and is used for such a measurement to be taken (see, for example, the detailed description related to the yᵣ₅ example above);
in an embodiment that involves such an RE and another RE as disclosed herein, the measurement of the component of the interference that includes residual interference and noise, and the measurement of interference including the adjacent channel component and the component of the interference that includes residual interference and noise, enable determination of the adjacent channel component of the interference—in other words, the adjacent channel component of the interference is determinable from the measurement of the component of the interference that includes residual interference and noise and the measurement of interference that includes the adjacent channel component and the component of the interference including residual interference and noise (see, for example, the detailed description related to the combined yᵣ₁ and yᵣ₅ example above);
the first REs may also or instead include a reference signal RE, in which a reference signal is to be communicated between the first UE and the first network device, that corresponds to an RE in which there is to be no communication by the second UE and at a different time position in the time-frequency grid different from the time position at which all REs are muted for communications by the second UE—the using may then involve communicating the reference signal by the first UE with the first network device to enable a measurement to be taken based on the reference signal and including an adjacent channel component of the interference caused by communications by the second UE and a component of the interference that includes residual interference and noise—in such a reference signal example, the first REs include a reference signal RE that corresponds to an RE in which there is to be no communication by the second UE and at a time position different from the time position of the REs that are muted, and the reference signal RE is used to communicate a reference signal between the first UE and the first network device for such a measurement to be taken (see, for example, the detailed description related to the yᵣ₆ example above);
such a reference signal RE may be used with one or more other REs—for example, the measurement based on the reference signal and including the component of the interference that includes residual interference and noise, and the measurement based on the reference signal, may enable determination of the adjacent channel component of the interference (see, for example, the detailed description related to the combined yᵣ₆ and yᵣ₃ example above);
another way to describe an example in which there are multiple reference signal REs is as follows: the first REs may include a reference signal RE that corresponds to an RE of the REs that are muted and is used to communicate a reference signal between the first UE and the first network device for a measurement to be taken based on the reference signal and including a component of the interference that includes residual interference and noise, the first REs further include a further reference signal RE that corresponds to an RE in which there is to be no communication by the second UE and at a time position different from the time position of the REs that are muted, wherein the further reference signal RE is used to communicate a further reference signal between the first UE and the first network device for a measurement to be taken based on the further reference signal and comprising an adjacent channel component of the interference caused by communications by the second UE and the component of the interference comprising residual interference and noise, and the adjacent channel component of the interference is determinable from the measurement based on the reference signal and the measurement based on the further reference signal;
the controller may be further configured to control the apparatus to determine the different components of the interference, or more generally the apparatus or a component thereof such as a processor may be configured to determine (or for determining), or programming may include instructions to determine (or for determining) the different components of the interference;
the apparatus or a component thereof such as a transmitter 1104 or a processor may be configured to report (or for reporting), or programming may include instructions to report (or for reporting), to the first network device based on the determined different components of the interference;
the controller may be further configured to control the apparatus to determine an effective adjacent channel leakage ratio (ACLR) based on the determined different components of the interference, or more generally the apparatus or a component thereof such as a processor may be configured to determine (or for determining), or programming may include instructions to determine (or for determining) an effective ACLR based on the determined different components of the interference;
the apparatus or a component thereof such as a transmitter 1104 or a processor may be configured to report (or for reporting), or programming may include instructions to report (or for reporting), to the second network device based on the determined different components of the interference;
the configuration of the first REs is periodic, semi-persistent, or triggered by an event;
the apparatus or a component thereof such as a transmitter 1104 or a processor may be configured to transmit (or for transmitting), or programming may include instructions to transmit (or for transmitting), to the first network device, an indication of a capability of the first UE to measure and/or report the interference to the first network device;
the configuration is received responsive to transmitting the indication of the capability;
the receiver is further configured to receive (or for receiving), the apparatus or another component thereof is configured to receive (or for receiving), or programming may include instructions to receive (or for receiving), from the first network device, signaling related to interference mitigation that is based on the measurement of interference;
the interference mitigation includes any one or more of the following: changing scheduled or configured resources, redefining boundaries of a bandwidth part, changing or switching a bandwidth part, avoiding scheduling in impacted resources, changing RSRP signal strength, changing allocated power level, power control, switching a serving transmit beam, switching a receive beam, switching a beam pair link, hybrid beamforming, adaptive frequency hopping, focused beamforming;
the communications by the second UE are communications between the second UE and a second network device in a second wireless communication system;
the set of second REs is based on coordination between the first network device and the second network device;
the coordination between the first network device and the second network device involves an exchange of direct signaling between the first network device and the second network device related to one or more parameters of the configuration;
the communications by the second UE are communications between the second UE and the first network device;
the receiver is further configured to receive (or for receiving), the apparatus or another component thereof is configured to receive (or for receiving), or programming may include instructions to receive (or for receiving), by the first UE from the second network device, a further configuration of further REs for communications between the first UE and the second network device;
the apparatus or a component thereof such as a transmitter 1104 or a processor may be configured to transmit (or for transmitting), or programming may include instructions to transmit (or for transmitting), to the second network device, an indication of a capability of the first UE to measure and/or report the interference to the second network device; the further configuration is received responsive to transmitting the indication of the capability;
the receiver is further configured to receive (or for receiving), the apparatus or another component thereof is configured to receive (or for receiving), or programming may include instructions to receive (or for receiving), by the first UE from the second network device, signaling related to interference mitigation, based on interference measurement associated with the further REs, to be applied to subsequent communications between the first UE and the second network device;
the interference mitigation to be applied to subsequent communications between the first UE and the second network device comprises any one or more of the following, for the subsequent communications between the first UE and the second network device: changing scheduled or configured resources, redefining boundaries of a bandwidth part, changing or switching a bandwidth part, avoiding scheduling in impacted resources, changing RSRP signal strength, changing allocated power level, power control, switching a serving transmit beam, switching a receive beam, switching a beam pair link, hybrid beamforming, adaptive frequency hopping, focused beamforming;
one of the first wireless communication system and the second wireless communication system comprises a terrestrial network, and the other of the first wireless communication system and the second wireless communication system comprises a non-terrestrial network.

An apparatus for a first network device or a component thereof such as a transmitter 1104 or a processor may be configured to transmit (or for transmitting) the configuration of first REs, or programming may include instructions to transmit (or for transmitting) the configuration of first REs or to cause a processor to transmit the configuration of first REs to a first UE. An apparatus for a first network device or a component thereof such as a controller 1130, which may be coupled to the transmitter 1104, may be configured to control (or for controlling), or programming may include instructions to control (or for controlling) the apparatus to use the first REs according to the configuration.

Embodiments related to such apparatus or non-transitory computer readable storage media may include any one or more of the following features, for example, which are also discussed elsewhere herein:
the first REs may include an RE, in which there is to be no communication between the first UE and the first network device, that corresponds to an RE in the set of second REs-such an RE enables a measurement to be taken of a component of the interference comprising residual interference and noise;
the first REs include an RE that corresponds to an RE of the REs that are muted, and the RE (which is one of the first REs) is not used for communication between the first UE and the first network device but is used for a measurement to be taken of a component of the interference including residual interference and noise;
the detailed description related to the yᵣ₁ example above is illustrative of the two preceding items;
the first REs may include an RE, in which there is to be no communication between the first UE and the first network device, that corresponds to an RE at a different time position in the time-frequency grid different from the time position at which all REs are muted for communications by the second UE-such an RE enables a measurement to be taken of interference comprising a component of the interference caused by communications by the second UE, and a component of the interference comprising residual interference and noise;
the first REs include an RE that corresponds to an RE at a time position different from the time position of the REs that are muted, the RE (which is one of the first REs) is not used for communication between the first UE and the first network device, and is used for a measurement to be taken of interference including a component of the interference caused by communications by the second UE, and a component of the interference that includes residual interference and noise;
the detailed description related to the yᵣ₂ example above is illustrative of the two preceding items;
the first REs may include both of the above two types of REs, and the measurement of the component of the interference that includes residual interference and noise, and the measurement of the interference including the component of the interference caused by communications by the second UE and the component of the interference including the residual interference and noise, then enable determination of the component of the interference caused by communications by the second UE;
the component of the interference caused by communications by the second UE is determinable from the measurement of the component of the interference including residual interference and noise and the measurement of the interference including the component of the interference caused by communications by the second UE and component of the interference that includes the residual interference and noise;
the detailed description related to the combined yᵣ₁ and yᵣ₂ example above is illustrative of the two preceding items;
the first REs may also or instead include a reference signal RE, in which a reference signal is to be communicated between the first UE and the first network device, that corresponds to an RE in the set of second REs—the using may then involve communicating, with the first UE by the first network device, the reference signal to enable a measurement to be taken based on the reference signal and including a component of the interference that includes residual interference and noise;
the first REs may include a reference signal RE that corresponds to an RE of the REs that are muted, and the reference signal RE is used to communicate a reference signal between the first UE and the first network device for a measurement to be taken based on the reference signal and including a component of the interference that includes residual interference and noise;
the detailed description related to the yᵣ₃ example above is illustrative of the two preceding items;
such communicating (and other communicating referenced below) may involve receiving or transmitting the reference signal;
to support such receiving, the apparatus or a component thereof such as a receiver 1154 or a processor may be configured to receive (or for receiving), or programming may include instructions to receive (or for receiving), the reference signal by the first UE from the first network device;
to support such transmitting, the apparatus or a component thereof such as a transmitter 1104 or a processor may be configured to transmit (or for transmitting), or programming may include instructions to transmit (or for transmitting), the reference signal by the first UE to the first network device;
such a reference signal RE and related features may be implemented in combination with one or more other REs and related features—for example, the measurement based on the reference signal, the measurement of the component of the interference that includes residual interference and noise, and the measurement of the interference that includes the component of the interference caused by communications by the second UE and the component of the interference including residual interference and noise, may further enable determination of the component of the interference caused by communications by the second UE;
the component of the interference caused by communications by the second UE is determinable from the measurement based on the reference signal, the measurement of the component of the interference including residual interference and noise, and the measurement of the interference including the component of the interference caused by communications by the second UE and the component of the interference that includes residual interference and noise;
the detailed description related to the combined yᵣ₁, yᵣ₂, and yᵣ₃ example above is illustrative of the two preceding items;
the first REs may also or instead include a reference signal RE, in which a reference signal is to be communicated between the first UE and the first network device, that corresponds to an RE at a different time position in the time-frequency grid different from the time position at which all REs are muted for communications by the second UE—the using may then involve communicating the reference signal to enable a measurement to be taken based on the reference signal and including a component of the interference caused by communications by the second UE and a component of the interference that includes residual interference and noise;
the first REs include a reference signal RE that corresponds to an RE at a time position different from the time position of the REs that are muted, and the reference signal RE is used to communicate a reference signal between the first UE and the first network device for a measurement to be taken based on the reference signal and including a component of the interference caused by communications by the second UE and a component of the interference that includes residual interference and noise;
the detailed description related to the yᵣ₄ example above is illustrative of the two preceding items;
such a reference signal RE may be used with other REs disclosed herein—for example, the measurement based on the reference signal, the measurement of the component of the interference that includes residual interference and noise, and the measurement of the interference including the component of the interference caused by communications by the second UE and the component of the interference that includes residual interference and noise, enable determination of the component of the interference caused by communications by the second UE;
the component of the interference caused by communications by the second UE is determinable from the measurement based on the reference signal, the measurement of the component of the interference including residual interference and noise, and the measurement of the interference including the component of the interference caused by communications by the second UE and the component of the interference that includes residual interference and noise;
the detailed description related to the combined yᵣ₁, yᵣ₂, and yᵣ₄ example above is illustrative of the two preceding items;
the first REs may also or instead include an RE, in which there is to be no communication between the first UE and the first network device, that corresponds to an RE in which there is to be no communication by the second UE and at a different time position in the time-frequency grid different from the time position at which all REs are muted for communications by the second UE-such an RE enables measurement of interference that includes an adjacent channel component of the interference caused by communications by the second UE, and a component of the interference including residual interference and noise;
the first REs include an RE that corresponds to an RE in which there is to be no communication by the second UE and at a time position different from the time position of the REs that are muted, and the RE (one of the first REs) is not used for communication between the first UE and the first network device but is used for a measurement to be taken of interference including an adjacent channel component of the interference caused by communications by the second UE, and a component of the interference that includes residual interference and noise;
the detailed description related to the yᵣ₅ example above is illustrative of the two preceding items;
in an embodiment that involves such an RE and another RE as disclosed herein, the measurement of the component of the interference that includes residual interference and noise, and the measurement of interference including the adjacent channel component and the component of the interference that includes residual interference and noise, enable determination of the adjacent channel component of the interference;
the adjacent channel component of the interference may be determinable from the measurement of the component of the interference including residual interference and noise and the measurement of interference including the adjacent channel component and the component of the interference that includes residual interference and noise;
the detailed description related to the combined yᵣ₁ and yᵣ₅ example above is illustrative of the two preceding items;
the first REs may also or instead include a reference signal RE, in which a reference signal is to be communicated between the first UE and the first network device, that corresponds to an RE in which there is to be no communication by the second UE and at a different time position in the time-frequency grid different from the time position at which all REs are muted for communications by the second UE—the using may then involve communicating the reference signal with the first UE by the first network device to enable a measurement to be taken based on the reference signal and including an adjacent channel component of the interference caused by communications by the second UE and a component of the interference that includes residual interference and noise;
the first REs include a reference signal RE that corresponds to an RE in which there is to be no communication by the second UE and at a time position different from the time position of the REs that are muted, and the reference signal RE is used to communicate a reference signal between the first UE and the first network device for a measurement to be taken based on the reference signal and including an adjacent channel component of the interference caused by communications by the second UE and a component of the interference that includes residual interference and noise;
the detailed description related to the yᵣ₆ example above is illustrative of the two preceding items;
such a reference signal RE may be used with one or more other REs—for example, the measurement based on the reference signal and including the component of the interference that includes residual interference and noise, and the measurement based on the reference signal, may enable determination of the adjacent channel component of the interference;
the first REs may include a reference signal RE that corresponds to an RE of the REs that are muted and that is used to communicate a reference signal between the first UE and the first network device for a measurement to be taken based on the reference signal and including a component of the interference that includes residual interference and noise, and the first REs may further include a further reference signal RE that corresponds to an RE in which there is to be no communication by the second UE and at a time position different from the time position of the REs that are muted, wherein the further reference signal RE is used to communicate a further reference signal between the first UE and the first network device for a measurement to be taken based on the further reference signal and including an adjacent channel component of the interference caused by communications by the second UE and the component of the interference that includes residual interference and noise—the adjacent channel component of the interference is then determinable from the measurement based on the reference signal and the measurement based on the further reference signal;
the detailed description related to the combined yᵣ₆ and yᵣ₃ example above is illustrative of the two preceding items;
the apparatus or a component thereof such as a receiver 1154 may be configured to receive (or for receiving), or programming may include instructions to receive (or for receiving), from the first UE, a report based on the different components of the interference determined by the first UE;
the apparatus or a component thereof such as a transmitter 1104 or a processor may be configured to transmit (or for transmitting), or programming may include instructions to transmit (or for transmitting), to the first UE, signaling related to interference mitigation that is based on the different components of the interference;
the configuration of the first REs is periodic, semi-persistent, or triggered by an event;
the apparatus or a component thereof such as a receiver 1154 or a processor may be configured to receive (or for receiving), or programming may include instructions to receive (or for receiving), from the first UE, an indication of a capability of the first UE to measure and/or report the interference to the first network device;
the configuration is transmitted to the first UE responsive to receiving the indication of the capability from the first UE;
the transmitter is further configured to transmit (or for transmitting), the apparatus or another component thereof is configured to transmit (or for transmitting), or programming may include instructions to transmit (or for transmitting), to the first UE from the first network device, signaling related to interference mitigation that is based on the measurement of interference;
the interference mitigation includes any one or more of the following: changing scheduled or configured resources, redefining boundaries of a bandwidth part, changing or switching a bandwidth part, avoiding scheduling in impacted resources, changing RSRP signal strength, changing allocated power level, power control, switching a serving transmit beam, switching a receive beam, switching a beam pair link, hybrid beamforming, adaptive frequency hopping, focused beamforming;
the communications by the second UE are communications between the second UE and a second network device in a second wireless communication system;
the controller is further configured to coordinate (or for coordinating), the apparatus or another component thereof is configured to coordinate (or for coordinating), or programming may include instructions to coordinate (or for coordinating), by the first network device with the second network device, on the interference mitigation;
the interference mitigation comprises interference mitigation to be applied to any one or more of the following: subsequent communications between the first UE and the first network device, subsequent communications between the first UE and the second network device, subsequent communications between the second UE and the second network device;
the controller is further configured to coordinate (or for coordinating), the apparatus or another component thereof is configured to coordinate (or for coordinating), or programming may include instructions to coordinate (or for coordinating), by the first network device with the second network device, the REs in the set of second REs;
the coordinating involves exchanging direct signaling between the first network device and the second network device related to one or more parameters of the configuration;
the communications by the second UE are communications between the second UE and the first network device.

An apparatus for a second network device or a component thereof such as a controller 1130 or a processor may be configured to coordinate (or for coordinating), with a first network device in a first wireless communication system, a set of REs. An apparatus for a second network device or a component thereof such as a transmitter 1104, which may be coupled to the controller 1130, may be configured to transmit (or for transmitting), or programming may include instructions to transmit (or for transmitting), to a second UE, a configuration to mute REs in the set of REs for communications between the second UE and the second network device.

Embodiments related to such apparatus or non-transitory computer readable storage media may include any one or more of the following features, for example, which are also discussed elsewhere herein:
the first REs may include an RE, in which there is to be no communication between the first UE and the first network device, that corresponds to an RE in the set of second REs-such an RE enables a measurement to be taken of a component of the interference comprising residual interference and noise;
the first REs may include an RE that corresponds to one of the REs that are muted—that RE (one of the first REs) is not used for communication between the first UE and the first network device, and is used for a measurement to be taken of a component of the interference that includes residual interference and noise;
the detailed description related to the yᵣ₁ example above is illustrative of the two preceding items;
the first REs may include an RE, in which there is to be no communication between the first UE and the first network device, that corresponds to an RE at a different time position in the time-frequency grid different from the time position at which all REs are muted for communications by the second UE-such an RE enables a measurement to be taken of interference comprising a component of the interference caused by communications between the second UE and the second network device, and a component of the interference comprising residual interference and noise;
the first REs may include an RE that corresponds to an RE at a time position different from the time position of the REs that are muted, and that RE (one of the first REs) is not used for communication between the first UE and the first network device, but is used for a measurement to be taken of interference including a component of the interference caused by communications between the second UE and the second network device, and a component of the interference that includes residual interference and noise;
the detailed description related to the yᵣ₂ example above is illustrative of the two preceding items;
the first REs may include both of these REs, and the measurement of the component of the interference that includes residual interference and noise, and the measurement of the interference including the component of the interference caused by communications between the second UE and the second network device and the component of the interference including the residual interference and noise, then enable determination of the component of the interference caused by communications between the second UE and the second network device;
the component of the interference caused by communications between the second UE and the second network device is determinable from the measurement of the component of the interference including residual interference and noise and the measurement of the interference including the component of the interference caused by communications between the second UE and the second network device and the component of the interference that includes the residual interference and noise;
the detailed description related to the combined yᵣ₁ and yᵣ₂ example above is illustrative of the two preceding items;
the first REs may also or instead include a reference signal RE, in which a reference signal is to be communicated between the first UE and the first network device—the reference signal enables a measurement to be taken based on the reference signal and including a component of the interference that includes residual interference and noise;
the first REs may include a reference signal RE that corresponds to one of the REs that are muted, and the reference signal RE is used to communicate a reference signal between the first UE and the first network device for a measurement to be taken based on the reference signal and including a component of the interference that includes residual interference and noise;
the detailed description related to the yᵣ₃ example above is illustrative of the two preceding items;
such a reference signal RE and related features may be implemented in combination with one or more other REs and related features—for example, the measurement based on the reference signal, the measurement of the component of the interference that includes residual interference and noise, and the measurement of the interference that includes the component of the interference caused by communications between the second UE and the second network device and the component of the interference including residual interference and noise, may further enable determination of the component of the interference caused by communications between the second UE and the second network device;
the detailed description related to the combined yᵣ₁, yᵣ₂, and yᵣ₃ example above is illustrative of the two preceding items;
the first REs may also or instead include a reference signal RE, in which a reference signal is to be communicated between the first UE and the first network device, that corresponds to an RE at a different time position in the time-frequency grid different from the time position at which all REs are muted for communications between the second UE and the second network device—the reference signal enables a measurement to be taken based on the reference signal and including a component of the interference caused by communications between the second UE and the second network device and a component of the interference that includes residual interference and noise;
the first REs may include a reference signal RE that corresponds to an RE at a time position different from the time position of the REs that are muted, and the reference signal RE is used to communicate a reference signal between the first UE and the first network device for a measurement to be taken based on the reference signal and including a component of the interference caused by communications between the second UE and the second network device and a component of the interference that includes residual interference and noise;
the detailed description related to the yᵣ₄ example above is illustrative of the two preceding items;
such an RE may be used with other REs disclosed herein—for example, the measurement based on the reference signal, the measurement of the component of the interference that includes residual interference and noise, and the measurement of the interference including the component of the interference caused by communications between the second UE and the second network device and the component of the interference that includes residual interference and noise, enable determination of the component of the interference caused by communications between the second UE and the second network device;
the component of the interference caused by communications between the second UE and the second network device is determinable from the measurement based on the reference signal, the measurement of the component of the interference including residual interference and noise, and the measurement of the interference including the component of the interference caused by communications between the second UE and the second network device and the component of the interference that includes residual interference and noise;
the detailed description related to the combined yᵣ₁, yᵣ₂, and yᵣ₄ example above is illustrative of the two preceding items;
the first REs may also or instead include an RE, in which there is to be no communication between the first UE and the first network device, that corresponds to an RE in which there is to be no communication between the second UE and the second network device and at a different time position in the time-frequency grid different from the time position at which all REs are muted for communications between the second UE and the second network device-such an RE enables measurement of interference that includes an adjacent channel component of the interference caused by communications between the second UE and the second network device, and a component of the interference including residual interference and noise;
the first REs may include an RE that corresponds to an RE in which there is to be no communication between the second UE and the second network device and at a time position different from the time position of the REs that are muted, and the RE in the plurality of first REs is not used for communication between the first UE and the first network device but is used for a measurement to be taken of interference including an adjacent channel component of the interference caused by communications between the second UE and the second network device, and a component of the interference that includes residual interference and noise;
the detailed description related to the yᵣ₅ example above is illustrative of the two preceding items;
in an embodiment that involves such an RE and another RE as disclosed herein, the measurement of the component of the interference that includes residual interference and noise, and the measurement of interference including the adjacent channel component and the component of the interference that includes residual interference and noise, enable determination of the adjacent channel component of the interference;
the adjacent channel component of the interference is determinable from the measurement of the component of the interference including residual interference and noise and the measurement of interference including the adjacent channel component and the component of the interference that includes residual interference and noise;
the detailed description related to the combined yᵣ₁ and yᵣ₅ example above is illustrative of the two preceding items;
the first REs may also or instead include a reference signal RE, in which a reference signal is to be communicated between the first UE and the first network device, that corresponds to an RE in which there is to be no communication between the second UE and the second network device and at a different time position in the time-frequency grid different from the time position at which all REs are muted for communications between the second UE and the second network device—the reference signal enables a measurement to be taken based on the reference signal and including an adjacent channel component of the interference caused by communications between the second UE and the second network device and a component of the interference that includes residual interference and noise;
the first REs may include a reference signal RE that corresponds to an RE in which there is to be no communication between the second UE and the second network device and at a time position different from the time position of the REs that are muted, and the reference signal RE is used to communicate a reference signal between the first UE and the first network device for a measurement to be taken based on the reference signal and including an adjacent channel component of the interference caused by communications between the second UE and the second network device and a component of the interference including residual interference and noise;
the detailed description related to the yᵣ₆ example above is illustrative of the two preceding items;
such an RE may be used with one or more other REs—for example, the measurement based on the reference signal and including the component of the interference that includes residual interference and noise, and the measurement based on the reference signal, may enable determination of the adjacent channel component of the interference;
the first REs may include a reference signal RE that corresponds to an RE of the REs that are muted and that is used to communicate a reference signal between the first UE and the first network device for a measurement to be taken based on the reference signal and including a component of the interference that includes residual interference and noise, and the first REs may further include a further reference signal RE that corresponds to an RE in which there is to be no communication between the second UE and the second network device and at a time position different from the time position of the REs that are muted, wherein the further reference signal RE is used to communicate a further reference signal between the first UE and the first network device for a measurement to be taken based on the further reference signal and including an adjacent channel component of the interference caused by communications between the second UE and the second network device and the component of the interference that includes residual interference and noise—the adjacent channel component of the interference is then determinable from the measurement based on the reference signal and the measurement based on the further reference signal;
the detailed description related to the combined yᵣ₆ and yᵣ₃ example above is illustrative of the two preceding items;
the apparatus or a component thereof such as a receiver 1154 may be configured to receive (or for receiving), or programming may include instructions to receive (or for receiving), from the first UE, a report based on the different components of the interference determined by the first UE;
the controller is further configured to coordinate (or for coordinating), the apparatus or another component thereof is configured to coordinate (or for coordinating), or programming may include instructions to coordinate (or for coordinating), with the first network device by the second network device, on interference mitigation that is based on the different components of the interferences, or a measurement of interference;
the interference mitigation comprises interference mitigation to be applied to any one or more of the following: subsequent communications between the first UE and the first network device, subsequent communications between the first UE and the second network device, subsequent communications between the second UE and the second network device;
the interference mitigation includes any one or more of the following: changing scheduled or configured resources, redefining boundaries of a bandwidth part, changing or switching a bandwidth part, avoiding scheduling in impacted resources, changing RSRP signal strength, changing allocated power level, power control, switching a serving transmit beam, switching a receive beam, switching a beam pair link, hybrid beamforming, adaptive frequency hopping, focused beamforming;
the transmitter is further configured to transmit (or for transmitting), the apparatus or another component thereof is configured to transmit (or for transmitting), or programming may include instructions to transmit (or for transmitting), to the first UE, a further configuration of further REs for communications between the first UE and the second network device;
the apparatus or a component thereof such as a receiver 1154 or a processor may be configured to receive (or for receiving), or programming may include instructions to receive (or for receiving), from the first UE, an indication of a capability of the first UE to measure and/or report the interference to the second network device;
the further configuration is transmitted to the first UE responsive to receiving the indication of the capability from the first UE;
the transmitter is further configured to transmit (or for transmitting), the apparatus or another component thereof is configured to transmit (or for transmitting), or programming may include instructions to transmit (or for transmitting), to the first UE, signaling related to interference mitigation, based on interference measurement associated with the further REs, to be applied to subsequent communications between the first UE and the second network device;
the interference mitigation includes any one or more of the following: changing scheduled or configured resources, redefining boundaries of a bandwidth part, changing or switching a bandwidth part, avoiding scheduling in impacted resources, changing RSRP signal strength, changing allocated power level, power control, switching a serving transmit beam, switching a receive beam, switching a beam pair link, hybrid beamforming, adaptive frequency hopping, focused beamforming;
the second network device is in the first wireless communication system;
the second network device is in a second wireless communication system.

An apparatus for a second UE or a component thereof such as a receiver 1154 or a processor may be configured to receive (or for receiving), from a second network device, a configuration of second REs. An apparatus for a second UE or a component thereof such as a controller 1130, which may be coupled to the receiver 1154, may be configured to control (or for controlling), or programming may include instructions to control (or for controlling), the apparatus to use the second REs according to the configuration.

The receiver may be further configured to receive (or for receiving), the apparatus or another component thereof is configured to receive (or for receiving), or programming may include instructions to receive (or for receiving), from the second network device, signaling related to interference mitigation that is based on the measurement of interference.

Other features disclosed herein may also or instead be provided or supported in apparatus embodiments.

Apparatus embodiments are not in any way restricted to single devices. A system, for example, may include a first network device and a first UE. The network device may be configured to transmit (or for transmitting) a configuration of first REs, and to use (or for using) the first REs according to the configuration. The first UE may be configured to receive (or for receiving), from the first network device, the configuration of the first REs, and to use (or for using) the first REs according to the configuration. Such a system may also include a second network device configured to coordinate (or for coordinating), with the first network device, the set of second REs, and for transmitting to the second UE, a configuration to mute REs in the set of second REs for communications between the second UE and the second network device. A system may include the second UE as well, configured to receive (or for receiving), from the second network device, the configuration to mute REs in the set of second REs for communications between the second UE and the second network device, and to use (or for using) the set of second REs according to the configuration.

Other features disclosed herein may also or instead be provided in method, apparatus, and/or system embodiments.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Regarding traffic adaptation, for example, embodiments disclosed herein may facilitate traffic adaptation, link adaptation, or both. Measurements of cross-link interference may be used to update the MCS that is currently in use. In an embodiment, as interference becomes higher, the order of MCS becomes lower.

Dynamic TDD may also or instead be provided. For example, embodiments may facilitate dynamic TDD and improve system throughput. Dynamic TDD per-UE demand can introduce cross-link interference. Therefore, measurements of cross-link interference as provided herein may be used to adjust/adapt allocation of an uplink portion and a downlink portion of a TDD slot transmission interval until a higher utilization and an acceptable level of cross-link interference is achieved.

Embodiments may also or instead be applied to flexible duplex and full duplex. Full duplex and partially flexible duplex may be facilitated, where cross-link interference can be considered as interference coming from surrounding nodes in addition to self-interference, which is a kind of interference that can happen between uplink and downlink signals of the same UE that is equipped with full/flexible full duplex. Time-frequency resources in systems that support flexible/full duplex mode can be allocated dynamically for uplink or downlink based on UE demand.

Coexistence of similar polarized transmission may also or instead be facilitated, and embodiments may provide measurements of cross-link interference in links that use the same polarization. Such measurements can be used as inputs for cross-polarization interference mitigation, using cross-polarization interference mitigation algorithms for example.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
receiving, by a first user equipment (UE) from a first network device in a first wireless communication system, a configuration of a plurality of first resource elements (REs),
the plurality of first REs comprising REs that correspond to a subset of REs in a set of second REs, the set of second REs comprising all REs at a time position in a time-frequency grid that are muted for communications by a second UE,
the plurality of first REs further comprising an RE that corresponds to an RE at a time position in the time-frequency grid different from the time position of the REs that are muted; and
using, by the first UE, the plurality of first REs according to the configuration, for determination of different components of interference.

2. The method of claim 1,
wherein the plurality of first REs comprises an RE that corresponds to an RE of the REs that are muted, wherein the RE in the plurality of first REs is not used for communications between the first UE and the first network device, and is used for a measurement to be taken of a component of the interference, the component comprising residual interference and noise.

3. The method of claim 1,
wherein the plurality of first REs comprises an RE that corresponds to an RE at a time position in the time-frequency grid different from the time position of the REs that are muted,
wherein the RE in the plurality of first REs is not used for communications between the first UE and the first network device, and is used for a measurement to be taken of the interference, the interference comprising a component caused by the communications by the second UE, and
wherein the component comprises residual interference and noise.

4. The method of claim 2,
wherein the plurality of first REs further comprises a further RE that corresponds to an RE at a time position different from the time position of the REs that are muted, wherein the further RE is not used for the communications between the first UE and the first network device, and is used for a second measurement to be taken of the interference, the interference comprising a second component of the interference caused by communications by the second UE and the component, and
wherein the second component of the interference caused by the communications by the second UE is determinable from (1) the measurement of the component of the interference and (2) the second measurement, the interference comprising the component and the second component.

5. The method of claim 1,
wherein the plurality of first REs comprise a reference signal RE that corresponds to an RE of the REs that are muted, wherein the reference signal RE is used to communicate a reference signal between the first UE and the first network device for a measurement to be taken based on the reference signal, the measurement comprising a component of the interference, the component comprising residual interference and noise.

6. The method of claim 4,
wherein the plurality of first REs comprise a reference signal RE that corresponds to an RE of the REs that are muted, wherein the reference signal RE is used to communicate a reference signal between the first UE and the first network device for a third measurement to be taken based on the reference signal, the third measurement comprising the component of the interference, and
wherein the second component is determinable from (1) the third measurement based on the reference signal, (2) the measurement of the component, and (3) the measurement of the interference, the interference comprising the component and the second component.

7. The method of claim 1,
wherein the plurality of first REs comprise a reference signal RE that corresponds to an RE at a time position in the time-frequency grid different from the time position of the REs that are muted, wherein the reference signal RE is used to communicate a reference signal between the first UE and the first network device for a measurement to be taken based on the reference signal, the measurement comprising a component of the interference caused by communications by the second UE and a second component of the interference, the second component comprising residual interference and noise.

8. The method of claim 4,
wherein the plurality of first REs further comprise a reference signal RE that corresponds to an RE at a time position in the time-frequency grid different from the time position of the REs that are muted, wherein the reference signal RE is used to communicate a reference signal between the first UE and the first network device for a third measurement to be taken based on the reference signal, the third measurement comprising the second component and the component, and
wherein the second component is determinable from the third measurement and the measurement of the component.

9. The method of claim 1,
wherein the plurality of first REs comprise an RE that corresponds to an RE in which there is to be no communication by the second UE and at a time position in the time-frequency grid different from the time position of the REs that are muted, wherein the RE in the plurality of first REs is not used for communications between the first UE and the first network device, and is used for a measurement to be taken of the interference, the interference comprising an adjacent channel component of the interference caused by communications by the second UE and a component of the interference, the component comprising residual interference and noise.

10. The method of claim 2,
wherein the plurality of first REs further comprise a further RE that corresponds to an RE in which there is to be no communication by the second UE and at a time position in the time-frequency grid different from the time position of the REs that are muted, wherein the further RE is not used for communications between the first UE and the first network device, and is used for a second measurement to be taken of the interference, the interference comprising an adjacent channel component caused by communications by the second UE and the component, and
wherein the adjacent channel component of the interference is determinable from the measurement of the component and the second measurement.

11. The method of claim 1,
wherein the plurality of first REs comprise a reference signal RE that corresponds to an RE in which there is to be no communication by the second UE and at a time position in the time-frequency grid different from the time position of the REs that are muted, wherein the reference signal RE is used to communicate a reference signal between the first UE and the first network device for a measurement to be taken based on the reference signal, the measurement comprising an adjacent channel component of the interference caused by communications by the second UE and a component of the interference, the component comprising residual interference and noise.

12. The method of claim 5,
wherein the plurality of first REs further comprise a further reference signal RE that corresponds to an RE in which there is to be no communication by the second UE and at a time position in the time-frequency grid different from the time position of the REs that are muted, wherein the further reference signal RE is used to communicate a further reference signal between the first UE and the first network device for a second measurement to be taken based on the further reference signal, the second measurement comprising an adjacent channel component of the interference caused by communications by the second UE and the component, and
wherein the adjacent channel component of the interference is determinable from the measurement based on the reference signal and the second measurement.

13. The method of claim 1, further comprising:
determining, by the first UE, the different components of the interference; and
reporting, by the first UE, to the first network device based on the different components of the interference.

14. The method of claim 13, further comprising:
determining an effective adjacent channel leakage ratio (ACLR) based on the different components of the interference.

15. The method of claim 13, further comprising:
reporting, by the first UE, to a second network device based on the different components of the interference.

16. A method comprising:
transmitting, to a first user equipment (UE) from a first network device in a first wireless communication system, a configuration of a plurality of first resource elements (REs),
the plurality of first REs comprising REs that correspond to a subset of REs in a set of second REs, the set of second REs comprising all REs at a time position in a time-frequency grid that are muted for communications by a second UE,
the plurality of first REs further comprising an RE that corresponds to an RE at a time position in the time-frequency grid different from the time position of the REs that are muted; and
using, by the first network device, the plurality of first REs according to the configuration, for determination of different components of interference.

17. The method of claim 16,
wherein the plurality of first REs comprise an RE that corresponds to an RE of the REs that are muted, wherein the RE in the plurality of first REs is not used for communications between the first UE and the first network device, and is used for a measurement to be taken of a component of the interference, the component comprising residual interference and noise.

18. The method of claim 17,
wherein the plurality of first REs further comprise a further RE that corresponds to an RE at a time position in the time-frequency grid different from the time position of the REs that are muted,
wherein the further RE is not used for communications between the first UE and the first network device, and is used for a second measurement to be taken of the interference, the interference comprising a second component caused by the communications by the second UE and the component, and
wherein the second component of the interference caused by the communications by the second UE is determinable from (1) the measurement of the component of the interference and (2) the second measurement of the interference, the interference comprising the component and the second component.

19. The method of claim 16,
wherein the plurality of first REs comprise a reference signal RE that corresponds to an RE of the REs that are muted, wherein the reference signal RE is used to communicate a reference signal between the first UE and the first network device for a measurement to be taken based on the reference signal, the measurement comprising a component of the interference, the component comprising residual interference and noise.

20. The method of claim 18,
wherein the plurality of first REs comprise a reference signal RE that corresponds to an RE of the REs that are muted, wherein the reference signal RE is used to communicate a reference signal between the first UE and the first network device for a third measurement to be taken based on the reference signal, the third measurement comprising the component of the interference, and
wherein the second component is determinable from (1) the third measurement based on the reference signal, (2) the measurement of the component, and (3) the measurement of the interference, the interference comprising the component and the second component.
